(19) United States
(12) Patent Application Publication
(10) Pub. No.: US 2024/0259158 A1
(43) Pub. Date: Aug. 1, 2024

(54) ENHANCED SOUNDING REFERENCE SIGNAL (SRS) OPERATION FOR FIFTH-GENERATION (5G) SYSTEMS

(71) Applicant: Intel Corporation, Santa Clara, CA (US)

(72) Inventors: Guotong WANG, Santa Clara, CA (US); Alexei DAVYDOV, Santa Clara, CA (US)

(21) Appl. No.: 18/560,328

(22) PCT Filed: Nov. 15, 2022
(86) PCT No.: PCT/US2022/049972

§ 371 Date: Nov. 10, 2023

(30) Foreign Application Priority Data
Nov. 17, 2021 (WO) PCT/CN2021/131163
Nov. 17, 2021 (WO) PCT/CN2021/131213
Apr. 6, 2022 (WO) PCT/CN2022/085322
Apr. 11, 2022 (WO) PCT/CN2022/086043

(51) Int. Cl. H04L 5/00; H04L 27/26; H04W 72/1268; H04W 72/232

(52) U.S. Cl. CPC H04L 5/0051; H04L 27/2605; H04W 72/1268; H04W 72/232

(57) ABSTRACT

Systems, apparatuses, methods, and computer-readable media are directed to enhancements to sounding reference signal (SRS) configurations for fifth-generation (5G) systems. In embodiments disclosed herein, an apparatus comprises: memory to store sounding reference signal (SRS) configuration information for an uplink transmission with up to eight layers by a user equipment (UE); and processing circuitry, coupled with the memory, to: retrieve SRS configuration information from the memory, wherein the SRS configuration information includes a maximum number of cyclic shifts for a comb value, and wherein the maximum number of cyclic shifts is an integer multiple of eight; and encode a message for transmission to the UE that includes the SRS configuration information.

### CROSS-REFERENCE TO RELATED APPLICATIONS

The present application claims priority to: International Patent Application No. PCT/CN2021/131213, which was filed Nov. 17, 2021; International Patent Application No. PCT/CN2021/131163, which was filed Nov. 17, 2021; International Patent Application No. PCT/CN2022/085322, which was filed Apr. 6, 2022; and to International Patent Application No. PCT/CN2022/086043, which was filed Apr. 11, 2022.

### FIELD

Various embodiments generally may relate to the field of wireless communications. For example, some embodiments may relate to enhancements to sounding reference signal (SRS) configurations for fifth-generation (5G) systems.

### BACKGROUND

In the NR Rel-15/Rel-16 spec, different types of SRS resource sets are supported. The SRS resource set is configured with a parameter of ‘usage’, which can be set to ‘beamManagement’, ‘codebook’, ‘nonCodebook’ or ‘antennaSwitching’. The SRS resource set configured for ‘beamManagement’ is used for beam acquisition and uplink beam indication using SRS. The SRS resource set configured for ‘codebook’ and ‘nonCodebook’ is used to determine the UL precoding with explicit indication by TPMI (transmission precoding matrix index) or implicit indication by SRI (SRS resource index).

Additionally, the SRS resource set configured for ‘antennaSwitching’ is used to acquire DL channel state information (CSI) using SRS measurements in the user equipment (UE) by leveraging reciprocity of the channel in TDD systems. For SRS transmission, the time domain behavior could be periodic, semi-persistent or aperiodic. Embodiments of the present disclosure are directed to, among other things, enhancements to SRS configurations to support uplink transmissions up to eight layers by a UE.

### BRIEF DESCRIPTION OF THE FIGURES

FIG. 1 illustrates an example of an RRC message for SRS resource set configuration in accordance with various embodiments.

FIGS. 2A and 2B illustrate an example of a RRC configuration of an SRS resource in accordance with various embodiments.

FIG. 2C illustrates an example of non-codebook based PUSCH transmission in accordance with various embodiments.

FIG. 3 illustrates an example of SRI indication for non-codebook based PUSCH transmission, Lmax=1 in accordance with various embodiments.

FIG. 4 illustrates an example of SRI indication for non-codebook based PUSCH transmission, Lmax=2 in accordance with various embodiments.

FIG. 5 illustrates an example of SRI indication for non-codebook based PUSCH transmission, Lmax=3 in accordance with various embodiments.

FIG. 6 illustrates an example of SRI indication for non-codebook based PUSCH transmission, Lmax=4 in accordance with various embodiments.

FIG. 7 illustrates a network in accordance with various embodiments.

FIG. 8 schematically illustrates a wireless network in accordance with various embodiments.

FIG. 9 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 10, 11, and 12 depict examples of procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

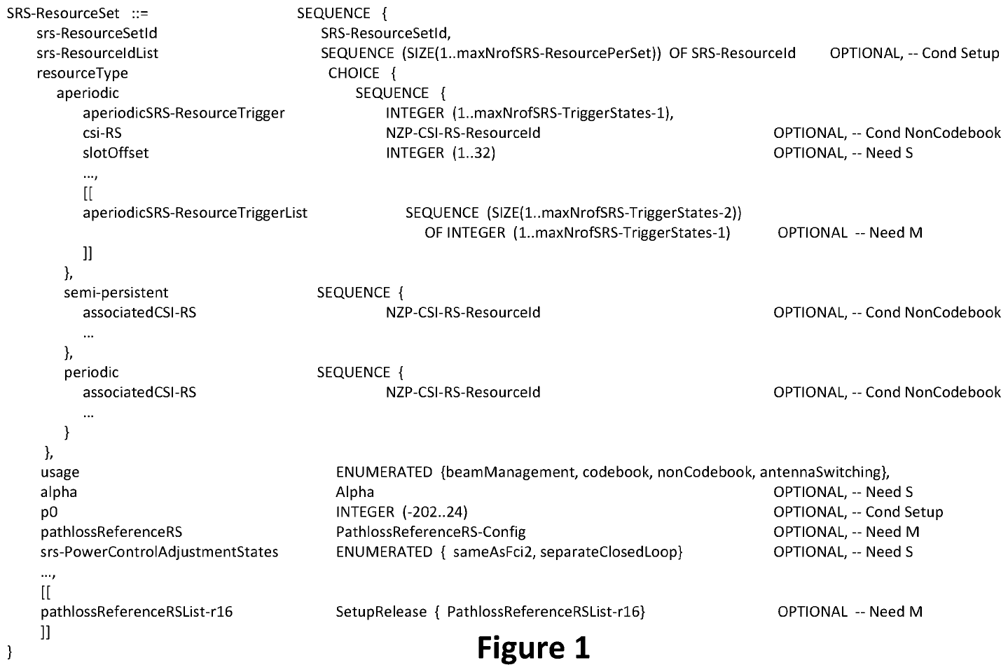

FIG. 1 shows an example of an RRC configuration for SRS resource set. Multiple SRS resource sets could be configured to the UE. Each SRS resource set could be configured with one or multiple SRS resources.

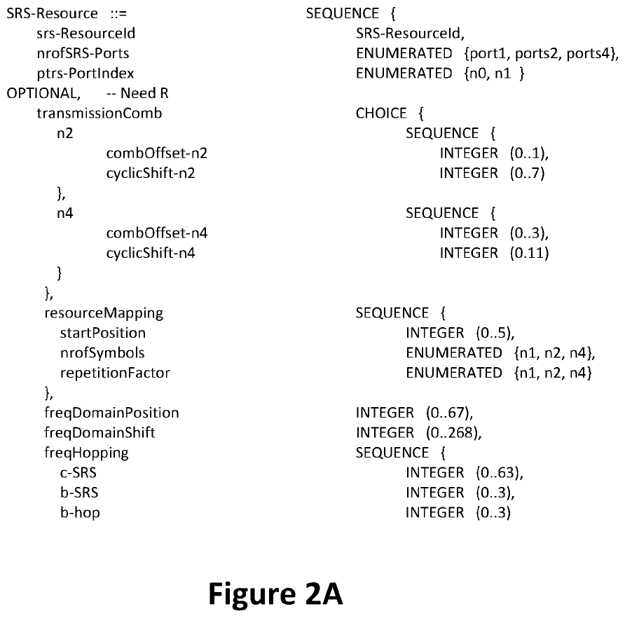

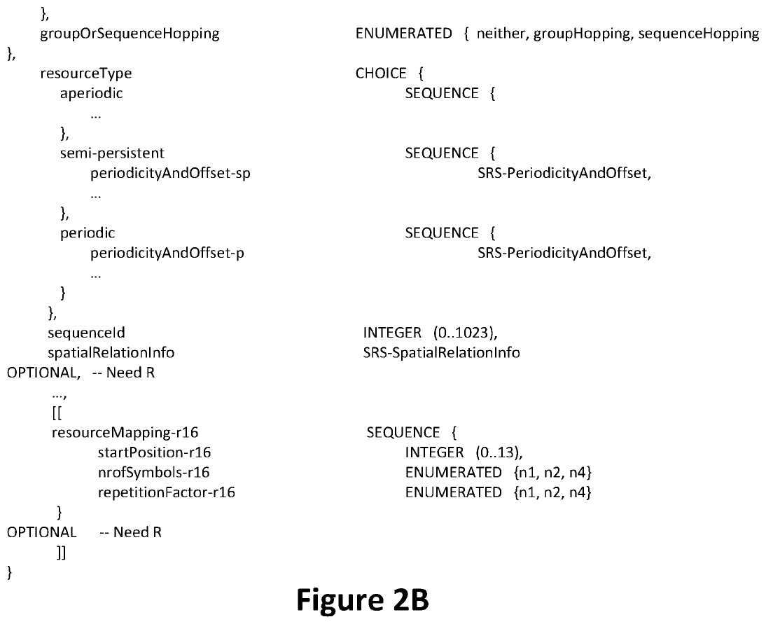

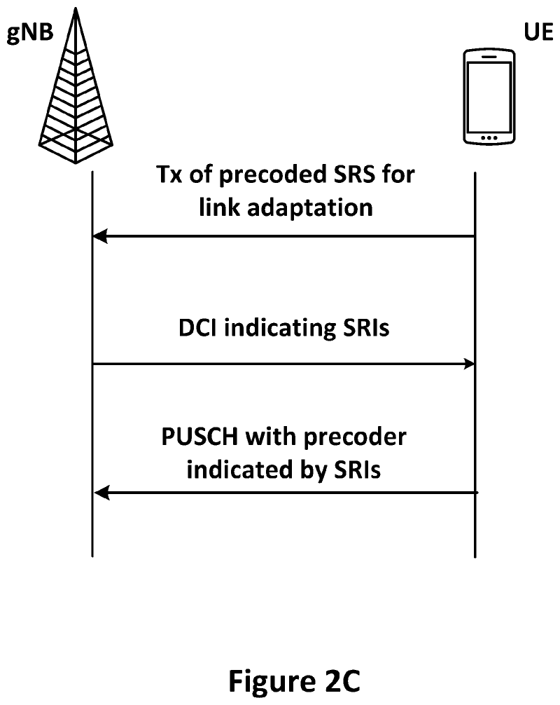

FIG. 2 shows an example of the RRC configuration for SRS resource in Rel-16. For an SRS resource, it could be configured with Nₐₚ^{SRS} antenna ports, where Nₐₚ^{SRS}∈{1, 2, 4}, and is indicated by RRC parameter nrofSRS-Ports. The SRS resource could be configured with comb value (K_{TC}) and comb offset, as indicated by RRC parameter transmissionComb.

When generating an SRS sequence, different cyclic shift (CS) could be applied. For antenna port pᵢ (pᵢ=1000+i, i=0, . . . , Nₐₚ^{SRS}−1), the cyclic shift αᵢ is given by:

$${α}_{i} = 2 π \frac{{n}_{SRS}^{CS , i}}{{n}_{SRS}^{CS , max}} \qquad ( 1 )$$

$${n}_{SRS}^{CS , i} = ( {n}_{SRS}^{CS} + \frac{{n}_{SRS}^{CS , max} ( {p}_{i} - 1000 )}{{N}_{ap}^{SRS}} ) mod {n}_{SRS}^{CS , max}$$

where n_{SR}^{SCS}∈{0,1, . . . , n_{SRS}^{CS,max}−1} and is configured by RRC parameter transmissionComb (e.g., cyclicShift-n2 or cyclicShift-n4), and the maximum number of cyclic shifts n_{SRS}^{CS,max} is given by Table 1.

TABLE 1
Maximum number of cyclic shifts N_{SRS}^{CS, max} as a function of K_{TC}

| K_{TC} | N_{SRS}^{CS, max} |
|---|---|
| 2 | 8 |
| 4 | 12 |
| 8 | 6 |

In Rel-18, up to 8 layers transmission could be introduced in Rel-18. Correspondingly, the SRS should be able to support 8-port operation.

However, when 8-port SRS is introduced, in Equation (1), the operation of

$$\frac{{n}_{SRS}^{CS , max} ( {p}_{i} - 1000 )}{{N}_{ap}^{SRS}}$$

is not a integer value according to the current values of n_{SRS}^{CS,max}. And this issue should be fixed to support 8-port SRS operation.

When 8-port SRS is supported, correspondingly, the SRS antenna switching should be extended to up to 8 Tx, e.g., 6T8R and 8T8R should be introduced. Accordingly, the current SRS sequence generation doesn't work for 8-port SRS. Embodiments of the present disclosure address this and other issues by supporting 8-port SRS operation.

### Cyclic Shift for SRS

In an embodiment, in order to support uplink transmission with up to 8 layers, the SRS should be enhanced. The SRS antenna port should be extended to 8, e.g., Nₐₚ^{SRS}∈{1, 2, 4, 8}.

In order to support 8-port SRS operation, the maximum number of cyclic shifts (N_{SRS}^{CS,max}) for different comb value (K_{TC}) should be multiple integer times of 8. An example of the configuration of maximum number of cyclic shifts is shown below in Table 2:

TABLE 2
Maximum number of cyclic shifts N_{SRS}^{CS, max} as a function of K_{TC}

| K_{TC} | N_{SRS}^{CS, max} |
|---|---|
| 2 | 8 or 16 or 24 |
| 4 | 8 or 16 or 24 |
| 8 | 8 or 16 or 24 |

In another embodiment, in order to support 8-port SRS, the existing values for maximum number of cyclic shifts (N_{SRS}^{CS,max}) as shown in Table 1 is used.

When generating 8-port SRS for Comb-4 and Comb-8, multiple Comb offsets, e.g., 4 comb offsets, should be used. For example, for Comb-4, 4 comb offsets (0,1,2,3) will be used, and each comb offset is mapped with 2-port (different cyclic shift are used for the two ports). For Comb-8, 4 comb offsets (0,2,4,6) or (1,3,5,7) could be used, and each comb offset is mapped with 2-port (different cyclic shift are used for the two ports).

In another example, when generating 8-port SRS for Comb-2 and Comb-4, multiple Comb offsets, e.g., 2 comb offsets, should be used. For Comb-2, 2 comb offsets (0,1) could be used, and each comb offset is mapped with 4-port (different cyclic shift are used for the four ports). For Comb-4, 2 comb offsets (0, 2) or (1, 3) could be used, and each comb offset is mapped with 4-port (different cyclic shift are used for the four ports).

In another embodiment, for 8-port SRS with Comb-2 (K_{TC}=2), when the SRS sequence length is 6, the maximum number of cyclic shifts should be 6 (n_{SRS}^{CS,max}=6).

For 8-port SRS, multiple Comb offsets should be used, e.g., 2 comb offsets should be used and different antenna port group are mapped to different comb offset. For example, comb offsets (0,1) are used. Comb offset #0 is mapped with 4-ports, e.g., port {#0, #1, #2, #3}. Comb offset #1 is mapped with another 4-ports, e.g., port {#4, #5, #6, #7}. Over the same comb offset, different cyclic shift is used for different ports (e.g., 4 different cyclic shifts are used over the same comb offset).

The comb offset configuration could be given by Equation (2).

$${k}_{TC}^{( {p}_{i} )} = ( k\_TC + ⌊ ( {p}_{i} - 1000 ) / 4 ⌋ \times \frac{{K}_{TC}}{2} ) mod 8 \qquad ( 2 )$$

where k_TC is the comb offset configured by RRC.

The cyclic shift allocation could be given by Equation (3).

$${n}_{SRS}^{CS , i} = ( {n}_{SRS}^{CS} + ( ( {p}_{i} - 1000 ) mod 4 ) ) mod {n}_{SRS}^{CS , max} \qquad ( 3 )$$

Table 3 shows example of the comb offset and cyclic shift allocation for 8-port SRS according to Equation (2) and (3).

TABLE 3
Example of comb offset and cyclic shift configuration for 8-port SRS with Comb-2

| Port | P0 | P1 | P2 | P3 | P4 | P5 | P6 | P7 |
|---|---|---|---|---|---|---|---|---|
| Comb | k_TC | k_TC | k_TC | k_TC | (k_TC + | (k_TC + | (k_TC + | (k_TC + |
| offset | | | | | 1)mod [symbol] | 1)mod [symbol] | 1)mod [symbol] | 1)mod 2 |
| Cyclic | n_{SRS}^{CS} | (n_{SRS}^{CS} + | (n_{SRS}^{CS} + | (n_{SRS}^{CS} + | n_{SRS}^{CS} | (n_{SRS}^{CS} + | (n_{SRS}^{CS} + | n(n_{SRS}^{CS} + |
| shift | | 1)mod [symbol] | 2)mod [symbol] | 3)mode [symbol] | | 1)mod [symbol] | 2)mode [symbol] | 3)mod6 |

[symbol]

indicates data missing or illegible when filed

In another example, for over the same comb offset, the cyclic shift of n_{SRS}^{CS,max}, (n_{SRS}^{CS,max}+2)mod 6, (n_{SRS}^{CS,max}+4)mod 6 and (n_{SRS}^{CS,max}+5)mod 6 could be used.

Note: This embodiment could also be used when SRS sequence is integer multiples of 6, or when SRS sequence is integer multiples of 12 but not integer multiple of 6.

In another embodiment, for 8-port SRS with Comb-2, if the SRS sequence length is integer multiples of 6 but is not integer multiples of 12, then the maximum number of cyclic shifts is 6. If the SRS sequence length is integer multiples of 12, then the maximum number of cyclic shifts is 12.

Alternatively, for 8-port SRS with comb-2, the maximum number of cyclic shifts is 6 or 12, no matter the sequence length.

When the maximum number of cyclic shifts is 6, multiple comb offsets should be used for 8-port SRS, e.g., two comb offsets. One example of the comb offset and cyclic shift allocation is shown as Equation (2) and (3).

When the maximum number of cyclic shifts is 12, then one comb offsets could be used for 8-port SRS, which is mapped with 8-ports with different cyclic shifts, e.g., over the same comb offset, 8 different cyclic shifts are used.

The comb offset configuration could be given by Equation (4).

$${k}_{TC}^{( {p}_{i} )} = k\_TC \qquad ( 4 )$$

The cyclic shift allocation could be given by Equation (5).

$${n}_{SRS}^{CS , i} = ( {n}_{SRS}^{CS} + ( {p}_{i} - 1000 ) ) mod {n}_{SRS}^{CS , max} \qquad ( 5 )$$

In another example, when the maximum number of cyclic shifts is 12, then multiple comb offsets should be used for 8-port SRS, e.g., two comb offsets. Over the same comb offset, different cyclic shift is used for different ports (e.g., 4 different cyclic shifts are used over the same comb offset).

The comb offset configuration could be given by Equation (6).

$${k}_{TC}^{( {p}_{i} )} = ( k\_TC + ⌊ ( {p}_{i} - 1000 ) / 4 ⌋ \times \frac{{K}_{TC}}{2} ) mod 8 \qquad ( 6 )$$

The cyclic shift allocation could be given by Equation (7), or the cyclic shift could be given by Equation (3).

$${n}_{SRS}^{CS , i} = ( {n}_{SRS}^{CS} + \frac{{n}_{SRS}^{CS , m a x} ( {p}_{i} - 1000 )}{{N}_{ap}^{SRS} / 2} ) mod {n}_{SRS}^{CS , m a x} \qquad ( 7 )$$

In another example, when the maximum number of cyclic shifts is 12 and the SRS sequence length is 6, then multiple comb offsets should be used for 8-port SRS, e.g., two comb offsets. Over the same comb offset, different cyclic shift is used for different ports (e.g., 4 different cyclic shifts are used over the same comb offset). The available cyclic shifts are (#0, #2, #4, #6, #8, #10).

In another embodiment, for 8-port SRS with Comb-4 (K_{TC}=4), when the SRS sequence length is 6, the maximum number of cyclic shifts should be 6 (n_{SRS}^{CS,max}=6).

In one example, four comb offsets are used for 8-port SRS. For example, comb offset k_TC, (k_TC+1)mod 4, (k_TC+2)mod 4, and (k_TC+3)mod 4. 2-ports are mapped to each comb offset. Over the same comb offset, different cyclic shift is used for different port (e.g., 2 different cyclic shifts are used over the same comb offset).

The comb offset configuration could be given by Equation (8).

$${k}_{TC}^{( {p}_{i} )} = ( k \_ TC + ( ( {p}_{i} - 1000 ) mod 4 ) ) mod 4 \qquad ( 8 )$$

The cyclic shift allocation could be given by Equation (9).

$${n}_{SRS}^{CS , i} = ( {n}_{SRS}^{CS} + \frac{{n}_{SRS}^{CS , m a x} ⌊ ( {p}_{i} - 1000 ) / 4 ⌋}{{N}_{ap}^{SRS} / 4} ) mod {n}_{SRS}^{CS , m a x} \qquad ( 9 )$$

Table 4 shows example of the comb offset and cyclic shift allocation for 8-port SRS according to Equation (8) and (9).

TABLE 4
Example of comb offset and cyclic shift configuration for 8-port SRS with Comb-4

| Port | P0 | P1 | P2 | P3 | P4 | P5 | P6 | P7 |
|---|---|---|---|---|---|---|---|---|
| Comb | k_TC | (k_TC + | (k_TC + | (k_TC + | k_TC | (k_TC + | (k_TC + | (k_TC + |
| offset | | 1)mod [symbol] | 2)mod 4, | 3)mod [symbol] | | 1)mod [symbol] | 2)mod [symbol] | 3)mod [symbol] |
| Cyclic | n_{SRS}^{CS} | n_{SRS}^{CS} | n_{SRS}^{CS} | n_{SRS}^{CS} | (n_{SRS}^{CS} + | (n_{SRS}^{CS} + | (n_{SRS}^{CS} + | (n_{SRS}^{CS} + |
| shift | | | | | 3)mod [symbol] | 3)mode [symbol] | 3)mod [symbol] | 3)mode [symbol] |

[symbol]

indicates data missing or illegible when filed

In another example, two comb offsets are used, for example, comb offset k_TC and comb offset (k_TC+2)mod 4. 4-ports are mapped to one comb offset and another 4-ports are mapped to another comb offset. Over the same comb offset, different cyclic shift is used for different port (e.g., 4 different cyclic shifts are used over the same comb offset).

The comb offset configuration could be given by Equation (10).

$${k}_{TC}^{( {p}_{i} )} = ( k \_ TC + ⌊ ( {p}_{i} - 1000 ) / 4 ⌋ \times \frac{{K}_{TC}}{2} ) mod 4 \qquad ( 10 )$$

The cyclic shift allocation could be given by Equation (11).

$${n}_{SRS}^{CS , i} = ( {n}_{SRS}^{CS} + ( ( {p}_{i} - 1000 ) mod 4 ) ) mod {n}_{SRS}^{CS , m a x} \qquad ( 11 )$$

Table 5 shows example of the comb offset and cyclic shift allocation for 8-port SRS according to Equation (10) and (11).

TABLE 5
Another example of comb offset and cyclic shift configuration for 8-port SRS with Comb-4

| Port | P0 | P1 | P2 | P3 | P4 | PS | P6 | P7 |
|---|---|---|---|---|---|---|---|---|
| Comb | k_TC | k_TC | k_TC | k_TC | (k_TC + | (k_TC + | (k_TC + | (k_TC + |
| offset | | | | | 2)mod [symbol] | 2)mod [symbol] | 2)mod [symbol] | 2)mod [symbol] |
| Cyclic | n_{SRS}^{CS} | (n_{SRS}^{CS} + | (n_{SRS}^{CS} + | (n_{SRS}^{CS} + | n_{SRS}^{CS} | (n_{SRS}^{CS} + | (n_{SRS}^{CS} + | (n_{SRS}^{CS} + |
| shift | | 1)mod [symbol] | 2)mod [symbol] | 3)mod [symbol] | | 1)mod [symbol] | 2)mod [symbol] | 3)mod [symbol] |

[symbol]

indicates data missing or illegible when filed

In another example, for over the same comb offset, the cyclic shift of n_{SRS}^{CS}, n_{SRS}^{CS}+2)mod 6, (n_{SRS}^{CS}+4)mod 6 and (n_{SRS}^{CS}+5)mod 6 could be used.

Note: This embodiment could also be used when SRS sequence is integer multiples of 6, or when SRS sequence is integer multiples of 12 but not integer multiple of 6.

In another embodiment, for 8-port SRS with Comb-4, if the SRS sequence length is integer multiples of 6 but is not integer multiples of 12, then the maximum number of cyclic shifts is 6. If the SRS sequence length is integer multiples of 12, then the maximum number of cyclic shifts is 12.

Alternatively, for 8-port SRS with comb-4, the maximum number of cyclic shifts is 6 or 12, no matter the sequence length.

When the maximum number of cyclic shifts is 6, multiple comb offsets should be used for 8-port SRS, e.g., two/four comb offsets. Examples of the comb offset and cyclic shift allocation are shown as Equation (8), (9); or Equation (10), (11).

When the maximum number of cyclic shifts is 12, then one comb offsets could be used for 8-port SRS, which is mapped with 8-ports with different cyclic shifts, e.g., over the same comb offset, 8 different cyclic shifts are used.

The comb offset configuration could be given by Equation (12).

$${k}_{TC}^{( {p}_{i} )} = k \_ TC \qquad ( 12 )$$

The cyclic shift allocation could be given by Equation (13).

$${n}_{SRS}^{CS , i} = ( {n}_{SRS}^{CS} + ( {p}_{i} - 1000 ) ) mod {n}_{SRS}^{CS , m a x} \qquad ( 13 )$$

In another example, when the maximum number of cyclic shifts is 12, then multiple comb offsets should be used for 8-port SRS, e.g., two/four comb offsets. Over the same comb offset, different cyclic shift is used for different ports (e.g., four/two different cyclic shifts are used over the same comb offset). When two comb offsets are used, the comb offsets and cyclic shift allocation could be as shown by Equation (10) and (11). When four comb offsets are used, the comb offsets and cyclic shift allocation could be as shown by Equation (8) and (9).

In another example, when the maximum number of cyclic shifts is 12 and the SRS sequence length is 6, then multiple comb offsets should be used for 8-port SRS, e.g., two/four comb offsets. Over the same comb offset, different cyclic shift is used for different ports (e.g., four/two different cyclic shifts are used over the same comb offset). The available cyclic shifts are (#0, #2, #4, #6, #8, #10).

In another embodiment, for 8-port SRS with Comb-8 (K_{TC}=8), the maximum number of cyclic shifts (n_{SRS}^{CS,max}) is 6 (n_{SRS}^{CS,max}=6).

In one example, four comb offsets are used for 8-port SRS. For example, comb offset k_TC, (k_TC+2)mod 8, (k_TC+4)mod 8, and (k_TC+6)mod 8. 2-ports are mapped to each comb offset. Over the same comb offset, different cyclic shift is used for different port (e.g., 2 different cyclic shifts are used over the same comb offset).

The comb offset configuration could be given by Equation (14).

$${k}_{TC}^{( {p}_{i} )} = ( k \_ TC + ( ( {p}_{i} - 1000 ) mod 4 ) \times 2 ) mod 8 \qquad ( 14 )$$

The cyclic shift allocation could be given by Equation (15).

$${n}_{SRS}^{CS , i} = ( {n}_{SRS}^{CS} + \frac{{n}_{SRS}^{CS , m a x} ⌊ ( {p}_{i} - 1000 ) / 4 ⌋}{{N}_{ap}^{SRS} / 4} ) mod {n}_{SRS}^{CS , m a x} \qquad ( 15 )$$

Table 6 shows example of the comb offset and cyclic shift allocation for 8-port SRS according to Equation (14) and (15).

TABLE 6
Example of comb offset and cyclic shift configuration for 8-port SRS

| Port | P0 | P1 | P2 | P3 | P4 | P5 | P6 | P7 |
|---|---|---|---|---|---|---|---|---|
| Comb | k_TC | (k_TC + | (k_TC + | (k_TC + | k_TC | (k_TC + | (k_TC + | (k_TC + |
| offset | | 2)mod [symbol] | 4)mod 8, | 6)mod [symbol] | | 2)mod [symbol] | 4)mod [symbol] | 6)mod [symbol] |
| Cyclic | n_{SRS}^{CS} | n_{SRS}^{CS} | n_{SRS}^{CS} | n_{SRS}^{CS} | (n_{SRS}^{CS} + | (n_{SRS}^{CS} + | (n_{SRS}^{CS} + | (n_{SRS}^{CS} + |
| shift | | | | | 3)mod [symbol] | 3)mod [symbol] | 3)mod [symbol] | 3)mod [symbol] |

[symbol]

indicates data missing or illegible when filed

In another example, two comb offsets are used, for example, comb offset k_TC and comb offset (k_TC+4)mod 8. 4-ports are mapped to one comb offset and another 4-ports are mapped to another comb offset. Over the same comb offset, different cyclic shift is used for different port (e.g., 4 different cyclic shifts are used over the same comb offset).

The comb offset configuration could be given by Equation (16).

$${k}_{TC}^{( {p}_{i} )} = ( k \_ TC + ⌊ ( {p}_{i} - 1000 ) / 4 ⌋ \times \frac{{K}_{TC}}{2} ) mod 8 \qquad ( 16 )$$

The cyclic shift allocation could be given by Equation (17).

$${n}_{SRS}^{CS , i} = ( {n}_{SRS}^{CS} + ( ( {p}_{i} - 1000 ) mod 4 ) ) mod {n}_{SRS}^{CS , m a x} \qquad ( 17 )$$

Table 7 shows example of the comb offset and cyclic shift allocation for 8-port SRS according to Equation (16) and (17).

TABLE 7
Another example of comb offset and cyclic shift configuration for 8-port SRS

| Port | P0 | P1 | P2 | P3 | P4 | P5 | P6 | P7 |
|---|---|---|---|---|---|---|---|---|
| Comb | k_TC | k_TC | k_TC | k_TC | (k_TC + | (k_TC + | (k_TC + | (k_TC + |
| offset | | | | | 4)mod [symbol] | 4)mod [symbol] | 4)mod [symbol] | 4)mod [symbol] |
| Cyclic | n_{SRS}^{CS} | (n_{SRS}^{CS} + | (n_{SRS}^{CS} + | (n_{SRS}^{CS} + | n_{SRS}^{CS} | (n_{SRS}^{CS} + | (n_{SRS}^{CS} + | (n_{SRS}^{CS} + |
| shift | | 1)mod [symbol] | 2)mod [symbol] | 3)mod [symbol] | | 1)mod [symbol] | 2)mod [symbol] | 3)mod [symbol] |

[symbol]

indicates data missing or illegible when filed

In another example, for over the same comb offset, the cyclic shift of n_{SRS}^{CS}, (n_{SRS}^{CS}+2)mod 6, (n_{SRS}^{CS}+4)mod 6 and (n_{SRS}^{CS}+5)mod 6 could be used.

In another example, eight comb offsets are used for 8-port SRS. For example, comb offset k_TC, (k_TC+1)mod 8, (k_TC+2)mod 8, . . . (k_TC+7)mod 8. 1-port is mapped to each comb offset. Over the same comb offset, one cyclic shift is used.

The comb offset configuration could be given by Equation (18).

$${k}_{TC}^{( {p}_{i} )} = ( k \_ TC + ( {p}_{i} - 1000 ) ) mod 8 \qquad ( 18 )$$

The cyclic shift allocation could be given by Equation (19). Or it can be given by Equation (13).

$${n}_{SRS}^{CS , i} = ( {n}_{SRS}^{CS} + \frac{{n}_{SRS}^{CS , m a x} ⌊ ( {p}_{i} - 1000 ) / 8 ⌋}{{N}_{ap}^{SRS} / 4} ) mod {n}_{SRS}^{CS , m a x} \qquad ( 19 )$$

Note: This embodiment could also be used when SRS sequence is integer multiples of 6, or when SRS sequence is integer multiples of 12 but not integer multiple of 6.

In another embodiment, for 8-port SRS with Comb-8, if the SRS sequence length is integer multiples of 6 but is not integer multiples of 12, then the maximum number of cyclic shifts is 6. If the SRS sequence length is integer multiples of 12, then the maximum number of cyclic shifts is 12.

Alternatively, for 8-port SRS with comb-8, the maximum number of cyclic shifts is 6 or 12, no matter the sequence length.

When the maximum number of cyclic shifts is 6, multiple comb offsets should be used for 8-port SRS, e.g., two/four/eight comb offsets. Examples of the comb offset and cyclic shift allocation are shown as Equation (14), (15); or Equation (16), (17); or Equation (18), (19).

When the maximum number of cyclic shifts is 12, then one comb offsets could be used for 8-port SRS, which is mapped with 8-ports with different cyclic shifts, e.g., over the same comb offset, 8 different cyclic shifts are used.

The comb offset configuration could be given by Equation (20).

$${k}_{TC}^{( {p}_{i} )} = k \_ TC \qquad ( 20 )$$

The cyclic shift allocation could be given by Equation (21).

$${n}_{SRS}^{CS , i} = ( {n}_{SRS}^{CS} + ( {p}_{i} - 1000 ) ) mod {n}_{SRS}^{CS , m a x} \qquad ( 21 )$$

In another example, when the maximum number of cyclic shifts is 12, then multiple comb offsets should be used for 8-port SRS, e.g., two/four/eight comb offsets. Over the same comb offset, different cyclic shift is used for different ports (e.g., four/two/one different cyclic shifts are used over the same comb offset). When two comb offsets are used, the comb offsets and cyclic shift allocation could be as shown by Equation (16) and (17). When four comb offsets are used, the comb offsets and cyclic shift allocation could be as shown by Equation (14) and (15). When eight comb offsets are used, the comb offsets and cyclic shift allocation could be as shown by Equation (18) and (19).

In another example, when the maximum number of cyclic shifts is 12 and the SRS sequence length is 6, then multiple comb offsets should be used for 8-port SRS, e.g., two/four comb offsets. Over the same comb offset, different cyclic shift is used for different ports (e.g., four/two different cyclic shifts are used over the same comb offset). The available cyclic shifts are (#0, #2, #4, #6, #8, #10).

In another embodiment, for 8-port SRS with Comb-2, the SRS sequence length should be integer multiples of 24. For 8-port SRS with Comb-4, the SRS sequence length should be integer multiples of 12. For 8-port SRS with Comb-8, the SRS sequence length should integer multiples of 6. In this case, the maximum number of cyclic shifts (Ns ax) as shown in Table 1 could be used. In another example, the minimum SRS sequence length for 8-port should be 12 or 24.

In another embodiment, two symbols could be used for 8-port SRS. And TD-OCC could be applied for the two symbols SRS.

In another embodiment, in order to support uplink transmission with up to 8 layers, 6-port SRS could be supported besides 8-port SRS, e.g., Nₐₚ^{SRS}∈{1, 2, 4, 6, 8}.

In order to support 8-port and 6-port SRS operation, the maximum number of cyclic shifts (n_{SRS}^{CS,max}) for different comb value (K_{TC}) should be multiple integer times of 8 and 6. An example of the configuration of maximum number of cyclic shifts is shown as in Table 8.

TABLE 8
Maximum number of cyclic shifts N_{SRS}^{CS, max} as a function of K_{TC}

| K_{TC} | N_{SRS}^{CS, max} |
|---|---|
| 2 | 24 |
| 4 | 24 |
| 8 | 24 |

In another embodiment, in order to support 6-port SRS, the existing values for maximum number of cyclic shifts (n_{SRS}^{CS,max}) as shown in Table 1 is used.

When generating 6-port SRS for Comb-2, multiple Comb offsets, e.g., 2 comb offsets, should be used. For example, 2 comb offsets (0,1) will be used. One comb offset (0) is mapped with 4-port (different cyclic shift are used for the four ports) and the other comb offset (1) is mapped with 2-port (different cyclic shift are used for the two ports).

When generating 6-port SRS for Comb-4, one comb offsets could be used, and the comb offset is mapped with 6-port (different cyclic shift are used for the six ports). Or multiple comb offsets, e.g., 3 comb offsets (0,1,2), could be used, and each comb offset is mapped with 2-port (different cyclic shift are used for the two ports).

When generating 6-port SRS for Comb-8, multiple Comb offsets, e.g., 3 comb offsets, should be used. For example, comb offset (0, 2, 4) is used, and each comb offset is mapped with 2-port (different cyclic shift are used for the two ports).

SRS Antenna Switching with Up to 8 Tx

In an embodiment, for SRS antenna switching, the following xTyR configuration should be supported: 6T8R, 8T8R. For 6T8R, one or several of the following SRS resource configuration could be supported:
2 SRS resources, one is 6-port and the other one is 2-port (if 6-port SRS is supported)
2 SRS resources, both are 4-port
2 SRS resources, both are 6-port (if 6-port SRS is supported)
4 SRS resources, all the resources are 2-port

For 6T8R, up to 2 or 4 aperiodic SRS resource sets could be supported. For 8T8R, one SRS resource with 8-port could be supported and one aperiodic SRS resource set could be supported.

Support for Non-Codebook Transmissions with Up to Eight Layers

For non-codebook based transmissions, the UE is configured with one SRS resource set including one or multiple SRS resources. The ‘usage’ of the SRS resource set is set to ‘nonCodebook’. And all the SRS resources are configured with only one antenna port. In Rel-15/Rel-16, up to 4 SRS resources could be configured in one SRS resource set for non-codebook based transmission. For non-codebook based transmission, the UE could be configured with one NZP (non-zero power) CSI-RS resource associated with the SRS resource set. Based on measuring on the CSI-RS resource, the UE could calculate the precoder used for SRS transmission, i.e. for non-codebook based transmission, the SRS resources transmission for link adaptation is precoded. After measuring the SRS, the gNB could indicate one or several SRIs for PUSCH transmission. The UE should select the precoder for PUSCH according to the indicated SRIs. In FR2, the spatial relation for PUSCH transmission could be based on either SRI or the measurement on CSI-RS.

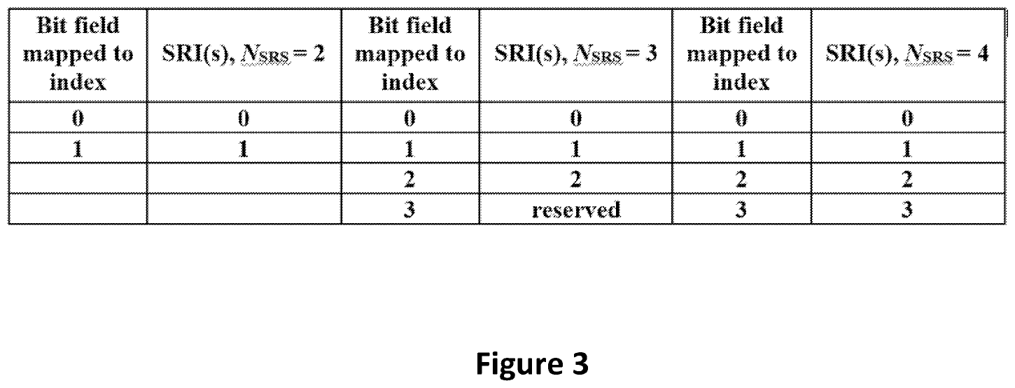

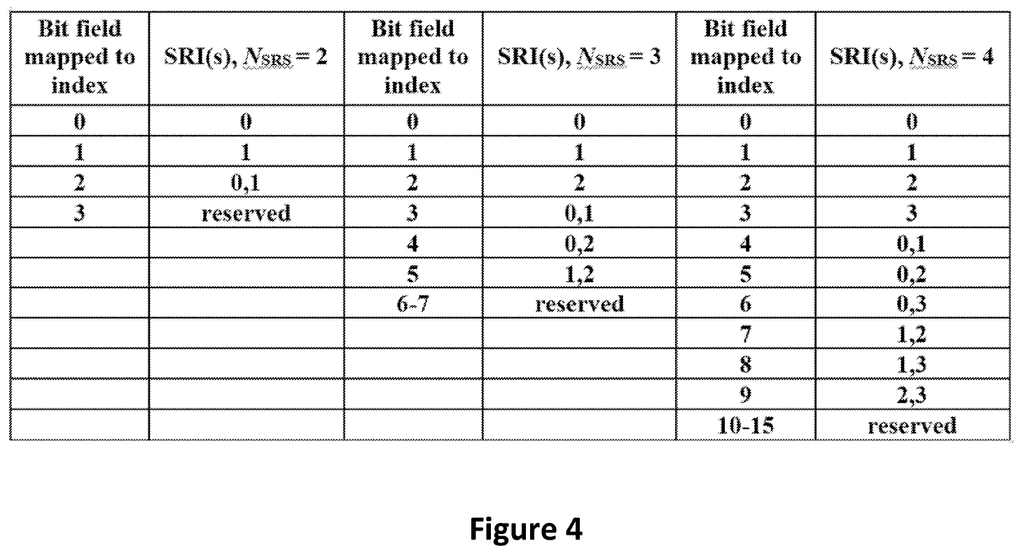

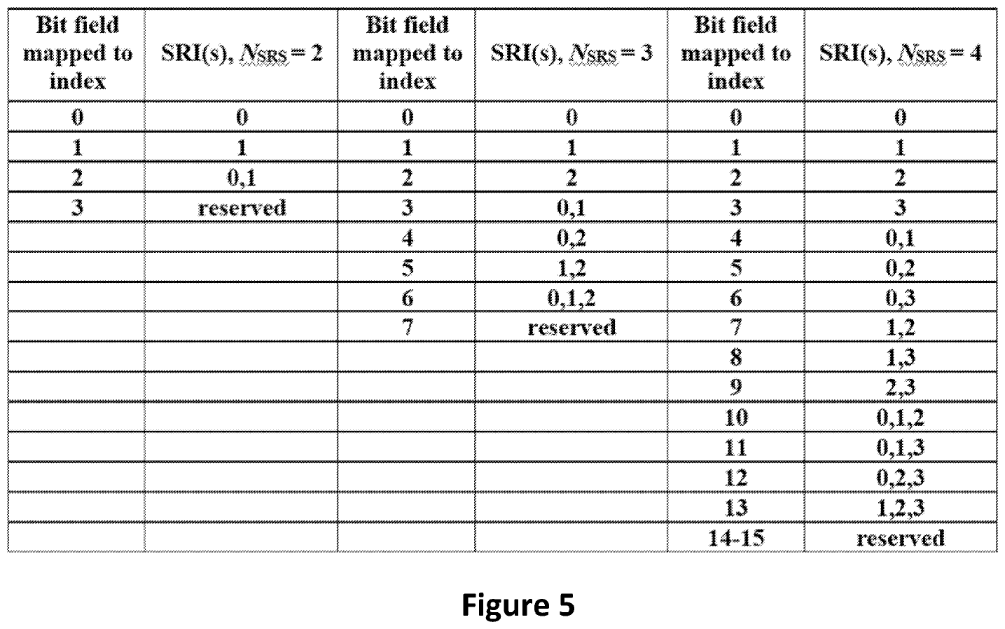

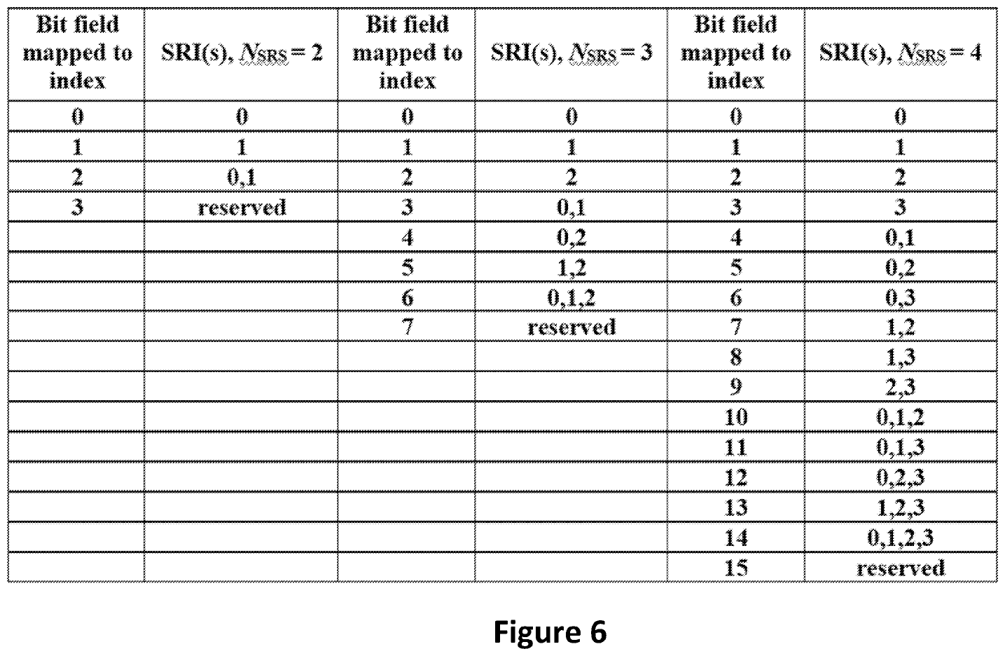

FIG. 2C shows an example of the operation of non-codebook based PUSCH transmission. In DCI, there is one filed of SRS Resource Indicator (SRI) which could be used to indicate one or several SRIs for PUSCH transmission. The bit width of the field is determined by the maximum number of layers Lₘₐₓ (configured by RRC parameter, maxMIMO-Layers) and the number of SRS resources within the SRS resource set for non-codebook, N_{SRS}. FIG. 3 to FIG. 6 show the mapping between SRI field index to SRIs for given Lₘₐₓ and N_{SRS}. In particular: FIG. 3 shows an Lₘₐₓ of 1, FIG. 4 shows an Lₘₐₓ of 2, FIG. 5 shows an Lₘₐₓ of 3, and FIG. 6 shows an Lₘₐₓ of 4.

In Rel-18, up to 8 layers could be supported for uplink transmission. Therefore, the non-codebook based transmission should be enhanced to support 8 layers, however the current non-codebook based transmission only support up to 4 layers. Embodiments of the present disclosure address this and other issues by supporting up to 8 layers for non-codebook based transmission.

In an embodiment, in order to support 8 layers transmission in uplink, for non-codebook based transmission, up to 8 SRS resources could be configured in one SRS resource set and only one SRS resource set is configured for non-codebook based transmission.

Correspondingly, the SRI field for non-codebook based transmission in DCI should be redesigned. Table X1 to Table X8 below show examples of the mapping between bit field index and SRIs for given Lₘₐₓ (maximum number of layers as indicated by maxMIMO-Layers) and number of SRS resources (N_{SRS}). The values in these tables further indicate the required number of bit field indexes (corresponding to number of bits of the field).

TABLE X1
SRI indication for non-codebook based PUSCH transmission, Lmax = 1

| Bit | | | | | | | |
|---|---|---|---|---|---|---|---|
| field | | | | | | | |
| mapped | | | | | | | |
| to | SRI(s) | SRI(s) | SRI(s) | SRI(s) | SRI(s) | SRI(s) | SRI(s) |
| index | N_{SRS} = 2 | N_{SRS} = 3 | N_{SRS} = 4 | N_{SRS} = 5 | N_{SRS} = 6 | N_{SRS} = 7 | N_{SRS} = 8 |
| 0 | 0 | 0 | 0 | 0 | 0 | 0 | 0 |
| 1 | 1 | 1 | 1 | 1 | 1 | 1 | 1 |
| 2 | | 2 | 2 | 2 | 2 | 2 | 2 |
| 3 | | reserved | 3 | 3 | 3 | 3 | 3 |
| 4 | | | | 4 | 4 | 4 | 4 |
| 5 | | | | reserved | 5 | 5 | 5 |
| 6 | | | | | reserved | 6 | 6 |
| 7 | | | | | | reserved | 7 |

TABLE X2
SRI indication for non-codebook based PUSCH transmission, Lmax = 2

| Bit | | | | | | | |
|---|---|---|---|---|---|---|---|
| field | | | | | | | |
| mapped | | | | | | | |
| to | SRI(s) | SRI(s) | SRI(s) | SRI(s) | SRI(s) | SRI(s) | SRI(s) |
| index | N_{SRS} = 2 | N_{SRS} = 3 | N_{SRS} = 4 | N_{SRS} = 5 | N_{SRS} = 6 | N_{SRS} = 7 | N_{SRS} = 8 |
| 0 | 0 | 0 | 0 | 0 | 0 | 0 | 0 |
| 1 | 1 | 1 | 1 | 1 | 1 | 1 | 1 |
| 2 | 0, 1 | 2 | 2 | 2 | 2 | 2 | 2 |
| 3 | reserved | 0, 1 | 3 | 3 | 3 | 3 | 3 |
| 4 | | 0, 2 | 0, 1 | 4 | 4 | 4 | 4 |
| 5 | | 1, 2 | 0, 2 | 0, 1 | 5 | 5 | 5 |
| 6 | | reserved | 0, 3 | 0, 2 | 0, 1 | 6 | 6 |
| 7 | | | 1, 2 | 0, 3 | 0, 2 | 0, 1 | 7 |
| 8 | | | 1, 3 | 0, 4 | 0, 3 | 0, 2 | 0, 1 |
| 9 | | | 2, 3 | 1, 2 | 0, 4 | 0, 3 | 0, 2 |
| 10 | | | reserved | 1, 3 | 0, 5 | 0, 4 | 0, 3 |
| 11 | | | | 1, 4 | 1, 2 | 0, 5 | 0, 4 |
| 12 | | | | 2, 3 | 1, 3 | 0, 6 | 0, 5 |
| 13 | | | | 2, 4 | 1, 4 | 1, 2 | 0, 6 |
| 14 | | | | 3, 4 | 1, 5 | 1, 3 | 0, 7 |
| 15 | | | | reserved | 2, 3 | 1, 4 | 1, 2 |
| 16 | | | | | 2, 4 | 1, 5 | 1, 3 |
| 17 | | | | | 2, 5 | 1, 6 | 1, 4 |
| 18 | | | | | 3, 4 | 2, 3 | 1, 5 |
| 19 | | | | | 3, 5 | 2, 4 | 1, 6 |
| 20 | | | | | 4, 5 | 2, 5 | 1, 7 |
| 21 | | | | | reserved | 2, 6 | 2, 3 |
| 22 | | | | | | 3, 4 | 2, 4 |
| 23 | | | | | | 3, 5 | 2, 5 |
| 24 | | | | | | 3, 6 | 2, 6 |
| 25 | | | | | | 4, 5 | 2, 7 |
| 26 | | | | | | 4, 6 | 3, 4 |
| 27 | | | | | | 5, 6 | 3, 5 |
| 28 | | | | | | reserved | 3, 6 |
| 29 | | | | | | | 3, 7 |
| 30 | | | | | | | 4, 5 |
| 31 | | | | | | | 4, 6 |
| 32 | | | | | | | 4, 7 |
| 33 | | | | | | | 5, 6 |
| 34 | | | | | | | 5, 7 |
| 35 | | | | | | | 6, 7 |
| 36~63 | | | | | | | reserved |

TABLE X3
SRI indication for non-codebook based PUSCH transmission, Lmax = 3

| Bit | | | | | | | |
|---|---|---|---|---|---|---|---|
| field | | | | | | | |
| mapped | | | | | | | |
| to | SRI(s) | SRI(s) | SRI(s) | SRI(s) | SRI(s) | SRI(s) | SRI(s) |
| index | N_{SRS} = 2 | N_{SRS} = 3 | N_{SRS} = 4 | N_{SRS} = 5 | N_{SRS} = 6 | N_{SRS} = 7 | N_{SRS} = 8 |
| 0 | 0 | 0 | 0 | 0 | 0 | 0 | 0 |
| 1 | 1 | 1 | 1 | 1 | 1 | 1 | 1 |
| 2 | 0, 1 | 2 | 2 | 2 | 2 | 2 | 2 |
| 3 | reserved | 0, 1 | 3 | 3 | 3 | 3 | 3 |
| 4 | | 0, 2 | 0, 1 | 4 | 4 | 4 | 4 |
| 5 | | 1, 2 | 0, 2 | 0, 1 | 5 | 5 | 5 |
| 6 | | 0, 1, 2 | 0, 3 | 0, 2 | 0, 1 | 6 | 6 |
| 7 | | reserved | 1, 2 | 0, 3 | 0, 2 | 0, 1 | 7 |
| 8 | | | 1, 3 | 0, 4 | 0, 3 | 0, 2 | 0, 1 |
| 9 | | | 2, 3 | 1, 2 | 0, 4 | 0, 3 | 0, 2 |
| 10 | | | 0, 1, 2 | 1, 3 | 0, 5 | 0, 4 | 0, 3 |
| 11 | | | 0, 1, 3 | 1, 4 | 1, 2 | 0, 5 | 0, 4 |
| 12 | | | 0, 2, 3 | 2, 3 | 1, 3 | 0, 6 | 0, 5 |
| 13 | | | 1, 2, 3 | 2, 4 | 1, 4 | 1, 2 | 0, 6 |
| 14 | | | reserved | 3, 4 | 1, 5 | 1, 3 | 0, 7 |
| 15 | | | | 0, 1, 2 | 2, 3 | 1, 4 | 1, 2 |
| 16 | | | | 0, 1, 3 | 2, 4 | 1, 5 | 1, 3 |
| 17 | | | | 0, 1, 4 | 2, 5 | 1, 6 | 1, 4 |
| 18 | | | | 0, 2, 3 | 3, 4 | 2, 3 | 1, 5 |
| 19 | | | | 0, 2, 4 | 3, 5 | 2, 4 | 1, 6 |
| 20 | | | | 0, 3, 4 | 4, 5 | 2, 5 | 1, 7 |
| 21 | | | | 1, 2, 3 | 0, 1, 2 | 2, 6 | 2, 3 |
| 22 | | | | 1, 2, 4 | 0, 1, 3 | 3, 4 | 2, 4 |
| 23 | | | | 1, 3, 4 | 0, 1, 4 | 3, 5 | 2, 5 |
| 24 | | | | 2, 3, 4 | 0, 1, 5 | 3, 6 | 2, 6 |
| 25 | | | | reserved | 0, 2, 3 | 4, 5 | 2, 7 |
| 26 | | | | | 0, 2, 4 | 4, 6 | 3, 4 |
| 27 | | | | | 0, 2, 5 | 5, 6 | 3, 5 |
| 28 | | | | | 0, 3, 4 | 0, 1, 2 | 3, 6 |
| 29 | | | | | 0, 3, 5 | 0, 1, 3 | 3, 7 |
| 30 | | | | | 0, 4, 5 | 0, 1, 4 | 4, 5 |
| 31 | | | | | 1, 2, 3 | 0, 1, 5 | 4, 6 |
| 32 | | | | | 1, 2, 4 | 0, 1, 6 | 4, 7 |
| 33 | | | | | 1, 2, 5 | 0, 2, 3 | 5, 6 |
| 34 | | | | | 1, 3, 4 | 0, 2, 4 | 5, 7 |
| 35 | | | | | 1, 3, 5 | 0, 2, 5 | 6, 7 |
| 36 | | | | | 1, 4, 5 | 0, 2, 6 | 0, 1, 2 |
| 37 | | | | | 2, 3, 4 | 0, 3, 4 | 0, 1, 3 |
| 38 | | | | | 2, 3, 5 | 0, 3, 5 | 0, 1, 4 |
| 39 | | | | | 2, 4, 5 | 0, 3, 6 | 0, 1, 5 |
| 40 | | | | | 3, 4, 5 | 0, 4, 5 | 0, 1, 6 |
| 41 | | | | | reserved | 0, 4, 6 | 0, 1, 7 |
| 42 | | | | | | 0, 5, 6 | 0, 2, 3 |
| 43 | | | | | | 1, 2, 3 | 0, 2, 4 |
| 44 | | | | | | 1, 2, 4 | 0, 2, 5 |
| 45 | | | | | | 1, 2, 5 | 0, 2, 6 |
| 46 | | | | | | 1, 2, 6 | 0, 2, 7 |
| 47 | | | | | | 1, 3, 4 | 0, 3, 4 |
| 48 | | | | | | 1, 3, 5 | 0, 3, 5 |
| 49 | | | | | | 1, 3, 6 | 0, 3, 6 |
| 50 | | | | | | 1, 4, 5 | 0, 3, 7 |
| 51 | | | | | | 1, 4, 6 | 0, 4, 5 |
| 52 | | | | | | 1, 5, 6 | 0, 4, 6 |
| 53 | | | | | | 2, 3, 4 | 0, 4, 7 |
| 54 | | | | | | 2, 3, 5 | 0, 5, 6 |
| 55 | | | | | | 2, 3, 6 | 0, 5, 7 |
| 56 | | | | | | 2, 4, 5 | 0, 6, 7 |
| 57 | | | | | | 2, 4, 6 | 1, 2, 3 |
| 58 | | | | | | 2, 5, 6 | 1, 2, 4 |
| 59 | | | | | | 3, 4, 5 | 1, 2, 5 |
| 60 | | | | | | 3, 4, 6 | 1, 2, 6 |
| 61 | | | | | | 3, 5, 6 | 1, 2, 7 |
| 62 | | | | | | 4, 5, 6 | 1, 3, 4 |
| 63 | | | | | | reserved | 1, 3, 5 |
| 64 | | | | | | | 1, 3, 6 |
| 65 | | | | | | | 1, 3, 7 |
| 66 | | | | | | | 1, 4, 5 |
| 67 | | | | | | | 1, 4, 6 |
| 68 | | | | | | | 1, 4, 7 |
| 69 | | | | | | | 1, 5, 6 |
| 70 | | | | | | | 1, 5, 7 |
| 71 | | | | | | | 1, 6, 7 |
| 72 | | | | | | | 2, 3, 4 |
| 73 | | | | | | | 2, 3, 5 |
| 74 | | | | | | | 2, 3, 6 |
| 75 | | | | | | | 2, 3, 7 |
| 76 | | | | | | | 2, 4, 5 |
| 77 | | | | | | | 2, 4, 6 |
| 78 | | | | | | | 2, 4, 7 |
| 79 | | | | | | | 2, 5, 6 |
| 80 | | | | | | | 2, 5, 7 |
| 81 | | | | | | | 2, 6, 7 |
| 82 | | | | | | | 3, 4, 5 |
| 83 | | | | | | | 3, 4, 6 |
| 84 | | | | | | | 3, 4, 7 |
| 85 | | | | | | | 3, 5, 6 |
| 86 | | | | | | | 3, 5, 7 |
| 87 | | | | | | | 3, 6, 7 |
| 88 | | | | | | | 4, 5, 6 |
| 89 | | | | | | | 4, 5, 7 |
| 90 | | | | | | | 4, 6, 7 |
| 91 | | | | | | | 5, 6, 7 |
| 92~127 | | | | | | | reserved |

TABLE X4
SRI indication for non-codebook based PUSCH transmission, Lmax = 4

| Bit field | | | | | | | |
|---|---|---|---|---|---|---|---|
| mapped | SRI(s) | SRI(s) | SRI(s) | SRI(s) | SRI(s) | SRI(s) | SRI(s) |
| to index | N_{SRS} = 2 | N_{SRS} = 3 | N_{SRS} = 4 | N_{SRS} = 5 | N_{SRS} = 6 | N_{SRS} = 7 | N_{SRS} = 8 |
| 0 | 0 | 0 | 0 | 0 | 0 | 0 | 0 |
| 1 | 1 | 1 | 1 | 1 | 1 | 1 | 1 |
| 2 | 0, 1 | 2 | 2 | 2 | 2 | 2 | 2 |
| 3 | reserved | 0, 1 | 3 | 3 | 3 | 3 | 3 |
| 4 | | 0, 2 | 0, 1 | 4 | 4 | 4 | 4 |
| 5 | | 1, 2 | 0, 2 | 0, 1 | 5 | 5 | 5 |
| 6 | | 0, 1, 2 | 0, 3 | 0, 2 | 0, 1 | 6 | 6 |
| 7 | | reserved | 1, 2 | 0, 3 | 0, 2 | 0, 1 | 7 |
| 8 | | | 1, 3 | 0, 4 | 0, 3 | 0, 2 | 0, 1 |
| 9 | | | 2, 3 | 1, 2 | 0, 4 | 0, 3 | 0, 2 |
| 10 | | | 0, 1, 2 | 1, 3 | 0, 5 | 0, 4 | 0, 3 |
| 11 | | | 0, 1, 3 | 1, 4 | 1, 2 | 0, 5 | 0, 4 |
| 12 | | | 0, 2, 3 | 2, 3 | 1, 3 | 0, 6 | 0, 5 |
| 13 | | | 1, 2, 3 | 2, 4 | 1, 4 | 1, 2 | 0, 6 |
| 14 | | | 0, 1, 2, 3 | 3, 4 | 1, 5 | 1, 3 | 0, 7 |
| 15 | | | reserved | 0, 1, 2 | 2, 3 | 1, 4 | 1, 2 |
| 16 | | | | 0, 1, 3 | 2, 4 | 1, 5 | 1, 3 |
| 17 | | | | 0, 1, 4 | 2, 5 | 1, 6 | 1, 4 |
| 18 | | | | 0, 2, 3 | 3, 4 | 2, 3 | 1, 5 |
| 19 | | | | 0, 2, 4 | 3, 5 | 2, 4 | 1, 6 |
| 20 | | | | 0, 3, 4 | 4, 5 | 2, 5 | 1, 7 |
| 21 | | | | 1, 2, 3 | 0, 1, 2 | 2, 6 | 2, 3 |
| 22 | | | | 1, 2, 4 | 0, 1, 3 | 3, 4 | 2, 4 |
| 23 | | | | 1, 3, 4 | 0, 1, 4 | 3, 5 | 2, 5 |
| 24 | | | | 2, 3, 4 | 0, 1, 5 | 3, 6 | 2, 6 |
| 25 | | | | 0, 1, 2, 3 | 0, 2, 3 | 4, 5 | 2, 7 |
| 26 | | | | 0, 1, 2, 4 | 0, 2, 4 | 4, 6 | 3, 4 |
| 27 | | | | 0, 1, 3, 4 | 0, 2, 5 | 5, 6 | 3, 5 |
| 28 | | | | 0, 2, 3, 4 | 0, 3, 4 | 0, 1, 2 | 3, 6 |
| 29 | | | | 1, 2, 3, 4 | 0, 3, 5 | 0, 1, 3 | 3, 7 |
| 30 | | | | reserved | 0, 4, 5 | 0, 1, 4 | 4, 5 |
| 31 | | | | | 1, 2, 3 | 0, 1, 5 | 4, 6 |
| 32 | | | | | 1, 2, 4 | 0, 1, 6 | 4, 7 |
| 33 | | | | | 1, 2, 5 | 0, 2, 3 | 5, 6 |
| 34 | | | | | 1, 3, 4 | 0, 2, 4 | 5, 7 |
| 35 | | | | | 1, 3, 5 | 0, 2, 5 | 6, 7 |
| 36 | | | | | 1, 4, 5 | 0, 2, 6 | 0, 1, 2 |
| 37 | | | | | 2, 3, 4 | 0, 3, 4 | 0, 1, 3 |
| 38 | | | | | 2, 3, 5 | 0, 3, 5 | 0, 1, 4 |
| 39 | | | | | 2, 4, 5 | 0, 3, 6 | 0, 1, 5 |
| 40 | | | | | 3, 4, 5 | 0, 4, 5 | 0, 1, 6 |
| 41 | | | | | 0, 1, 2, 3 | 0, 4, 6 | 0, 1, 7 |
| 42 | | | | | 0, 1, 2, 4 | 0, 5, 6 | 0, 2, 3 |
| 43 | | | | | 0, 1, 2, 5 | 1, 2, 3 | 0, 2, 4 |
| 44 | | | | | 0, 1, 3, 4 | 1, 2, 4 | 0, 2, 5 |
| 45 | | | | | 0, 1, 3, 5 | 1, 2, 5 | 0, 2, 6 |
| 46 | | | | | 0, 1, 4, 5 | 1, 2, 6 | 0, 2, 7 |
| 47 | | | | | 0, 2, 3, 4 | 1, 3, 4 | 0, 3, 4 |
| 48 | | | | | 0, 2, 3, 5 | 1, 3, 5 | 0, 3, 5 |
| 49 | | | | | 0, 2, 4, 5 | 1, 3, 6 | 0, 3, 6 |
| 50 | | | | | 0, 3, 4, 5 | 1, 4, 5 | 0, 3, 7 |
| 51 | | | | | 1, 2, 3, 4 | 1, 4, 6 | 0, 4, 5 |
| 52 | | | | | 1, 2, 3, 5 | 1, 5, 6 | 0, 4, 6 |
| 53 | | | | | 1, 2, 4, 5 | 2, 3, 4 | 0, 4, 7 |
| 54 | | | | | 1, 3, 4, 5 | 2, 3, 5 | 0, 5, 6 |
| 55 | | | | | 2, 3, 4, 5 | 2, 3, 6 | 0, 5, 7 |
| 56 | | | | | reserved | 2, 4, 5 | 0, 6, 7 |
| 57 | | | | | | 2, 4, 6 | 1, 2, 3 |
| 58 | | | | | | 2, 5, 6 | 1, 2, 4 |
| 59 | | | | | | 3, 4, 5 | 1, 2, 5 |
| 60 | | | | | | 3, 4, 6 | 1, 2, 6 |
| 61 | | | | | | 3, 5, 6 | 1, 2, 7 |
| 62 | | | | | | 4, 5, 6 | 1, 3, 4 |
| 63 | | | | | | 0, 1, 2, 3 | 1, 3, 5 |
| 64 | | | | | | 0, 1, 2, 4 | 1, 3, 6 |
| 65 | | | | | | 0, 1, 2, 5 | 1, 3, 7 |
| 66 | | | | | | 0, 1, 2, 6 | 1, 4, 5 |
| 67 | | | | | | 0, 1, 3, 4 | 1, 4, 6 |
| 68 | | | | | | 0, 1, 3, 5 | 1, 4, 7 |
| 69 | | | | | | 0, 1, 3, 6 | 1, 5, 6 |
| 70 | | | | | | 0, 1, 4, 5 | 1, 5, 7 |
| 71 | | | | | | 0, 1, 4, 6 | 1, 6, 7 |
| 72 | | | | | | 0, 1, 5, 6 | 2, 3, 4 |
| 73 | | | | | | 0, 2, 3, 4 | 2, 3, 5 |
| 74 | | | | | | 0, 2, 3, 5 | 2, 3, 6 |
| 75 | | | | | | 0, 2, 3, 6 | 2, 3, 7 |
| 76 | | | | | | 0, 2, 4, 5 | 2, 4, 5 |
| 77 | | | | | | 0, 2, 4, 6 | 2, 4, 6 |
| 78 | | | | | | 0, 2, 5, 6 | 2, 4, 7 |
| 79 | | | | | | 0, 3, 4, 5 | 2, 5, 6 |
| 80 | | | | | | 0, 3, 4, 6 | 2, 5, 7 |
| 81 | | | | | | 0, 3, 5, 6 | 2, 6, 7 |
| 82 | | | | | | 0, 4, 5, 6 | 3, 4, 5 |
| 83 | | | | | | 1, 2, 3, 4 | 3, 4, 6 |
| 84 | | | | | | 1, 2, 3, 5 | 3, 4, 7 |
| 85 | | | | | | 1, 2, 3, 6 | 3, 5, 6 |
| 86 | | | | | | 1, 2, 4, 5 | 3, 5, 7 |
| 87 | | | | | | 1, 2, 4, 6 | 3, 6, 7 |
| 88 | | | | | | 1, 2, 5, 6 | 4, 5, 6 |
| 89 | | | | | | 1, 3, 4, 5 | 4, 5, 7 |
| 90 | | | | | | 1, 3, 4, 6 | 4, 6, 7 |
| 91 | | | | | | 1, 3, 5, 6 | 5, 6, 7 |
| 92 | | | | | | 1, 4, 5, 6 | 0, 1, 2, 3 |
| 93 | | | | | | 2, 3, 4, 5 | 0, 1, 2, 4 |
| 94 | | | | | | 2, 3, 4, 6 | 0, 1, 2, 5 |
| 95 | | | | | | 2, 3, 5, 6 | 0, 1, 2, 6 |
| 96 | | | | | | 2, 4, 5, 6 | 0, 1, 2, 7 |
| 97 | | | | | | 3, 4, 5, 6 | 0, 1, 3, 4 |
| 98 | | | | | | reserved | 0, 1, 3, 5 |
| 99 | | | | | | | 0, 1, 3, 6 |
| 100 | | | | | | | 0, 1, 3, 7 |
| 101 | | | | | | | 0, 1, 4, 5 |
| 102 | | | | | | | 0, 1, 4, 6 |
| 103 | | | | | | | 0, 1, 4, 7 |
| 104 | | | | | | | 0, 1, 5, 6 |
| 105 | | | | | | | 0, 1, 5, 7 |
| 106 | | | | | | | 0, 1, 6, 7 |
| 107 | | | | | | | 0, 2, 3, 4 |
| 108 | | | | | | | 0, 2, 3, 5 |
| 109 | | | | | | | 0, 2, 3, 6 |
| 110 | | | | | | | 0, 2, 3, 7 |
| 111 | | | | | | | 0, 2, 4, 5 |
| 112 | | | | | | | 0, 2, 4, 6 |
| 113 | | | | | | | 0, 2, 4, 7 |
| 114 | | | | | | | 0, 2, 5, 6 |
| 115 | | | | | | | 0, 2, 5, 7 |
| 116 | | | | | | | 0, 2, 6, 7 |
| 117 | | | | | | | 0, 3, 4, 5 |
| 118 | | | | | | | 0, 3, 4, 6 |
| 119 | | | | | | | 0, 3, 4, 7 |
| 120 | | | | | | | 0, 3, 5, 6 |
| 121 | | | | | | | 0, 3, 5, 7 |
| 122 | | | | | | | 0, 3, 6, 7 |
| 123 | | | | | | | 0, 4, 5, 6 |
| 124 | | | | | | | 0, 4, 5, 7 |
| 125 | | | | | | | 0, 4, 6, 7 |
| 126 | | | | | | | 0, 5, 6, 7 |
| 127 | | | | | | | 1, 2, 3, 4 |
| 128 | | | | | | | 1, 2, 3, 5 |
| 129 | | | | | | | 1, 2, 3, 6 |
| 130 | | | | | | | 1, 2, 3, 7 |
| 131 | | | | | | | 1, 2, 4, 5 |
| 132 | | | | | | | 1, 2, 4, 6 |
| 133 | | | | | | | 1, 2, 4, 7 |
| 134 | | | | | | | 1, 2, 5, 6 |
| 135 | | | | | | | 1, 2, 5, 7 |
| 136 | | | | | | | 1, 2, 6, 7 |
| 137 | | | | | | | 1, 3, 4, 5 |
| 138 | | | | | | | 1, 3, 4, 6 |
| 139 | | | | | | | 1, 3, 4, 7 |
| 140 | | | | | | | 1, 3, 5, 6 |
| 141 | | | | | | | 1, 3, 5, 7 |
| 142 | | | | | | | 1, 3, 6, 7 |
| 143 | | | | | | | 1, 4, 5, 6 |
| 144 | | | | | | | 1, 4, 5, 7 |
| 145 | | | | | | | 1, 4, 6, 7 |
| 146 | | | | | | | 1, 5, 6, 7 |
| 147 | | | | | | | 2, 3, 4, 5 |
| 148 | | | | | | | 2, 3, 4, 6 |
| 149 | | | | | | | 2, 3, 4, 7 |
| 150 | | | | | | | 2, 3, 5, 6 |
| 151 | | | | | | | 2, 3, 5, 7 |
| 152 | | | | | | | 2, 3, 6, 7 |
| 153 | | | | | | | 2, 4, 5, 6 |
| 154 | | | | | | | 2, 4, 5, 7 |
| 155 | | | | | | | 2, 4, 6, 7 |
| 156 | | | | | | | 2, 5, 6, 7 |
| 157 | | | | | | | 3, 4, 5, 6 |
| 158 | | | | | | | 3, 4, 5, 7 |
| 159 | | | | | | | 3, 4, 6, 7 |
| 160 | | | | | | | 3, 5, 6, 7 |
| 161 | | | | | | | 4, 5, 6, 7 |
| 162~255 | | | | | | | reserved |

TABLE X5
SRI indication for non-codebook based PUSCH transmission, Lmax = 5

| Bit field | | | | | | | |
|---|---|---|---|---|---|---|---|
| mapped | SRI(s) | SRI(s) | SRI(s) | SRI(s) | SRI(s) | SRI(s) | SRI(s) |
| to index | N_{SRS} = 2 | N_{SRS} = 3 | N_{SRS} = 4 | N_{SRS} = 5 | N_{SRS} = 6 | N_{SRS} = 7 | N_{SRS} = 8 |
| 0 | 0 | 0 | 0 | 0 | 0 | 0 | 0 |
| 1 | 1 | 1 | 1 | 1 | 1 | 1 | 1 |
| 2 | 0, 1 | 2 | 2 | 2 | 2 | 2 | 2 |
| 3 | reserved | 0, 1 | 3 | 3 | 3 | 3 | 3 |
| 4 | | 0, 2 | 0, 1 | 4 | 4 | 4 | 4 |
| 5 | | 1, 2 | 0, 2 | 0, 1 | 5 | 5 | 5 |
| 6 | | 0, 1, 2 | 0, 3 | 0, 2 | 0, 1 | 6 | 6 |
| 7 | | reserved | 1, 2 | 0, 3 | 0, 2 | 0, 1 | 7 |
| 8 | | | 1, 3 | 0, 4 | 0, 3 | 0, 2 | 0, 1 |
| 9 | | | 2, 3 | 1, 2 | 0, 4 | 0, 3 | 0, 2 |
| 10 | | | 0, 1, 2 | 1, 3 | 0, 5 | 0, 4 | 0, 3 |
| 11 | | | 0, 1, 3 | 1, 4 | 1, 2 | 0, 5 | 0, 4 |
| 12 | | | 0, 2, 3 | 2, 3 | 1, 3 | 0, 6 | 0, 5 |
| 13 | | | 1, 2, 3 | 2, 4 | 1, 4 | 1, 2 | 0, 6 |
| 14 | | | 0, 1, 2, 3 | 3, 4 | 1, 5 | 1, 3 | 0, 7 |
| 15 | | | reserved | 0, 1, 2 | 2, 3 | 1, 4 | 1, 2 |
| 16 | | | | 0, 1, 3 | 2, 4 | 1, 5 | 1, 3 |
| 17 | | | | 0, 1, 4 | 2, 5 | 1, 6 | 1, 4 |
| 18 | | | | 0, 2, 3 | 3, 4 | 2, 3 | 1, 5 |
| 19 | | | | 0, 2, 4 | 3, 5 | 2, 4 | 1, 6 |
| 20 | | | | 0, 3, 4 | 4, 5 | 2, 5 | 1, 7 |
| 21 | | | | 1, 2, 3 | 0, 1, 2 | 2, 6 | 2, 3 |
| 22 | | | | 1, 2, 4 | 0, 1, 3 | 3, 4 | 2, 4 |
| 23 | | | | 1, 3, 4 | 0, 1, 4 | 3, 5 | 2, 5 |
| 24 | | | | 2, 3, 4 | 0, 1, 5 | 3, 6 | 2, 6 |
| 25 | | | | 0, 1, 2, 3 | 0, 2, 3 | 4, 5 | 2, 7 |
| 26 | | | | 0, 1, 2, 4 | 0, 2, 4 | 4, 6 | 3, 4 |
| 27 | | | | 0, 1, 3, 4 | 0, 2, 5 | 5, 6 | 3, 5 |
| 28 | | | | 0, 2, 3, 4 | 0, 3, 4 | 0, 1, 2 | 3, 6 |
| 29 | | | | 1, 2, 3, 4 | 0, 3, 5 | 0, 1, 3 | 3, 7 |
| 30 | | | | 0, 1, 2, 3, 4 | 0, 4, 5 | 0, 1, 4 | 4, 5 |
| 31 | | | | reserved | 1, 2, 3 | 0, 1, 5 | 4, 6 |
| 32 | | | | | 1, 2, 4 | 0, 1, 6 | 4, 7 |
| 33 | | | | | 1, 2, 5 | 0, 2, 3 | 5, 6 |
| 34 | | | | | 1, 3, 4 | 0, 2, 4 | 5, 7 |
| 35 | | | | | 1, 3, 5 | 0, 2, 5 | 6, 7 |
| 36 | | | | | 1, 4, 5 | 0, 2, 6 | 0, 1, 2 |
| 37 | | | | | 2, 3, 4 | 0, 3, 4 | 0, 1, 3 |
| 38 | | | | | 2, 3, 5 | 0, 3, 5 | 0, 1, 4 |
| 39 | | | | | 2, 4, 5 | 0, 3, 6 | 0, 1, 5 |
| 40 | | | | | 3, 4, 5 | 0, 4, 5 | 0, 1, 6 |
| 41 | | | | | 0, 1, 2, 3 | 0, 4, 6 | 0, 1, 7 |
| 42 | | | | | 0, 1, 2, 4 | 0, 5, 6 | 0, 2, 3 |
| 43 | | | | | 0, 1, 2, 5 | 1, 2, 3 | 0, 2, 4 |
| 44 | | | | | 0, 1, 3, 4 | 1, 2, 4 | 0, 2, 5 |
| 45 | | | | | 0, 1, 3, 5 | 1, 2, 5 | 0, 2, 6 |
| 46 | | | | | 0, 1, 4, 5 | 1, 2, 6 | 0, 2, 7 |
| 47 | | | | | 0, 2, 3, 4 | 1, 3, 4 | 0, 3, 4 |
| 48 | | | | | 0, 2, 3, 5 | 1, 3, 5 | 0, 3, 5 |
| 49 | | | | | 0, 2, 4, 5 | 1, 3, 6 | 0, 3, 6 |
| 50 | | | | | 0, 3, 4, 5 | 1, 4, 5 | 0, 3, 7 |
| 51 | | | | | 1, 2, 3, 4 | 1, 4, 6 | 0, 4, 5 |
| 52 | | | | | 1, 2, 3, 5 | 1, 5, 6 | 0, 4, 6 |
| 53 | | | | | 1, 2, 4, 5 | 2, 3, 4 | 0, 4, 7 |
| 54 | | | | | 1, 3, 4, 5 | 2, 3, 5 | 0, 5, 6 |
| 55 | | | | | 2, 3, 4, 5 | 2, 3, 6 | 0, 5, 7 |
| 56 | | | | | 0, 1, 2, 3, 4 | 2, 4, 5 | 0, 6, 7 |
| 57 | | | | | 0, 1, 2, 3, 5 | 2, 4, 6 | 1, 2, 3 |
| 58 | | | | | 0, 1, 2, 4, 5 | 2, 5, 6 | 1, 2, 4 |
| 59 | | | | | 0, 1, 3, 4, 5 | 3, 4, 5 | 1, 2, 5 |
| 60 | | | | | 0, 2, 3, 4, 5 | 3, 4, 6 | 1, 2, 6 |
| 61 | | | | | 1, 2, 3, 4, 5 | 3, 5, 6 | 1, 2, 7 |
| 62 | | | | | reserved | 4, 5, 6 | 1, 3, 4 |
| 63 | | | | | | 0, 1, 2, 3 | 1, 3, 5 |
| 64 | | | | | | 0, 1, 2, 4 | 1, 3, 6 |
| 65 | | | | | | 0, 1, 2, 5 | 1, 3, 7 |
| 66 | | | | | | 0, 1, 2, 6 | 1, 4, 5 |
| 67 | | | | | | 0, 1, 3, 4 | 1, 4, 6 |
| 68 | | | | | | 0, 1, 3, 5 | 1, 4, 7 |
| 69 | | | | | | 0, 1, 3, 6 | 1, 5, 6 |
| 70 | | | | | | 0, 1, 4, 5 | 1, 5, 7 |
| 71 | | | | | | 0, 1, 4, 6 | 1, 6, 7 |
| 72 | | | | | | 0, 1, 5, 6 | 2, 3, 4 |
| 73 | | | | | | 0, 2, 3, 4 | 2, 3, 5 |
| 74 | | | | | | 0, 2, 3, 5 | 2, 3, 6 |
| 75 | | | | | | 0, 2, 3, 6 | 2, 3, 7 |
| 76 | | | | | | 0, 2, 4, 5 | 2, 4, 5 |
| 77 | | | | | | 0, 2, 4, 6 | 2, 4, 6 |
| 78 | | | | | | 0, 2, 5, 6 | 2, 4, 7 |
| 79 | | | | | | 0, 3, 4, 5 | 2, 5, 6 |
| 80 | | | | | | 0, 3, 4, 6 | 2, 5, 7 |
| 81 | | | | | | 0, 3, 5, 6 | 2, 6, 7 |
| 82 | | | | | | 0, 4, 5, 6 | 3, 4, 5 |
| 83 | | | | | | 1, 2, 3, 4 | 3, 4, 6 |
| 84 | | | | | | 1, 2, 3, 5 | 3, 4, 7 |
| 85 | | | | | | 1, 2, 3, 6 | 3, 5, 6 |
| 86 | | | | | | 1, 2, 4, 5 | 3, 5, 7 |
| 87 | | | | | | 1, 2, 4, 6 | 3, 6, 7 |
| 88 | | | | | | 1, 2, 5, 6 | 4, 5, 6 |
| 89 | | | | | | 1, 3, 4, 5 | 4, 5, 7 |
| 90 | | | | | | 1, 3, 4, 6 | 4, 6, 7 |
| 91 | | | | | | 1, 3, 5, 6 | 5, 6, 7 |
| 92 | | | | | | 1, 4, 5, 6 | 0, 1, 2, 3 |
| 93 | | | | | | 2, 3, 4, 5 | 0, 1, 2, 4 |
| 94 | | | | | | 2, 3, 4, 6 | 0, 1, 2, 5 |
| 95 | | | | | | 2, 3, 5, 6 | 0, 1, 2, 6 |
| 96 | | | | | | 2, 4, 5, 6 | 0, 1, 2, 7 |
| 97 | | | | | | 3, 4, 5, 6 | 0, 1, 3, 4 |
| 98 | | | | | | 0, 1, 2, 3, 4 | 0, 1, 3, 5 |
| 99 | | | | | | 0, 1, 2, 3, 5 | 0, 1, 3, 6 |
| 100 | | | | | | 0, 1, 2, 3, 6 | 0, 1, 3, 7 |
| 101 | | | | | | 0, 1, 2, 4, 5 | 0, 1, 4, 5 |
| 102 | | | | | | 0, 1, 2, 4, 6 | 0, 1, 4, 6 |
| 103 | | | | | | 0, 1, 2, 5, 6 | 0, 1, 4, 7 |
| 104 | | | | | | 0, 1, 3, 4, 5 | 0, 1, 5, 6 |
| 105 | | | | | | 0, 1, 3, 4, 6 | 0, 1, 5, 7 |
| 106 | | | | | | 0, 1, 3, 5, 6 | 0, 1, 6, 7 |
| 107 | | | | | | 0, 1, 4, 5, 6 | 0, 2, 3, 4 |
| 108 | | | | | | 0, 2, 3, 4, 5 | 0, 2, 3, 5 |
| 109 | | | | | | 0, 2, 3, 4, 6 | 0, 2, 3, 6 |
| 110 | | | | | | 0, 2, 3, 5, 6 | 0, 2, 3, 7 |
| 111 | | | | | | 0, 2, 4, 5, 6 | 0, 2, 4, 5 |
| 112 | | | | | | 0, 3, 4, 5, 6 | 0, 2, 4, 6 |
| 113 | | | | | | 1, 2, 3, 4, 5 | 0, 2, 4, 7 |
| 114 | | | | | | 1, 2, 3, 4, 6 | 0, 2, 5, 6 |
| 115 | | | | | | 1, 2, 3, 5, 6 | 0, 2, 5, 7 |
| 116 | | | | | | 1, 2, 4, 5, 6 | 0, 2, 6, 7 |
| 117 | | | | | | 1, 3, 4, 5, 6 | 0, 3, 4, 5 |
| 118 | | | | | | 2, 3, 4, 5, 6 | 0, 3, 4, 6 |
| 119 | | | | | | reserved | 0, 3, 4, 7 |
| 120 | | | | | | | 0, 3, 5, 6 |
| 121 | | | | | | | 0, 3, 5, 7 |
| 122 | | | | | | | 0, 3, 6, 7 |
| 123 | | | | | | | 0, 4, 5, 6 |
| 124 | | | | | | | 0, 4, 5, 7 |
| 125 | | | | | | | 0, 4, 6, 7 |
| 126 | | | | | | | 0, 5, 6, 7 |
| 127 | | | | | | | 1, 2, 3, 4 |
| 128 | | | | | | | 1, 2, 3, 5 |
| 129 | | | | | | | 1, 2, 3, 6 |
| 130 | | | | | | | 1, 2, 3, 7 |
| 131 | | | | | | | 1, 2, 4, 5 |
| 132 | | | | | | | 1, 2, 4, 6 |
| 133 | | | | | | | 1, 2, 4, 7 |
| 134 | | | | | | | 1, 2, 5, 6 |
| 135 | | | | | | | 1, 2, 5, 7 |
| 136 | | | | | | | 1, 2, 6, 7 |
| 137 | | | | | | | 1, 3, 4, 5 |
| 138 | | | | | | | 1, 3, 4, 6 |
| 139 | | | | | | | 1, 3, 4, 7 |
| 140 | | | | | | | 1, 3, 5, 6 |
| 141 | | | | | | | 1, 3, 5, 7 |
| 142 | | | | | | | 1, 3, 6, 7 |
| 143 | | | | | | | 1, 4, 5, 6 |
| 144 | | | | | | | 1, 4, 5, 7 |
| 145 | | | | | | | 1, 4, 6, 7 |
| 146 | | | | | | | 1, 5, 6, 7 |
| 147 | | | | | | | 2, 3, 4, 5 |
| 148 | | | | | | | 2, 3, 4, 6 |
| 149 | | | | | | | 2, 3, 4, 7 |
| 150 | | | | | | | 2, 3, 5, 6 |
| 151 | | | | | | | 2, 3, 5, 7 |
| 152 | | | | | | | 2, 3, 6, 7 |
| 153 | | | | | | | 2, 4, 5, 6 |
| 154 | | | | | | | 2, 4, 5, 7 |
| 155 | | | | | | | 2, 4, 6, 7 |
| 156 | | | | | | | 2, 5, 6, 7 |
| 157 | | | | | | | 3, 4, 5, 6 |
| 158 | | | | | | | 3, 4, 5, 7 |
| 159 | | | | | | | 3, 4, 6, 7 |
| 160 | | | | | | | 3, 5, 6, 7 |
| 161 | | | | | | | 4, 5, 6, 7 |
| 163 | | | | | | | 0, 1, 2, 3, 4 |
| 164 | | | | | | | 0, 1, 2, 3, 5 |
| 165 | | | | | | | 0, 1, 2, 3, 6 |
| 166 | | | | | | | 0, 1, 2, 3, 7 |
| 167 | | | | | | | 0, 1, 2, 4, 5 |
| 168 | | | | | | | 0, 1, 2, 4, 6 |
| 169 | | | | | | | 0, 1, 2, 4, 7 |
| 170 | | | | | | | 0, 1, 2, 5, 6 |
| 171 | | | | | | | 0, 1, 2, 5, 7 |
| 172 | | | | | | | 0, 1, 2, 6, 7 |
| 173 | | | | | | | 0, 1, 3, 4, 5 |
| 174 | | | | | | | 0, 1, 3, 4, 6 |
| 175 | | | | | | | 0, 1, 3, 4, 7 |
| 176 | | | | | | | 0, 1, 3, 5, 6 |
| 177 | | | | | | | 0, 1, 3, 5, 7 |
| 178 | | | | | | | 0, 1, 3, 6, 7 |
| 179 | | | | | | | 0, 1, 3, 4, 5 |
| 180 | | | | | | | 0, 1, 3, 4, 6 |
| 181 | | | | | | | 0, 1, 3, 4, 7 |
| 182 | | | | | | | 0, 1, 3, 5, 6 |
| 183 | | | | | | | 0, 1, 3, 5, 7 |
| 184 | | | | | | | 0, 1, 3, 6, 7 |
| 185 | | | | | | | 0, 1, 4, 5, 6 |
| 186 | | | | | | | 0, 1, 4, 5, 7 |
| 187 | | | | | | | 0, 1, 4, 6, 7 |
| 188 | | | | | | | 0, 1, 5, 6, 7 |
| 189 | | | | | | | 0, 2, 3, 4, 5 |
| 190 | | | | | | | 0, 2, 3, 4, 6 |
| 191 | | | | | | | 0, 2, 3, 4, 7 |
| 192 | | | | | | | 0, 2, 3, 5, 6 |
| 193 | | | | | | | 0, 2, 3, 5, 7 |
| 194 | | | | | | | 0, 2, 3, 6, 7 |
| 195 | | | | | | | 0, 3, 4, 5, 6 |
| 196 | | | | | | | 0, 3, 4, 5, 7 |
| 197 | | | | | | | 0, 3, 4, 6, 7 |
| 198 | | | | | | | 0, 4, 5, 6, 7 |
| 199 | | | | | | | 1, 2, 3, 4, 5 |
| 200 | | | | | | | 1, 2, 3, 4, 6 |
| 201 | | | | | | | 1, 2, 3, 4, 7 |
| 202 | | | | | | | 1, 2, 3, 5, 6 |
| 203 | | | | | | | 1, 2, 3, 5, 7 |
| 204 | | | | | | | 1, 2, 3, 6, 7 |
| 205 | | | | | | | 1, 2, 4, 5, 6 |
| 206 | | | | | | | 1, 2, 4, 5, 7 |
| 207 | | | | | | | 1, 2, 4, 6, 7 |
| 208 | | | | | | | 1, 3, 4, 5, 6 |
| 209 | | | | | | | 1, 3, 4, 5, 7 |
| 211 | | | | | | | 1, 3, 4, 6, 7 |
| 212 | | | | | | | 1, 3, 5, 6, 7 |
| 213 | | | | | | | 1, 4, 5, 6, 7 |
| 214 | | | | | | | 2, 3, 4, 5, 6 |
| 215 | | | | | | | 2, 3, 4, 5, 7 |
| 216 | | | | | | | 2, 3, 4, 6, 7 |
| 217 | | | | | | | 2, 3, 5, 6, 7 |
| 218 | | | | | | | 3, 4, 5, 6, 7 |
| 219~255 | | | | | | | reserved |

TABLE X6
SRI indication for non-codebook based PUSCH transmission, Lmax = 6

| Bit field | | | | | | | |
|---|---|---|---|---|---|---|---|
| mapped | SRI(s) | SRI(s) | SRI(s) | SRI(s) | SRI(s) | SRI(s) | SRI(s) |
| to index | N_{SRS} = 2 | N_{SRS} = 3 | N_{SRS} = 4 | N_{SRS} = 5 | N_{SRS} = 6 | N_{SRS} = 7 | N_{SRS} = 8 |
| 0 | 0 | 0 | 0 | 0 | 0 | 0 | 0 |
| 1 | 1 | 1 | 1 | 1 | 1 | 1 | 1 |
| 2 | 0, 1 | 2 | 2 | 2 | 2 | 2 | 2 |
| 3 | reserved | 0, 1 | 3 | 3 | 3 | 3 | 3 |
| 4 | | 0, 2 | 0, 1 | 4 | 4 | 4 | 4 |
| 5 | | 1, 2 | 0, 2 | 0, 1 | 5 | 5 | 5 |
| 6 | | 0, 1, 2 | 0, 3 | 0, 2 | 0, 1 | 6 | 6 |
| 7 | | reserved | 1, 2 | 0, 3 | 0, 2 | 0, 1 | 7 |
| 8 | | | 1, 3 | 0, 4 | 0, 3 | 0, 2 | 0, 1 |
| 9 | | | 2, 3 | 1, 2 | 0, 4 | 0, 3 | 0, 2 |
| 10 | | | 0, 1, 2 | 1, 3 | 0, 5 | 0, 4 | 0, 3 |
| 11 | | | 0, 1, 3 | 1, 4 | 1, 2 | 0, 5 | 0, 4 |
| 12 | | | 0, 2, 3 | 2, 3 | 1, 3 | 0, 6 | 0, 5 |
| 13 | | | 1, 2, 3 | 2, 4 | 1, 4 | 1, 2 | 0, 6 |
| 14 | | | 0, 1, 2, 3 | 3, 4 | 1, 5 | 1, 3 | 0, 7 |
| 15 | | | reserved | 0, 1, 2 | 2, 3 | 1, 4 | 1, 2 |
| 16 | | | | 0, 1, 3 | 2, 4 | 1, 5 | 1, 3 |
| 17 | | | | 0, 1, 4 | 2, 5 | 1, 6 | 1, 4 |
| 18 | | | | 0, 2, 3 | 3, 4 | 2, 3 | 1, 5 |
| 19 | | | | 0, 2, 4 | 3, 5 | 2, 4 | 1, 6 |
| 20 | | | | 0, 3, 4 | 4, 5 | 2, 5 | 1, 7 |
| 21 | | | | 1, 2, 3 | 0, 1, 2 | 2, 6 | 2, 3 |
| 22 | | | | 1, 2, 4 | 0, 1, 3 | 3, 4 | 2, 4 |
| 23 | | | | 1, 3, 4 | 0, 1, 4 | 3, 5 | 2, 5 |
| 24 | | | | 2, 3, 4 | 0, 1, 5 | 3, 6 | 2, 6 |
| 25 | | | | 0, 1, 2, 3 | 0, 2, 3 | 4, 5 | 2, 7 |
| 26 | | | | 0, 1, 2, 4 | 0, 2, 4 | 4, 6 | 3, 4 |
| 27 | | | | 0, 1, 3, 4 | 0, 2, 5 | 5, 6 | 3, 5 |
| 28 | | | | 0, 2, 3, 4 | 0, 3, 4 | 0, 1, 2 | 3, 6 |
| 29 | | | | 1, 2, 3, 4 | 0, 3, 5 | 0, 1, 3 | 3, 7 |
| 30 | | | | 0, 1, 2, 3, 4 | 0, 4, 5 | 0, 1, 4 | 4, 5 |
| 31 | | | | reserved | 1, 2, 3 | 0, 1, 5 | 4, 6 |
| 32 | | | | | 1, 2, 4 | 0, 1, 6 | 4, 7 |
| 33 | | | | | 1, 2, 5 | 0, 2, 3 | 5, 6 |
| 34 | | | | | 1, 3, 4 | 0, 2, 4 | 5, 7 |
| 35 | | | | | 1, 3, 5 | 0, 2, 5 | 6, 7 |
| 36 | | | | | 1, 4, 5 | 0, 2, 6 | 0, 1, 2 |
| 37 | | | | | 2, 3, 4 | 0, 3, 4 | 0, 1, 3 |
| 38 | | | | | 2, 3, 5 | 0, 3, 5 | 0, 1, 4 |
| 39 | | | | | 2, 4, 5 | 0, 3, 6 | 0, 1, 5 |
| 40 | | | | | 3, 4, 5 | 0, 4, 5 | 0, 1, 6 |
| 41 | | | | | 0, 1, 2, 3 | 0, 4, 6 | 0, 1, 7 |
| 42 | | | | | 0, 1, 2, 4 | 0, 5, 6 | 0, 2, 3 |
| 43 | | | | | 0, 1, 2, 5 | 1, 2, 3 | 0, 2, 4 |
| 44 | | | | | 0, 1, 3, 4 | 1, 2, 4 | 0, 2, 5 |
| 45 | | | | | 0, 1, 3, 5 | 1, 2, 5 | 0, 2, 6 |
| 46 | | | | | 0, 1, 4, 5 | 1, 2, 6 | 0, 2, 7 |
| 47 | | | | | 0, 2, 3, 4 | 1, 3, 4 | 0, 3, 4 |
| 48 | | | | | 0, 2, 3, 5 | 1, 3, 5 | 0, 3, 5 |
| 49 | | | | | 0, 2, 4, 5 | 1, 3, 6 | 0, 3, 6 |
| 50 | | | | | 0, 3, 4, 5 | 1, 4, 5 | 0, 3, 7 |
| 51 | | | | | 1, 2, 3, 4 | 1, 4, 6 | 0, 4, 5 |
| 52 | | | | | 1, 2, 3, 5 | 1, 5, 6 | 0, 4, 6 |
| 53 | | | | | 1, 2, 4, 5 | 2, 3, 4 | 0, 4, 7 |
| 54 | | | | | 1, 3, 4, 5 | 2, 3, 5 | 0, 5, 6 |
| 55 | | | | | 2, 3, 4, 5 | 2, 3, 6 | 0, 5, 7 |
| 56 | | | | | 0, 1, 2, 3, 4 | 2, 4, 5 | 0, 6, 7 |
| 57 | | | | | 0, 1, 2, 3, 5 | 2, 4, 6 | 1, 2, 3 |
| 58 | | | | | 0, 1, 2, 4, 5 | 2, 5, 6 | 1, 2, 4 |
| 59 | | | | | 0, 1, 3, 4, 5 | 3, 4, 5 | 1, 2, 5 |
| 60 | | | | | 0, 2, 3, 4, 5 | 3, 4, 6 | 1, 2, 6 |
| 61 | | | | | 1, 2, 3, 4, 5 | 3, 5, 6 | 1, 2, 7 |
| 62 | | | | | 0, 1, 2, 3, 4, 5 | 4, 5, 6 | 1, 3, 4 |
| 63 | | | | | reserved | 0, 1, 2, 3 | 1, 3, 5 |
| 64 | | | | | | 0, 1, 2, 4 | 1, 3, 6 |
| 65 | | | | | | 0, 1, 2, 5 | 1, 3, 7 |
| 66 | | | | | | 0, 1, 2, 6 | 1, 4, 5 |
| 67 | | | | | | 0, 1, 3, 4 | 1, 4, 6 |
| 68 | | | | | | 0, 1, 3, 5 | 1, 4, 7 |
| 69 | | | | | | 0, 1, 3, 6 | 1, 5, 6 |
| 70 | | | | | | 0, 1, 4, 5 | 1, 5, 7 |
| 71 | | | | | | 0, 1, 4, 6 | 1, 6, 7 |
| 72 | | | | | | 0, 1, 5, 6 | 2, 3, 4 |
| 73 | | | | | | 0, 2, 3, 4 | 2, 3, 5 |
| 74 | | | | | | 0, 2, 3, 5 | 2, 3, 6 |
| 75 | | | | | | 0, 2, 3, 6 | 2, 3, 7 |
| 76 | | | | | | 0, 2, 4, 5 | 2, 4, 5 |
| 77 | | | | | | 0, 2, 4, 6 | 2, 4, 6 |
| 78 | | | | | | 0, 2, 5, 6 | 2, 4, 7 |
| 79 | | | | | | 0, 3, 4, 5 | 2, 5, 6 |
| 80 | | | | | | 0, 3, 4, 6 | 2, 5, 7 |
| 81 | | | | | | 0, 3, 5, 6 | 2, 6, 7 |
| 82 | | | | | | 0, 4, 5, 6 | 3, 4, 5 |
| 83 | | | | | | 1, 2, 3, 4 | 3, 4, 6 |
| 84 | | | | | | 1, 2, 3, 5 | 3, 4, 7 |
| 85 | | | | | | 1, 2, 3, 6 | 3, 5, 6 |
| 86 | | | | | | 1, 2, 4, 5 | 3, 5, 7 |
| 87 | | | | | | 1, 2, 4, 6 | 3, 6, 7 |
| 88 | | | | | | 1, 2, 5, 6 | 4, 5, 6 |
| 89 | | | | | | 1, 3, 4, 5 | 4, 5, 7 |
| 90 | | | | | | 1, 3, 4, 6 | 4, 6, 7 |
| 91 | | | | | | 1, 3, 5, 6 | 5, 6, 7 |
| 92 | | | | | | 1, 4, 5, 6 | 0, 1, 2, 3 |
| 93 | | | | | | 2, 3, 4, 5 | 0, 1, 2, 4 |
| 94 | | | | | | 2, 3, 4, 6 | 0, 1, 2, 5 |
| 95 | | | | | | 2, 3, 5, 6 | 0, 1, 2, 6 |
| 96 | | | | | | 2, 4, 5, 6 | 0, 1, 2, 7 |
| 97 | | | | | | 3, 4, 5, 6 | 0, 1, 3, 4 |
| 98 | | | | | | 0, 1, 2, 3, 4 | 0, 1, 3, 5 |
| 99 | | | | | | 0, 1, 2, 3, 5 | 0, 1, 3, 6 |
| 100 | | | | | | 0, 1, 2, 3, 6 | 0, 1, 3, 7 |
| 101 | | | | | | 0, 1, 2, 4, 5 | 0, 1, 4, 5 |
| 102 | | | | | | 0, 1, 2, 4, 6 | 0, 1, 4, 6 |
| 103 | | | | | | 0, 1, 2, 5, 6 | 0, 1, 4, 7 |
| 104 | | | | | | 0, 1, 3, 4, 5 | 0, 1, 5, 6 |
| 105 | | | | | | 0, 1, 3, 4, 6 | 0, 1, 5, 7 |
| 106 | | | | | | 0, 1, 3, 5, 6 | 0, 1, 6, 7 |
| 107 | | | | | | 0, 1, 4, 5, 6 | 0, 2, 3, 4 |
| 108 | | | | | | 0, 2, 3, 4, 5 | 0, 2, 3, 5 |
| 109 | | | | | | 0, 2, 3, 4, 6 | 0, 2, 3, 6 |
| 110 | | | | | | 0, 2, 3, 5, 6 | 0, 2, 3, 7 |
| 111 | | | | | | 0, 2, 4, 5, 6 | 0, 2, 4, 5 |
| 112 | | | | | | 0, 3, 4, 5, 6 | 0, 2, 4, 6 |
| 113 | | | | | | 1, 2, 3, 4, 5 | 0, 2, 4, 7 |
| 114 | | | | | | 1, 2, 3, 4, 6 | 0, 2, 5, 6 |
| 115 | | | | | | 1, 2, 3, 5, 6 | 0, 2, 5, 7 |
| 116 | | | | | | 1, 2, 4, 5, 6 | 0, 2, 6, 7 |
| 117 | | | | | | 1, 3, 4, 5, 6 | 0, 3, 4, 5 |
| 118 | | | | | | 2, 3, 4, 5, 6 | 0, 3, 4, 6 |
| 119 | | | | | | 0, 1, 2, 3, 4, 5 | 0, 3, 4, 7 |
| 120 | | | | | | 0, 1, 2, 3, 4, 6 | 0, 3, 5, 6 |
| 121 | | | | | | 0, 1, 2, 3, 5, 6 | 0, 3, 5, 7 |
| 122 | | | | | | 0, 1, 2, 4, 5, 6 | 0, 3, 6, 7 |
| 123 | | | | | | 0, 1, 3, 4, 5, 6 | 0, 4, 5, 6 |
| 124 | | | | | | 0, 2, 3, 4, 5, 6 | 0, 4, 5, 7 |
| 125 | | | | | | 1, 2, 3, 4, 5, 6 | 0, 4, 6, 7 |
| 126 | | | | | | reserved | 0, 5, 6, 7 |
| 127 | | | | | | | 1, 2, 3, 4 |
| 128 | | | | | | | 1, 2, 3, 5 |
| 129 | | | | | | | 1, 2, 3, 6 |
| 130 | | | | | | | 1, 2, 3, 7 |
| 131 | | | | | | | 1, 2, 4, 5 |
| 132 | | | | | | | 1, 2, 4, 6 |
| 133 | | | | | | | 1, 2, 4, 7 |
| 134 | | | | | | | 1, 2, 5, 6 |
| 135 | | | | | | | 1, 2, 5, 7 |
| 136 | | | | | | | 1, 2, 6, 7 |
| 137 | | | | | | | 1, 3, 4, 5 |
| 138 | | | | | | | 1, 3, 4, 6 |
| 139 | | | | | | | 1, 3, 4, 7 |
| 140 | | | | | | | 1, 3, 5, 6 |
| 141 | | | | | | | 1, 3, 5, 7 |
| 142 | | | | | | | 1, 3, 6, 7 |
| 143 | | | | | | | 1, 4, 5, 6 |
| 144 | | | | | | | 1, 4, 5, 7 |
| 145 | | | | | | | 1, 4, 6, 7 |
| 146 | | | | | | | 1, 5, 6, 7 |
| 147 | | | | | | | 2, 3, 4, 5 |
| 148 | | | | | | | 2, 3, 4, 6 |
| 149 | | | | | | | 2, 3, 4, 7 |
| 150 | | | | | | | 2, 3, 5, 6 |
| 151 | | | | | | | 2, 3, 5, 7 |
| 152 | | | | | | | 2, 3, 6, 7 |
| 153 | | | | | | | 2, 4, 5, 6 |
| 154 | | | | | | | 2, 4, 5, 7 |
| 155 | | | | | | | 2, 4, 6, 7 |
| 156 | | | | | | | 2, 5, 6, 7 |
| 157 | | | | | | | 3, 4, 5, 6 |
| 158 | | | | | | | 3, 4, 5, 7 |
| 159 | | | | | | | 3, 4, 6, 7 |
| 160 | | | | | | | 3, 5, 6, 7 |
| 161 | | | | | | | 4, 5, 6, 7 |
| 163 | | | | | | | 0, 1, 2, 3, 4 |
| 164 | | | | | | | 0, 1, 2, 3, 5 |
| 165 | | | | | | | 0, 1, 2, 3, 6 |
| 166 | | | | | | | 0, 1, 2, 3, 7 |
| 167 | | | | | | | 0, 1, 2, 4, 5 |
| 168 | | | | | | | 0, 1, 2, 4, 6 |
| 169 | | | | | | | 0, 1, 2, 4, 7 |
| 170 | | | | | | | 0, 1, 2, 5, 6 |
| 171 | | | | | | | 0, 1, 2, 5, 7 |
| 172 | | | | | | | 0, 1, 2, 6, 7 |
| 173 | | | | | | | 0, 1, 3, 4, 5 |
| 174 | | | | | | | 0, 1, 3, 4, 6 |
| 175 | | | | | | | 0, 1, 3, 4, 7 |
| 176 | | | | | | | 0, 1, 3, 5, 6 |
| 177 | | | | | | | 0, 1, 3, 5, 7 |
| 178 | | | | | | | 0, 1, 3, 6, 7 |
| 179 | | | | | | | 0, 1, 3, 4, 5 |
| 180 | | | | | | | 0, 1, 3, 4, 6 |
| 181 | | | | | | | 0, 1, 3, 4, 7 |
| 182 | | | | | | | 0, 1, 3, 5, 6 |
| 183 | | | | | | | 0, 1, 3, 5, 7 |
| 184 | | | | | | | 0, 1, 3, 6, 7 |
| 185 | | | | | | | 0, 1, 4, 5, 6 |
| 186 | | | | | | | 0, 1, 4, 5, 7 |
| 187 | | | | | | | 0, 1, 4, 6, 7 |
| 188 | | | | | | | 0, 1, 5, 6, 7 |
| 189 | | | | | | | 0, 2, 3, 4, 5 |
| 190 | | | | | | | 0, 2, 3, 4, 6 |
| 191 | | | | | | | 0, 2, 3, 4, 7 |
| 192 | | | | | | | 0, 2, 3, 5, 6 |
| 193 | | | | | | | 0, 2, 3, 5, 7 |
| 194 | | | | | | | 0, 2, 3, 6, 7 |
| 195 | | | | | | | 0, 3, 4, 5, 6 |
| 196 | | | | | | | 0, 3, 4, 5, 7 |
| 197 | | | | | | | 0, 3, 4, 6, 7 |
| 198 | | | | | | | 0, 4, 5, 6, 7 |
| 199 | | | | | | | 1, 2, 3, 4, 5 |
| 200 | | | | | | | 1, 2, 3, 4, 6 |
| 201 | | | | | | | 1, 2, 3, 4, 7 |
| 202 | | | | | | | 1, 2, 3, 5, 6 |
| 203 | | | | | | | 1, 2, 3, 5, 7 |
| 204 | | | | | | | 1, 2, 3, 6, 7 |
| 205 | | | | | | | 1, 2, 4, 5, 6 |
| 206 | | | | | | | 1, 2, 4, 5, 7 |
| 207 | | | | | | | 1, 2, 4, 6, 7 |
| 208 | | | | | | | 1, 3, 4, 5, 6 |
| 209 | | | | | | | 1, 3, 4, 5, 7 |
| 211 | | | | | | | 1, 3, 4, 6, 7 |
| 212 | | | | | | | 1, 3, 5, 6, 7 |
| 213 | | | | | | | 1, 4, 5, 6, 7 |
| 214 | | | | | | | 2, 3, 4, 5, 6 |
| 215 | | | | | | | 2, 3, 4, 5, 7 |
| 216 | | | | | | | 2, 3, 4, 6, 7 |
| 217 | | | | | | | 2, 3, 5, 6, 7 |
| 218 | | | | | | | 3, 4, 5, 6, 7 |
| 219 | | | | | | | 0, 1, 2, 3, 4, 5 |
| 220 | | | | | | | 0, 1, 2, 3, 4, 6 |
| 221 | | | | | | | 0, 1, 2, 3, 4, 7 |
| 222 | | | | | | | 0, 1, 2, 3, 5, 6 |
| 223 | | | | | | | 0, 1, 2, 3, 5, 7 |
| 224 | | | | | | | 0, 1, 2, 3, 6, 7 |
| 225 | | | | | | | 0, 1, 2, 4, 5, 6 |
| 226 | | | | | | | 0, 1, 2, 4, 5, 7 |
| 227 | | | | | | | 0, 1, 2, 4, 6, 7 |
| 228 | | | | | | | 0, 1, 2, 5, 6, 7 |
| 229 | | | | | | | 0, 1, 3, 4, 5, 6 |
| 230 | | | | | | | 0, 1, 3, 4, 5, 7 |
| 231 | | | | | | | 0, 1, 3, 4, 6, 7 |
| 232 | | | | | | | 0, 1, 3, 5, 6, 7 |
| 233 | | | | | | | 0, 1, 4, 5, 6, 7 |
| 234 | | | | | | | 0, 2, 3, 4, 5, 6 |
| 235 | | | | | | | 0, 2, 3, 4, 5, 7 |
| 236 | | | | | | | 0, 2, 3, 4, 6, 7 |
| 237 | | | | | | | 0, 2, 3, 5, 6, 7 |
| 238 | | | | | | | 0, 2, 4, 5, 6, 7 |
| 239 | | | | | | | 0, 3, 4, 5, 6, 7 |
| 240 | | | | | | | 1, 2, 3, 4, 5, 6 |
| 241 | | | | | | | 1, 2, 3, 4, 5, 7 |
| 242 | | | | | | | 1, 2, 3, 4, 6, 7 |
| 243 | | | | | | | 1, 2, 3, 5, 6, 7 |
| 244 | | | | | | | 1, 2, 4, 5, 6, 7 |
| 245 | | | | | | | 1, 3, 4, 5, 6, 7 |
| 246 | | | | | | | 2, 3, 4, 5, 6, 7 |
| 247~255 | | | | | | | Reserved |

TABLE X7
SRI indication for non-codebook based PUSCH transmission, Lmax = 7

| Bit field | | | | | | | |
|---|---|---|---|---|---|---|---|
| mapped | SRI(s) | SRI(s) | SRI(s) | SRI(s) | SRI(s) | SRI(s) | SRI(s) |
| to index | N_{SRS} = 2 | N_{SRS} = 3 | N_{SRS} = 4 | N_{SRS} = 5 | N_{SRS} = 6 | N_{SRS} = 7 | N_{SRS} = 8 |
| 0 | 0 | 0 | 0 | 0 | 0 | 0 | 0 |
| 1 | 1 | 1 | 1 | 1 | 1 | 1 | 1 |
| 2 | 0, 1 | 2 | 2 | 2 | 2 | 2 | 2 |
| 3 | reserved | 0, 1 | 3 | 3 | 3 | 3 | 3 |
| 4 | | 0, 2 | 0, 1 | 4 | 4 | 4 | 4 |
| 5 | | 1, 2 | 0, 2 | 0, 1 | 5 | 5 | 5 |
| 6 | | 0, 1, 2 | 0, 3 | 0, 2 | 0, 1 | 6 | 6 |
| 7 | | reserved | 1, 2 | 0, 3 | 0, 2 | 0, 1 | 7 |
| 8 | | | 1, 3 | 0, 4 | 0, 3 | 0, 2 | 0, 1 |
| 9 | | | 2, 3 | 1, 2 | 0, 4 | 0, 3 | 0, 2 |
| 10 | | | 0, 1, 2 | 1, 3 | 0, 5 | 0, 4 | 0, 3 |
| 11 | | | 0, 1, 3 | 1, 4 | 1, 2 | 0, 5 | 0, 4 |
| 12 | | | 0, 2, 3 | 2, 3 | 1, 3 | 0, 6 | 0, 5 |
| 13 | | | 1, 2, 3 | 2, 4 | 1, 4 | 1, 2 | 0, 6 |
| 14 | | | 0, 1, 2, 3 | 3, 4 | 1, 5 | 1, 3 | 0, 7 |
| 15 | | | reserved | 0, 1, 2 | 2, 3 | 1, 4 | 1, 2 |
| 16 | | | | 0, 1, 3 | 2, 4 | 1, 5 | 1, 3 |
| 17 | | | | 0, 1, 4 | 2, 5 | 1, 6 | 1, 4 |
| 18 | | | | 0, 2, 3 | 3, 4 | 2, 3 | 1, 5 |
| 19 | | | | 0, 2, 4 | 3, 5 | 2, 4 | 1, 6 |
| 20 | | | | 0, 3, 4 | 4, 5 | 2, 5 | 1, 7 |
| 21 | | | | 1, 2, 3 | 0, 1, 2 | 2, 6 | 2, 3 |
| 22 | | | | 1, 2, 4 | 0, 1, 3 | 3, 4 | 2, 4 |
| 23 | | | | 1, 3, 4 | 0, 1, 4 | 3, 5 | 2, 5 |
| 24 | | | | 2, 3, 4 | 0, 1, 5 | 3, 6 | 2, 6 |
| 25 | | | | 0, 1, 2, 3 | 0, 2, 3 | 4, 5 | 2, 7 |
| 26 | | | | 0, 1, 2, 4 | 0, 2, 4 | 4, 6 | 3, 4 |
| 27 | | | | 0, 1, 3, 4 | 0, 2, 5 | 5, 6 | 3, 5 |
| 28 | | | | 0, 2, 3, 4 | 0, 3, 4 | 0, 1, 2 | 3, 6 |
| 29 | | | | 1, 2, 3, 4 | 0, 3, 5 | 0, 1, 3 | 3, 7 |
| 30 | | | | 0, 1, 2, 3, 4 | 0, 4, 5 | 0, 1, 4 | 4, 5 |
| 31 | | | | reserved | 1, 2, 3 | 0, 1, 5 | 4, 6 |
| 32 | | | | | 1, 2, 4 | 0, 1, 6 | 4, 7 |
| 33 | | | | | 1, 2, 5 | 0, 2, 3 | 5, 6 |
| 34 | | | | | 1, 3, 4 | 0, 2, 4 | 5, 7 |
| 35 | | | | | 1, 3, 5 | 0, 2, 5 | 6, 7 |
| 36 | | | | | 1, 4, 5 | 0, 2, 6 | 0, 1, 2 |
| 37 | | | | | 2, 3, 4 | 0, 3, 4 | 0, 1, 3 |
| 38 | | | | | 2, 3, 5 | 0, 3, 5 | 0, 1, 4 |
| 39 | | | | | 2, 4, 5 | 0, 3, 6 | 0, 1, 5 |
| 40 | | | | | 3, 4, 5 | 0, 4, 5 | 0, 1, 6 |
| 41 | | | | | 0, 1, 2, 3 | 0, 4, 6 | 0, 1, 7 |
| 42 | | | | | 0, 1, 2, 4 | 0, 5, 6 | 0, 2, 3 |
| 43 | | | | | 0, 1, 2, 5 | 1, 2, 3 | 0, 2, 4 |
| 44 | | | | | 0, 1, 3, 4 | 1, 2, 4 | 0, 2, 5 |
| 45 | | | | | 0, 1, 3, 5 | 1, 2, 5 | 0, 2, 6 |
| 46 | | | | | 0, 1, 4, 5 | 1, 2, 6 | 0, 2, 7 |
| 47 | | | | | 0, 2, 3, 4 | 1, 3, 4 | 0, 3, 4 |
| 48 | | | | | 0, 2, 3, 5 | 1, 3, 5 | 0, 3, 5 |
| 49 | | | | | 0, 2, 4, 5 | 1, 3, 6 | 0, 3, 6 |
| 50 | | | | | 0, 3, 4, 5 | 1, 4, 5 | 0, 3, 7 |
| 51 | | | | | 1, 2, 3, 4 | 1, 4, 6 | 0, 4, 5 |
| 52 | | | | | 1, 2, 3, 5 | 1, 5, 6 | 0, 4, 6 |
| 53 | | | | | 1, 2, 4, 5 | 2, 3, 4 | 0, 4, 7 |
| 54 | | | | | 1, 3, 4, 5 | 2, 3, 5 | 0, 5, 6 |
| 55 | | | | | 2, 3, 4, 5 | 2, 3, 6 | 0, 5, 7 |
| 56 | | | | | 0, 1, 2, 3, 4 | 2, 4, 5 | 0, 6, 7 |
| 57 | | | | | 0, 1, 2, 3, 5 | 2, 4, 6 | 1, 2, 3 |
| 58 | | | | | 0, 1, 2, 4, 5 | 2, 5, 6 | 1, 2, 4 |
| 59 | | | | | 0, 1, 3, 4, 5 | 3, 4, 5 | 1, 2, 5 |
| 60 | | | | | 0, 2, 3, 4, 5 | 3, 4, 6 | 1, 2, 6 |
| 61 | | | | | 1, 2, 3, 4, 5 | 3, 5, 6 | 1, 2, 7 |
| 62 | | | | | 0, 1, 2, 3, 4, 5 | 4, 5, 6 | 1, 3, 4 |
| 63 | | | | | reserved | 0, 1, 2, 3 | 1, 3, 5 |
| 64 | | | | | | 0, 1, 2, 4 | 1, 3, 6 |
| 65 | | | | | | 0, 1, 2, 5 | 1, 3, 7 |
| 66 | | | | | | 0, 1, 2, 6 | 1, 4, 5 |
| 67 | | | | | | 0, 1, 3, 4 | 1, 4, 6 |
| 68 | | | | | | 0, 1, 3, 5 | 1, 4, 7 |
| 69 | | | | | | 0, 1, 3, 6 | 1, 5, 6 |
| 70 | | | | | | 0, 1, 4, 5 | 1, 5, 7 |
| 71 | | | | | | 0, 1, 4, 6 | 1, 6, 7 |
| 72 | | | | | | 0, 1, 5, 6 | 2, 3, 4 |
| 73 | | | | | | 0, 2, 3, 4 | 2, 3, 5 |
| 74 | | | | | | 0, 2, 3, 5 | 2, 3, 6 |
| 75 | | | | | | 0, 2, 3, 6 | 2, 3, 7 |
| 76 | | | | | | 0, 2, 4, 5 | 2, 4, 5 |
| 77 | | | | | | 0, 2, 4, 6 | 2, 4, 6 |
| 78 | | | | | | 0, 2, 5, 6 | 2, 4, 7 |
| 79 | | | | | | 0, 3, 4, 5 | 2, 5, 6 |
| 80 | | | | | | 0, 3, 4, 6 | 2, 5, 7 |
| 81 | | | | | | 0, 3, 5, 6 | 2, 6, 7 |
| 82 | | | | | | 0, 4, 5, 6 | 3, 4, 5 |
| 83 | | | | | | 1, 2, 3, 4 | 3, 4, 6 |
| 84 | | | | | | 1, 2, 3, 5 | 3, 4, 7 |
| 85 | | | | | | 1, 2, 3, 6 | 3, 5, 6 |
| 86 | | | | | | 1, 2, 4, 5 | 3, 5, 7 |
| 87 | | | | | | 1, 2, 4, 6 | 3, 6, 7 |
| 88 | | | | | | 1, 2, 5, 6 | 4, 5, 6 |
| 89 | | | | | | 1, 3, 4, 5 | 4, 5, 7 |
| 90 | | | | | | 1, 3, 4, 6 | 4, 6, 7 |
| 91 | | | | | | 1, 3, 5, 6 | 5, 6, 7 |
| 92 | | | | | | 1, 4, 5, 6 | 0, 1, 2, 3 |
| 93 | | | | | | 2, 3, 4, 5 | 0, 1, 2, 4 |
| 94 | | | | | | 2, 3, 4, 6 | 0, 1, 2, 5 |
| 95 | | | | | | 2, 3, 5, 6 | 0, 1, 2, 6 |
| 96 | | | | | | 2, 4, 5, 6 | 0, 1, 2, 7 |
| 97 | | | | | | 3, 4, 5, 6 | 0, 1, 3, 4 |
| 98 | | | | | | 0, 1, 2, 3, 4 | 0, 1, 3, 5 |
| 99 | | | | | | 0, 1, 2, 3, 5 | 0, 1, 3, 6 |
| 100 | | | | | | 0, 1, 2, 3, 6 | 0, 1, 3, 7 |
| 101 | | | | | | 0, 1, 2, 4, 5 | 0, 1, 4, 5 |
| 102 | | | | | | 0, 1, 2, 4, 6 | 0, 1, 4, 6 |
| 103 | | | | | | 0, 1, 2, 5, 6 | 0, 1, 4, 7 |
| 104 | | | | | | 0, 1, 3, 4, 5 | 0, 1, 5, 6 |
| 105 | | | | | | 0, 1, 3, 4, 6 | 0, 1, 5, 7 |
| 106 | | | | | | 0, 1, 3, 5, 6 | 0, 1, 6, 7 |
| 107 | | | | | | 0, 1, 4, 5, 6 | 0, 2, 3, 4 |
| 108 | | | | | | 0, 2, 3, 4, 5 | 0, 2, 3, 5 |
| 109 | | | | | | 0, 2, 3, 4, 6 | 0, 2, 3, 6 |
| 110 | | | | | | 0, 2, 3, 5, 6 | 0, 2, 3, 7 |
| 111 | | | | | | 0, 2, 4, 5, 6 | 0, 2, 4, 5 |
| 112 | | | | | | 0, 3, 4, 5, 6 | 0, 2, 4, 6 |
| 113 | | | | | | 1, 2, 3, 4, 5 | 0, 2, 4, 7 |
| 114 | | | | | | 1, 2, 3, 4, 6 | 0, 2, 5, 6 |
| 115 | | | | | | 1, 2, 3, 5, 6 | 0, 2, 5, 7 |
| 116 | | | | | | 1, 2, 4, 5, 6 | 0, 2, 6, 7 |
| 117 | | | | | | 1, 3, 4, 5, 6 | 0, 3, 4, 5 |
| 118 | | | | | | 2, 3, 4, 5, 6 | 0, 3, 4, 6 |
| 119 | | | | | | 0, 1, 2, 3, 4, 5 | 0, 3, 4, 7 |
| 120 | | | | | | 0, 1, 2, 3, 4, 6 | 0, 3, 5, 6 |
| 121 | | | | | | 0, 1, 2, 3, 5, 6 | 0, 3, 5, 7 |
| 122 | | | | | | 0, 1, 2, 4, 5, 6 | 0, 3, 6, 7 |
| 123 | | | | | | 0, 1, 3, 4, 5, 6 | 0, 4, 5, 6 |
| 124 | | | | | | 0, 2, 3, 4, 5, 6 | 0, 4, 5, 7 |
| 125 | | | | | | 1, 2, 3, 4, 5, 6 | 0, 4, 6, 7 |
| 126 | | | | | | 0, 1, 2, 3, 4, 5, 6 | 0, 5, 6, 7 |
| 127 | | | | | | reserved | 1, 2, 3, 4 |
| 128 | | | | | | | 1, 2, 3, 5 |
| 129 | | | | | | | 1, 2, 3, 6 |
| 130 | | | | | | | 1, 2, 3, 7 |
| 131 | | | | | | | 1, 2, 4, 5 |
| 132 | | | | | | | 1, 2, 4, 6 |
| 133 | | | | | | | 1, 2, 4, 7 |
| 134 | | | | | | | 1, 2, 5, 6 |
| 135 | | | | | | | 1, 2, 5, 7 |
| 136 | | | | | | | 1, 2, 6, 7 |
| 137 | | | | | | | 1, 3, 4, 5 |
| 138 | | | | | | | 1, 3, 4, 6 |
| 139 | | | | | | | 1, 3, 4, 7 |
| 140 | | | | | | | 1, 3, 5, 6 |
| 141 | | | | | | | 1, 3, 5, 7 |
| 142 | | | | | | | 1, 3, 6, 7 |
| 143 | | | | | | | 1, 4, 5, 6 |
| 144 | | | | | | | 1, 4, 5, 7 |
| 145 | | | | | | | 1, 4, 6, 7 |
| 146 | | | | | | | 1, 5, 6, 7 |
| 147 | | | | | | | 2, 3, 4, 5 |
| 148 | | | | | | | 2, 3, 4, 6 |
| 149 | | | | | | | 2, 3, 4, 7 |
| 150 | | | | | | | 2, 3, 5, 6 |
| 151 | | | | | | | 2, 3, 5, 7 |
| 152 | | | | | | | 2, 3, 6, 7 |
| 153 | | | | | | | 2, 4, 5, 6 |
| 154 | | | | | | | 2, 4, 5, 7 |
| 155 | | | | | | | 2, 4, 6, 7 |
| 156 | | | | | | | 2, 5, 6, 7 |
| 157 | | | | | | | 3, 4, 5, 6 |
| 158 | | | | | | | 3, 4, 5, 7 |
| 159 | | | | | | | 3, 4, 6, 7 |
| 160 | | | | | | | 3, 5, 6, 7 |
| 161 | | | | | | | 4, 5, 6, 7 |
| 163 | | | | | | | 0, 1, 2, 3, 4 |
| 164 | | | | | | | 0, 1, 2, 3, 5 |
| 165 | | | | | | | 0, 1, 2, 3, 6 |
| 166 | | | | | | | 0, 1, 2, 3, 7 |
| 167 | | | | | | | 0, 1, 2, 4, 5 |
| 168 | | | | | | | 0, 1, 2, 4, 6 |
| 169 | | | | | | | 0, 1, 2, 4, 7 |
| 170 | | | | | | | 0, 1, 2, 5, 6 |
| 171 | | | | | | | 0, 1, 2, 5, 7 |
| 172 | | | | | | | 0, 1, 2, 6, 7 |
| 173 | | | | | | | 0, 1, 3, 4, 5 |
| 174 | | | | | | | 0, 1, 3, 4, 6 |
| 175 | | | | | | | 0, 1, 3, 4, 7 |
| 176 | | | | | | | 0, 1, 3, 5, 6 |
| 177 | | | | | | | 0, 1, 3, 5, 7 |
| 178 | | | | | | | 0, 1, 3, 6, 7 |
| 179 | | | | | | | 0, 1, 3, 4, 5 |
| 180 | | | | | | | 0, 1, 3, 4, 6 |
| 181 | | | | | | | 0, 1, 3, 4, 7 |
| 182 | | | | | | | 0, 1, 3, 5, 6 |
| 183 | | | | | | | 0, 1, 3, 5, 7 |
| 184 | | | | | | | 0, 1, 3, 6, 7 |
| 185 | | | | | | | 0, 1, 4, 5, 6 |
| 186 | | | | | | | 0, 1, 4, 5, 7 |
| 187 | | | | | | | 0, 1, 4, 6, 7 |
| 188 | | | | | | | 0, 1, 5, 6, 7 |
| 189 | | | | | | | 0, 2, 3, 4, 5 |
| 190 | | | | | | | 0, 2, 3, 4, 6 |
| 191 | | | | | | | 0, 2, 3, 4, 7 |
| 192 | | | | | | | 0, 2, 3, 5, 6 |
| 193 | | | | | | | 0, 2, 3, 5, 7 |
| 194 | | | | | | | 0, 2, 3, 6, 7 |
| 195 | | | | | | | 0, 3, 4, 5, 6 |
| 196 | | | | | | | 0, 3, 4, 5, 7 |
| 197 | | | | | | | 0, 3, 4, 6, 7 |
| 198 | | | | | | | 0, 4, 5, 6, 7 |
| 199 | | | | | | | 1, 2, 3, 4, 5 |
| 200 | | | | | | | 1, 2, 3, 4, 6 |
| 201 | | | | | | | 1, 2, 3, 4, 7 |
| 202 | | | | | | | 1, 2, 3, 5, 6 |
| 203 | | | | | | | 1, 2, 3, 5, 7 |
| 204 | | | | | | | 1, 2, 3, 6, 7 |
| 205 | | | | | | | 1, 2, 4, 5, 6 |
| 206 | | | | | | | 1, 2, 4, 5, 7 |
| 207 | | | | | | | 1, 2, 4, 6, 7 |
| 208 | | | | | | | 1, 3, 4, 5, 6 |
| 209 | | | | | | | 1, 3, 4, 5, 7 |
| 211 | | | | | | | 1, 3, 4, 6, 7 |
| 212 | | | | | | | 1, 3, 5, 6, 7 |
| 213 | | | | | | | 1, 4, 5, 6, 7 |
| 214 | | | | | | | 2, 3, 4, 5, 6 |
| 215 | | | | | | | 2, 3, 4, 5, 7 |
| 216 | | | | | | | 2, 3, 4, 6, 7 |
| 217 | | | | | | | 2, 3, 5, 6, 7 |
| 218 | | | | | | | 3, 4, 5, 6, 7 |
| 219 | | | | | | | 0, 1, 2, 3, 4, 5 |
| 220 | | | | | | | 0, 1, 2, 3, 4, 6 |
| 221 | | | | | | | 0, 1, 2, 3, 4, 7 |
| 222 | | | | | | | 0, 1, 2, 3, 5, 6 |
| 223 | | | | | | | 0, 1, 2, 3, 5, 7 |
| 224 | | | | | | | 0, 1, 2, 3, 6, 7 |
| 225 | | | | | | | 0, 1, 2, 4, 5, 6 |
| 226 | | | | | | | 0, 1, 2, 4, 5, 7 |
| 227 | | | | | | | 0, 1, 2, 4, 6, 7 |
| 228 | | | | | | | 0, 1, 2, 5, 6, 7 |
| 229 | | | | | | | 0, 1, 3, 4, 5, 6 |
| 230 | | | | | | | 0, 1, 3, 4, 5, 7 |
| 231 | | | | | | | 0, 1, 3, 4, 6, 7 |
| 232 | | | | | | | 0, 1, 3, 5, 6, 7 |
| 233 | | | | | | | 0, 1, 4, 5, 6, 7 |
| 234 | | | | | | | 0, 2, 3, 4, 5, 6 |
| 235 | | | | | | | 0, 2, 3, 4, 5, 7 |
| 236 | | | | | | | 0, 2, 3, 4, 6, 7 |
| 237 | | | | | | | 0, 2, 3, 5, 6, 7 |
| 238 | | | | | | | 0, 2, 4, 5, 6, 7 |
| 239 | | | | | | | 0, 3, 4, 5, 6, 7 |
| 240 | | | | | | | 1, 2, 3, 4, 5, 6 |
| 241 | | | | | | | 1, 2, 3, 4, 5, 7 |
| 242 | | | | | | | 1, 2, 3, 4, 6, 7 |
| 243 | | | | | | | 1, 2, 3, 5, 6, 7 |
| 244 | | | | | | | 1, 2, 4, 5, 6, 7 |
| 245 | | | | | | | 1, 3, 4, 5, 6, 7 |
| 246 | | | | | | | 2, 3, 4, 5, 6, 7 |
| 247 | | | | | | | 0, 1, 2, 3, 4, 5, 6 |
| 248 | | | | | | | 0, 1, 2, 3, 4, 5, 7 |
| 249 | | | | | | | 0, 1, 2, 3, 5, 6, 7 |
| 250 | | | | | | | 0, 1, 2, 4, 5, 6, 7 |
| 251 | | | | | | | 0, 1, 3, 4, 5, 6, 7 |
| 252 | | | | | | | 0, 2, 3, 4, 5, 6, 7 |
| 253 | | | | | | | 1, 2, 3, 4, 5, 6, 7 |
| 254~255 | | | | | | | Reserved |

TABLE X8
SRI indication for non-codebook based PUSCH transmission, Lmax = 8

| Bit field | | | | | | | |
|---|---|---|---|---|---|---|---|
| mapped | SRI(s) | SRI(s) | SRI(s) | SRI(s) | SRI(s) | SRI(s) | SRI(s) |
| to index | N_{SRS} = 2 | N_{SRS} = 3 | N_{SRS} = 4 | N_{SRS} = 5 | N_{SRS} = 6 | N_{SRS} = 7 | N_{SRS} = 8 |
| 0 | 0 | 0 | 0 | 0 | 0 | 0 | 0 |
| 1 | 1 | 1 | 1 | 1 | 1 | 1 | 1 |
| 2 | 0, 1 | 2 | 2 | 2 | 2 | 2 | 2 |
| 3 | reserved | 0, 1 | 3 | 3 | 3 | 3 | 3 |
| 4 | | 0, 2 | 0, 1 | 4 | 4 | 4 | 4 |
| 5 | | 1, 2 | 0, 2 | 0, 1 | 5 | 5 | 5 |
| 6 | | 0, 1, 2 | 0, 3 | 0, 2 | 0, 1 | 6 | 6 |
| 7 | | reserved | 1, 2 | 0, 3 | 0, 2 | 0, 1 | 7 |
| 8 | | | 1, 3 | 0, 4 | 0, 3 | 0, 2 | 0, 1 |
| 9 | | | 2, 3 | 1, 2 | 0, 4 | 0, 3 | 0, 2 |
| 10 | | | 0, 1, 2 | 1, 3 | 0, 5 | 0, 4 | 0, 3 |
| 11 | | | 0, 1, 3 | 1, 4 | 1, 2 | 0, 5 | 0, 4 |
| 12 | | | 0, 2, 3 | 2, 3 | 1, 3 | 0, 6 | 0, 5 |
| 13 | | | 1, 2, 3 | 2, 4 | 1, 4 | 1, 2 | 0, 6 |
| 14 | | | 0, 1, 2, 3 | 3, 4 | 1, 5 | 1, 3 | 0, 7 |
| 15 | | | reserved | 0, 1, 2 | 2, 3 | 1, 4 | 1, 2 |
| 16 | | | | 0, 1, 3 | 2, 4 | 1, 5 | 1, 3 |
| 17 | | | | 0, 1, 4 | 2, 5 | 1, 6 | 1, 4 |
| 18 | | | | 0, 2, 3 | 3, 4 | 2, 3 | 1, 5 |
| 19 | | | | 0, 2, 4 | 3, 5 | 2, 4 | 1, 6 |
| 20 | | | | 0, 3, 4 | 4, 5 | 2, 5 | 1, 7 |
| 21 | | | | 1, 2, 3 | 0, 1, 2 | 2, 6 | 2, 3 |
| 22 | | | | 1, 2, 4 | 0, 1, 3 | 3, 4 | 2, 4 |
| 23 | | | | 1, 3, 4 | 0, 1, 4 | 3, 5 | 2, 5 |
| 24 | | | | 2, 3, 4 | 0, 1, 5 | 3, 6 | 2, 6 |
| 25 | | | | 0, 1, 2, 3 | 0, 2, 3 | 4, 5 | 2, 7 |
| 26 | | | | 0, 1, 2, 4 | 0, 2, 4 | 4, 6 | 3, 4 |
| 27 | | | | 0, 1, 3, 4 | 0, 2, 5 | 5, 6 | 3, 5 |
| 28 | | | | 0, 2, 3, 4 | 0, 3, 4 | 0, 1, 2 | 3, 6 |
| 29 | | | | 1, 2, 3, 4 | 0, 3, 5 | 0, 1, 3 | 3, 7 |
| 30 | | | | 0, 1, 2, 3, 4 | 0, 4, 5 | 0, 1, 4 | 4, 5 |
| 31 | | | | reserved | 1, 2, 3 | 0, 1, 5 | 4, 6 |
| 32 | | | | | 1, 2, 4 | 0, 1, 6 | 4, 7 |
| 33 | | | | | 1, 2, 5 | 0, 2, 3 | 5, 6 |
| 34 | | | | | 1, 3, 4 | 0, 2, 4 | 5, 7 |
| 35 | | | | | 1, 3, 5 | 0, 2, 5 | 6, 7 |
| 36 | | | | | 1, 4, 5 | 0, 2, 6 | 0, 1, 2 |
| 37 | | | | | 2, 3, 4 | 0, 3, 4 | 0, 1, 3 |
| 38 | | | | | 2, 3, 5 | 0, 3, 5 | 0, 1, 4 |
| 39 | | | | | 2, 4, 5 | 0, 3, 6 | 0, 1, 5 |
| 40 | | | | | 3, 4, 5 | 0, 4, 5 | 0, 1, 6 |
| 41 | | | | | 0, 1, 2, 3 | 0, 4, 6 | 0, 1, 7 |
| 42 | | | | | 0, 1, 2, 4 | 0, 5, 6 | 0, 2, 3 |
| 43 | | | | | 0, 1, 2, 5 | 1, 2, 3 | 0, 2, 4 |
| 44 | | | | | 0, 1, 3, 4 | 1, 2, 4 | 0, 2, 5 |
| 45 | | | | | 0, 1, 3, 5 | 1, 2, 5 | 0, 2, 6 |
| 46 | | | | | 0, 1, 4, 5 | 1, 2, 6 | 0, 2, 7 |
| 47 | | | | | 0, 2, 3, 4 | 1, 3, 4 | 0, 3, 4 |
| 48 | | | | | 0, 2, 3, 5 | 1, 3, 5 | 0, 3, 5 |
| 49 | | | | | 0, 2, 4, 5 | 1, 3, 6 | 0, 3, 6 |
| 50 | | | | | 0, 3, 4, 5 | 1, 4, 5 | 0, 3, 7 |
| 51 | | | | | 1, 2, 3, 4 | 1, 4, 6 | 0, 4, 5 |
| 52 | | | | | 1, 2, 3, 5 | 1, 5, 6 | 0, 4, 6 |
| 53 | | | | | 1, 2, 4, 5 | 2, 3, 4 | 0, 4, 7 |
| 54 | | | | | 1, 3, 4, 5 | 2, 3, 5 | 0, 5, 6 |
| 55 | | | | | 2, 3, 4, 5 | 2, 3, 6 | 0, 5, 7 |
| 56 | | | | | 0, 1, 2, 3, 4 | 2, 4, 5 | 0, 6, 7 |
| 57 | | | | | 0, 1, 2, 3, 5 | 2, 4, 6 | 1, 2, 3 |
| 58 | | | | | 0, 1, 2, 4, 5 | 2, 5, 6 | 1, 2, 4 |
| 59 | | | | | 0, 1, 3, 4, 5 | 3, 4, 5 | 1, 2, 5 |
| 60 | | | | | 0, 2, 3, 4, 5 | 3, 4, 6 | 1, 2, 6 |
| 61 | | | | | 1, 2, 3, 4, 5 | 3, 5, 6 | 1, 2, 7 |
| 62 | | | | | 0, 1, 2, 3, 4, 5 | 4, 5, 6 | 1, 3, 4 |
| 63 | | | | | reserved | 0, 1, 2, 3 | 1, 3, 5 |
| 64 | | | | | | 0, 1, 2, 4 | 1, 3, 6 |
| 65 | | | | | | 0, 1, 2, 5 | 1, 3, 7 |
| 66 | | | | | | 0, 1, 2, 6 | 1, 4, 5 |
| 67 | | | | | | 0, 1, 3, 4 | 1, 4, 6 |
| 68 | | | | | | 0, 1, 3, 5 | 1, 4, 7 |
| 69 | | | | | | 0, 1, 3, 6 | 1, 5, 6 |
| 70 | | | | | | 0, 1, 4, 5 | 1, 5, 7 |
| 71 | | | | | | 0, 1, 4, 6 | 1, 6, 7 |
| 72 | | | | | | 0, 1, 5, 6 | 2, 3, 4 |
| 73 | | | | | | 0, 2, 3, 4 | 2, 3, 5 |
| 74 | | | | | | 0, 2, 3, 5 | 2, 3, 6 |
| 75 | | | | | | 0, 2, 3, 6 | 2, 3, 7 |
| 76 | | | | | | 0, 2, 4, 5 | 2, 4, 5 |
| 77 | | | | | | 0, 2, 4, 6 | 2, 4, 6 |
| 78 | | | | | | 0, 2, 5, 6 | 2, 4, 7 |
| 79 | | | | | | 0, 3, 4, 5 | 2, 5, 6 |
| 80 | | | | | | 0, 3, 4, 6 | 2, 5, 7 |
| 81 | | | | | | 0, 3, 5, 6 | 2, 6, 7 |
| 82 | | | | | | 0, 4, 5, 6 | 3, 4, 5 |
| 83 | | | | | | 1, 2, 3, 4 | 3, 4, 6 |
| 84 | | | | | | 1, 2, 3, 5 | 3, 4, 7 |
| 85 | | | | | | 1, 2, 3, 6 | 3, 5, 6 |
| 86 | | | | | | 1, 2, 4, 5 | 3, 5, 7 |
| 87 | | | | | | 1, 2, 4, 6 | 3, 6, 7 |
| 88 | | | | | | 1, 2, 5, 6 | 4, 5, 6 |
| 89 | | | | | | 1, 3, 4, 5 | 4, 5, 7 |
| 90 | | | | | | 1, 3, 4, 6 | 4, 6, 7 |
| 91 | | | | | | 1, 3, 5, 6 | 5, 6, 7 |
| 92 | | | | | | 1, 4, 5, 6 | 0, 1, 2, 3 |
| 93 | | | | | | 2, 3, 4, 5 | 0, 1, 2, 4 |
| 94 | | | | | | 2, 3, 4, 6 | 0, 1, 2, 5 |
| 95 | | | | | | 2, 3, 5, 6 | 0, 1, 2, 6 |
| 96 | | | | | | 2, 4, 5, 6 | 0, 1, 2, 7 |
| 97 | | | | | | 3, 4, 5, 6 | 0, 1, 3, 4 |
| 98 | | | | | | 0, 1, 2, 3, 4 | 0, 1, 3, 5 |
| 99 | | | | | | 0, 1, 2, 3, 5 | 0, 1, 3, 6 |
| 100 | | | | | | 0, 1, 2, 3, 6 | 0, 1, 3, 7 |
| 101 | | | | | | 0, 1, 2, 4, 5 | 0, 1, 4, 5 |
| 102 | | | | | | 0, 1, 2, 4, 6 | 0, 1, 4, 6 |
| 103 | | | | | | 0, 1, 2, 5, 6 | 0, 1, 4, 7 |
| 104 | | | | | | 0, 1, 3, 4, 5 | 0, 1, 5, 6 |
| 105 | | | | | | 0, 1, 3, 4, 6 | 0, 1, 5, 7 |
| 106 | | | | | | 0, 1, 3, 5, 6 | 0, 1, 6, 7 |
| 107 | | | | | | 0, 1, 4, 5, 6 | 0, 2, 3, 4 |
| 108 | | | | | | 0, 2, 3, 4, 5 | 0, 2, 3, 5 |
| 109 | | | | | | 0, 2, 3, 4, 6 | 0, 2, 3, 6 |
| 110 | | | | | | 0, 2, 3, 5, 6 | 0, 2, 3, 7 |
| 111 | | | | | | 0, 2, 4, 5, 6 | 0, 2, 4, 5 |
| 112 | | | | | | 0, 3, 4, 5, 6 | 0, 2, 4, 6 |
| 113 | | | | | | 1, 2, 3, 4, 5 | 0, 2, 4, 7 |
| 114 | | | | | | 1, 2, 3, 4, 6 | 0, 2, 5, 6 |
| 115 | | | | | | 1, 2, 3, 5, 6 | 0, 2, 5, 7 |
| 116 | | | | | | 1, 2, 4, 5, 6 | 0, 2, 6, 7 |
| 117 | | | | | | 1, 3, 4, 5, 6 | 0, 3, 4, 5 |
| 118 | | | | | | 2, 3, 4, 5, 6 | 0, 3, 4, 6 |
| 119 | | | | | | 0, 1, 2, 3, 4, 5 | 0, 3, 4, 7 |
| 120 | | | | | | 0, 1, 2, 3, 4, 6 | 0, 3, 5, 6 |
| 121 | | | | | | 0, 1, 2, 3, 5, 6 | 0, 3, 5, 7 |
| 122 | | | | | | 0, 1, 2, 4, 5, 6 | 0, 3, 6, 7 |
| 123 | | | | | | 0, 1, 3, 4, 5, 6 | 0, 4, 5, 6 |
| 124 | | | | | | 0, 2, 3, 4, 5, 6 | 0, 4, 5, 7 |
| 125 | | | | | | 1, 2, 3, 4, 5, 6 | 0, 4, 6, 7 |
| 126 | | | | | | 0, 1, 2, 3, 4, 5, 6 | 0, 5, 6, 7 |
| 127 | | | | | | reserved | 1, 2, 3, 4 |
| 128 | | | | | | | 1, 2, 3, 5 |
| 129 | | | | | | | 1, 2, 3, 6 |
| 130 | | | | | | | 1, 2, 3, 7 |
| 131 | | | | | | | 1, 2, 4, 5 |
| 132 | | | | | | | 1, 2, 4, 6 |
| 133 | | | | | | | 1, 2, 4, 7 |
| 134 | | | | | | | 1, 2, 5, 6 |
| 135 | | | | | | | 1, 2, 5, 7 |
| 136 | | | | | | | 1, 2, 6, 7 |
| 137 | | | | | | | 1, 3, 4, 5 |
| 138 | | | | | | | 1, 3, 4, 6 |
| 139 | | | | | | | 1, 3, 4, 7 |
| 140 | | | | | | | 1, 3, 5, 6 |
| 141 | | | | | | | 1, 3, 5, 7 |
| 142 | | | | | | | 1, 3, 6, 7 |
| 143 | | | | | | | 1, 4, 5, 6 |
| 144 | | | | | | | 1, 4, 5, 7 |
| 145 | | | | | | | 1, 4, 6, 7 |
| 146 | | | | | | | 1, 5, 6, 7 |
| 147 | | | | | | | 2, 3, 4, 5 |
| 148 | | | | | | | 2, 3, 4, 6 |
| 149 | | | | | | | 2, 3, 4, 7 |
| 150 | | | | | | | 2, 3, 5, 6 |
| 151 | | | | | | | 2, 3, 5, 7 |
| 152 | | | | | | | 2, 3, 6, 7 |
| 153 | | | | | | | 2, 4, 5, 6 |
| 154 | | | | | | | 2, 4, 5, 7 |
| 155 | | | | | | | 2, 4, 6, 7 |
| 156 | | | | | | | 2, 5, 6, 7 |
| 157 | | | | | | | 3, 4, 5, 6 |
| 158 | | | | | | | 3, 4, 5, 7 |
| 159 | | | | | | | 3, 4, 6, 7 |
| 160 | | | | | | | 3, 5, 6, 7 |
| 161 | | | | | | | 4, 5, 6, 7 |
| 163 | | | | | | | 0, 1, 2, 3, 4 |
| 164 | | | | | | | 0, 1, 2, 3, 5 |
| 165 | | | | | | | 0, 1, 2, 3, 6 |
| 166 | | | | | | | 0, 1, 2, 3, 7 |
| 167 | | | | | | | 0, 1, 2, 4, 5 |
| 168 | | | | | | | 0, 1, 2, 4, 6 |
| 169 | | | | | | | 0, 1, 2, 4, 7 |
| 170 | | | | | | | 0, 1, 2, 5, 6 |
| 171 | | | | | | | 0, 1, 2, 5, 7 |
| 172 | | | | | | | 0, 1, 2, 6, 7 |
| 173 | | | | | | | 0, 1, 3, 4, 5 |
| 174 | | | | | | | 0, 1, 3, 4, 6 |
| 175 | | | | | | | 0, 1, 3, 4, 7 |
| 176 | | | | | | | 0, 1, 3, 5, 6 |
| 177 | | | | | | | 0, 1, 3, 5, 7 |
| 178 | | | | | | | 0, 1, 3, 6, 7 |
| 179 | | | | | | | 0, 1, 3, 4, 5 |
| 180 | | | | | | | 0, 1, 3, 4, 6 |
| 181 | | | | | | | 0, 1, 3, 4, 7 |
| 182 | | | | | | | 0, 1, 3, 5, 6 |
| 183 | | | | | | | 0, 1, 3, 5, 7 |
| 184 | | | | | | | 0, 1, 3, 6, 7 |
| 185 | | | | | | | 0, 1, 4, 5, 6 |
| 186 | | | | | | | 0, 1, 4, 5, 7 |
| 187 | | | | | | | 0, 1, 4, 6, 7 |
| 188 | | | | | | | 0, 1, 5, 6, 7 |
| 189 | | | | | | | 0, 2, 3, 4, 5 |
| 190 | | | | | | | 0, 2, 3, 4, 6 |
| 191 | | | | | | | 0, 2, 3, 4, 7 |
| 192 | | | | | | | 0, 2, 3, 5, 6 |
| 193 | | | | | | | 0, 2, 3, 5, 7 |
| 194 | | | | | | | 0, 2, 3, 6, 7 |
| 195 | | | | | | | 0, 3, 4, 5, 6 |
| 196 | | | | | | | 0, 3, 4, 5, 7 |
| 197 | | | | | | | 0, 3, 4, 6, 7 |
| 198 | | | | | | | 0, 4, 5, 6, 7 |
| 199 | | | | | | | 1, 2, 3, 4, 5 |
| 200 | | | | | | | 1, 2, 3, 4, 6 |
| 201 | | | | | | | 1, 2, 3, 4, 7 |
| 202 | | | | | | | 1, 2, 3, 5, 6 |
| 203 | | | | | | | 1, 2, 3, 5, 7 |
| 204 | | | | | | | 1, 2, 3, 6, 7 |
| 205 | | | | | | | 1, 2, 4, 5, 6 |
| 206 | | | | | | | 1, 2, 4, 5, 7 |
| 207 | | | | | | | 1, 2, 4, 6, 7 |
| 208 | | | | | | | 1, 3, 4, 5, 6 |
| 209 | | | | | | | 1, 3, 4, 5, 7 |
| 211 | | | | | | | 1, 3, 4, 6, 7 |
| 212 | | | | | | | 1, 3, 5, 6, 7 |
| 213 | | | | | | | 1, 4, 5, 6, 7 |
| 214 | | | | | | | 2, 3, 4, 5, 6 |
| 215 | | | | | | | 2, 3, 4, 5, 7 |
| 216 | | | | | | | 2, 3, 4, 6, 7 |
| 217 | | | | | | | 2, 3, 5, 6, 7 |
| 218 | | | | | | | 3, 4, 5, 6, 7 |
| 219 | | | | | | | 0, 1, 2, 3, 4, 5 |
| 220 | | | | | | | 0, 1, 2, 3, 4, 6 |
| 221 | | | | | | | 0, 1, 2, 3, 4, 7 |
| 222 | | | | | | | 0, 1, 2, 3, 5, 6 |
| 223 | | | | | | | 0, 1, 2, 3, 5, 7 |
| 224 | | | | | | | 0, 1, 2, 3, 6, 7 |
| 225 | | | | | | | 0, 1, 2, 4, 5, 6 |
| 226 | | | | | | | 0, 1, 2, 4, 5, 7 |
| 227 | | | | | | | 0, 1, 2, 4, 6, 7 |
| 228 | | | | | | | 0, 1, 2, 5, 6, 7 |
| 229 | | | | | | | 0, 1, 3, 4, 5, 6 |
| 230 | | | | | | | 0, 1, 3, 4, 5, 7 |
| 231 | | | | | | | 0, 1, 3, 4, 6, 7 |
| 232 | | | | | | | 0, 1, 3, 5, 6, 7 |
| 233 | | | | | | | 0, 1, 4, 5, 6, 7 |
| 234 | | | | | | | 0, 2, 3, 4, 5, 6 |
| 235 | | | | | | | 0, 2, 3, 4, 5, 7 |
| 236 | | | | | | | 0, 2, 3, 4, 6, 7 |
| 237 | | | | | | | 0, 2, 3, 5, 6, 7 |
| 238 | | | | | | | 0, 2, 4, 5, 6, 7 |
| 239 | | | | | | | 0, 3, 4, 5, 6, 7 |
| 240 | | | | | | | 1, 2, 3, 4, 5, 6 |
| 241 | | | | | | | 1, 2, 3, 4, 5, 7 |
| 242 | | | | | | | 1, 2, 3, 4, 6, 7 |
| 243 | | | | | | | 1, 2, 3, 5, 6, 7 |
| 244 | | | | | | | 1, 2, 4, 5, 6, 7 |
| 245 | | | | | | | 1, 3, 4, 5, 6, 7 |
| 246 | | | | | | | 2, 3, 4, 5, 6, 7 |
| 247 | | | | | | | 0, 1, 2, 3, 4, 5, 6 |
| 248 | | | | | | | 0, 1, 2, 3, 4, 5, 7 |
| 249 | | | | | | | 0, 1, 2, 3, 5, 6, 7 |
| 250 | | | | | | | 0, 1, 2, 4, 5, 6, 7 |
| 251 | | | | | | | 0, 1, 3, 4, 5, 6, 7 |
| 252 | | | | | | | 0, 2, 3, 4, 5, 6, 7 |
| 253 | | | | | | | 1, 2, 3, 4, 5, 6, 7 |
| 254 | | | | | | | 0, 1, 2, 3, 4, 5, 6, 7 |
| 255 | | | | | | | Reserved |

In another embodiment, for non-codebook based transmission, the value of parameter maxMIMO-Layers (Lₘₐₓ) should be extended up to 8.

In order to save overhead and for power saving, more than 4 and up to 8 SRS resources are configured in the SRS resource set for non-codebook only when Lₘₐₓ is larger than certain threshold, e.g., 4. For example, if Lₘₐₓ is smaller than or equal to 4, then only up to 4 SRS resources can be configured, which means in Table 1 to Table 4, column 5 to column 8 are not used.

In another embodiment, for non-codebook based transmission, in order to support up to 8 layers transmission, multiple codewords, e.g., 2, could be used and two SRS resource sets could be configured. In each SRS resource set, up to 4 SRS resource could be configured. For each codeword, up to 4 layers are supported. The number of SRS resources within the two SRS resource sets should be the same. In another example, the number of SRS resources within the two SRS resource sets could be different.

In DCI, two SRI fields should be included. For each SRI field, the mapping between bit field index and SRIs for given Lₘₐₓ (maximum number of layers as indicated by maxMIMO-Layers) and number of SRS resources within one SRS resource set (N_{SRS}) could use the legacy mapping as shown in FIG. 3 to FIG. 6. In one example, the Lₘₐₓ value is applied for both SRI fields. In another example, two Lₘₐₓ values could be configured, one for each SRI field. The two Lₘₐₓ values could be the same or different.

The mapping between SRI field in DCI and the codeword could be implicit or explicit. With implicit mapping, the order of the SRI field can indicate which codeword it is applied to. For example, the 1^{st} SRI field is applied to the 1^{st} codeword and the 2^{nd} SRI field is applied to the 2^{nd} codeword. With explicit mapping, the mapping between SRI field and codeword could be indicated by DCI or configured by RRC. For example, a new field could be added to DCI or the existing field could be reused/repurposed.

Whether one codeword is used for transmission could implicitly indicated by the SRI field. If one codeword is not used for transmission, in the corresponding SRI field, one specific value (for example, one reserved value) of the SRI field could be used to indicate that the corresponding codeword is not used for transmission. For example, for N_{SRS}=4, Lₘₐₓ=4, value of ‘15’ (which is reserved) could be used to indicate the corresponding codeword is not used for transmission. In such case, for Lₘₐₓ=1, N_{SRS}=2, the SRI field should be extended to 2 bits.

In another example, whether the codeword is used for transmission or not could be explicitly indicated by DCI. For example, a new field could be added to DCI or the existing field could be reused/repurpose. In one example, the new field could be a bitmap of two bits.

In another embodiment, for non-codebook based transmission, in order to support up to 8 layers transmission, two SRS resource sets could be configured if only one codeword is used (or two SRS resource sets could be configured irrespective the number of codewords). In each SRS resource set, up to 4 SRS resource could be configured. The number of SRS resources within the two SRS resource sets should be the same. In another example, the number of SRS resources within the two SRS resource sets could be different.

A new RRC parameter could be introduced to indicating the maximum number of total layers, for example, L_{Total,Max}, and L_{Total,Max}<=8. The legacy parameter Lₘₐₓ is to indicate the maximum number of layers corresponding to one SRS resource set, Lₘₐₓ<=4 and Lₘₐₓ<=L_{Total,Max}. In another example, the new RRC parameter L_{Total,Max} is not needed and only the legacy parameter Lₘₐₓ is used.

In DCI, two SRI fields should be included. For each SRI field, the mapping between bit field index and SRIs for given Lₘₐₓ (maximum number of layers as indicated by maxMIMO-Layers) and number of SRS resources within one SRS resource set (N_{SRS}) could use the legacy mapping as shown in FIG. 3 to FIG. 6. In one example, the Lₘₐₓ value is applied for both SRI fields. In another example, two Lₘₐₓ values could be configured, one for each SRI field. The two Lₘₐₓ values could be the same or different.

The rank indicated by the two SRI fields should be the same. In another example, the rank indicated by the two SRI fields could be different. The mapping between SRI field in DCI and the SRS resource set could be implicit or explicit.

With implicit mapping, the order of the SRI field can indicate which SRS resource set it is applied to. For example, the 1^{st} SRI field is applied to the 1^{st} SRS resource set and the 2^{nd} SRI field is applied to the 2^{nd} SRS resource set. With explicit mapping, the mapping between SRI field and the SRS resource set could be indicated by DCI or configured by RRC. For example, a new field could be added to DCI or the existing field could be reused/repurposed.

Whether the SRI field is used to indicate SRIs for transmission could implicitly indicated. With implicit indication, if one SRI field is not used for transmission, one specific value (for example, one reserved value) of the SRI field could be used to indicate that the corresponding SRI field is not used for transmission. For example, for N_{SRS}=4, Lₘₐₓ=4, value of ‘15’ (which is reserved) could be used to indicate the corresponding SRI field is not used for transmission. In such case, for Lₘₐₓ=1, N_{SRS}=2, the SRI field should be extended to 2 bits.

In another example, whether the SRI field is used for transmission or not could be explicitly indicated by DCI. For example, a new field could be added to DCI or the existing field could be reused/repurposed. In one example, the new field could be a bitmap of two bits.

In another example, for non-codebook based PUSCH transmission with up to N (N<=8) layers, port group could be defined with the number of port group is M. For example, the 8 antenna ports are split into two port groups. the 1^{st} port group consists of port #0 to port #3, and the 2^{nd} port group consists of port #4 to port #7.

The SRS resource set and the SRI field in the DCI could be mapped to the port group. For example, the 1^{st} SRI field is for the 1^{st} port group, the 2^{nd} SRI field is for the 2^{nd} port group.

Note: The embodiments in this disclosure could be applied to simultaneous multi-panel uplink transmission. When multiple SRS resource sets are configured, each SRS resource set could correspond to/be associated with one UE antenna panel. Consequently, one SRI field corresponds to/is associated with one UE antenna panel.

In another embodiment, for non-codebook based transmission, in order to support up to 8 layers transmission, one SRS resource set could be configured when one codeword is used. In the SRS resource set, up to 8 SRS resources could be configured. In the DCI, multiple SRI fields, e.g., two SRI fields, could be included.

In some embodiments, a new RRC parameter could be introduced to indicating the maximum number of total layers, for example, L_{Total,Max}, and L_{Total,Max}<=8 (or the value of the legacy RRC parameter maxMIMO-Layers (Lₘₐₓ) is extended to 8). The legacy parameter Lₘax is to indicate the maximum number of layers corresponding to one SRI field, Lₘₐₓ<=4 and Lₘₐₓ<=L_{Total,Max} (or new RRC parameters is introduced to indicate the maximum number of layers corresponding to one SRI field). In another example, the new RRC parameter L_{Total,Max} is not needed and only the legacy parameter Lₘₐₓ is used.

In an example, two Lₘₐₓ values are used, one for each SRI field. In another example, only one Lₘₐₓ value is used and is applied for both SRI field.

In an example, for non-codebook based PUSCH transmission with up to N (N<=8) layers, a port group could be defined with the number of port group is M. For example, the 8 antenna ports are split into two port groups. the 1^{st} port group consists of port #0 to port #3, and the 2^{nd} port group consists of port #4 to port #7.

In the DCI, the SRI field could be mapped to the port group. For example, the 1^{st} SRI field is for the 1^{st} port group, the 2^{nd} SRI field is for the 2^{nd} port group.

Assuming the total number of SRS resources within the SRS resource set for non-codebook based transmission is N_{SRS,total}, for each SRI field, when determining the mapping between the bit field index and SRIs, the value N_{SRS} is given by N_{SRS,1} and N_{SRS,2}, respectively (N_{SRS,1}+N_{SRS,2}=N_{SRS,total}). N_{SRS,1} and N_{SRS,2} could be configured or predefined. The mapping as shown in FIG. 3 through FIG. 6 could be used.

For example, Table X9 shows the predefined value of N_{SRS,1} and N_{SRS,2}. In this example, the second SRI field is not used if the number of SRS resources in the SRS resource set (N_{SRS,total}) is less than or equal to 4.

TABLE X9
Value of NSRS, 1 and NSRS, 2 for the SRI fields

| N_{SRS, total} | N_{SRS, 1} | N_{SRS,2} |
|---|---|---|
| 1 | 1 | 0 |
| 2 | 2 | 0 |
| 3 | 3 | 0 |
| 4 | 4 | 0 |
| 5 | 4 | 1 |
| 6 | 4 | 2 |
| 7 | 4 | 3 |
| 8 | 4 | 4 |

Whether the SRI field is used to indicate SRIs for transmission could be implicitly indicated. With implicit indication, if one SRI field is not used for transmission, one specific value (for example, one reserved value) of the SRI field could be used to indicate that the corresponding SRI field is not used for transmission.

In another example, whether the SRI field is used for transmission or not could be explicitly indicated by DCI. For example, a new field could be added to DCI or the existing field could be reused/repurposed. In one example, the new field could be a bitmap of two bits.

Note: this embodiment can also be used for the case of multiple codewords/multiple panels are used, e.g., two codewords. In this case, one SRS resource set is configured with up to 8 SRS resources, and two SRI fields are included in the DCI. The 1^{st} SRI field is used for the 1st codeword/panel and the 2nd SRI field is used for the 2nd codeword/panel.

In another embodiment, for non-codebook based transmission with up to 8 layers transmission, multiple SRS resource sets could be configured, e.g., N SRS resource sets where 1<=N<=8. In one example, N∈{1,2,4,8}. In the DCI, N SRI fields could be configured, one SRI field for each SRS resource set respectively.

In another example, for non-codebook based transmission with up to 8 layers transmission, one SRS resource sets could be configured. In the DCI, M SRI fields could be configured, e.g., M SRI fields, where 1<=M<=8. In one example, M∈{1,2,4,8}.

### Systems and Implementations

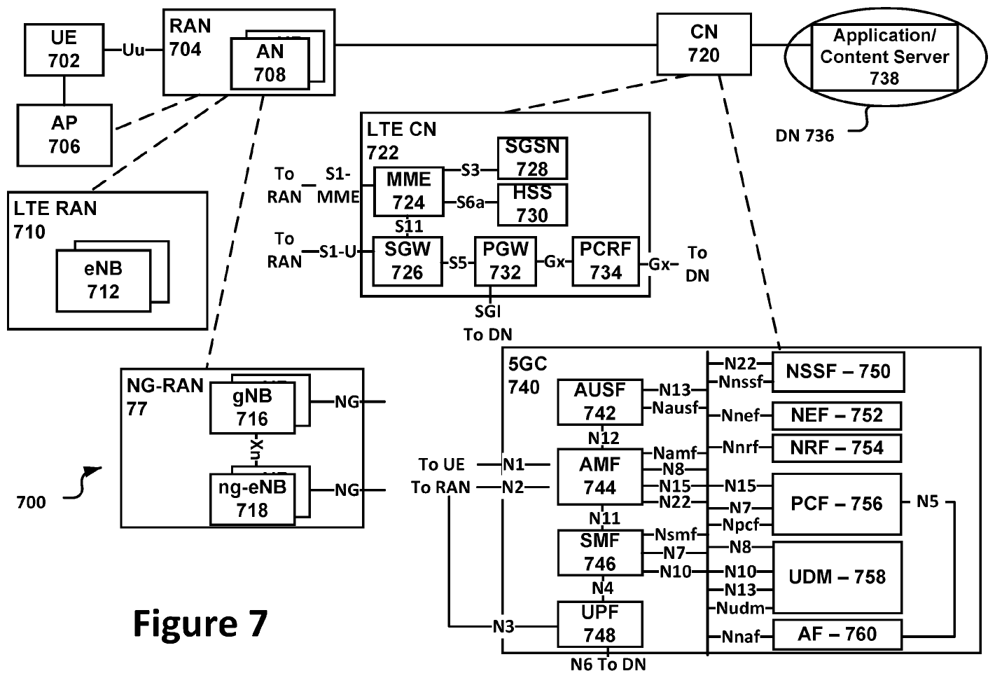

FIGS. 7-9 illustrate various systems, devices, and components that may implement aspects of disclosed embodiments.

FIG. 7 illustrates a network 700 in accordance with various embodiments. The network 700 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 700 may include a UE 702, which may include any mobile or non-mobile computing device designed to communicate with a RAN 704 via an over-the-air connection. The UE 702 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 700 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 702 may additionally communicate with an AP 706 via an over-the-air connection. The AP 706 may manage a WLAN connection, which may serve to offload some/all network traffic from the RAN 704. The connection between the UE 702 and the AP 706 may be consistent with any IEEE 802.11 protocol, wherein the AP 706 could be a wireless fidelity (Wi-Fi®) router. In some embodiments, the UE 702, RAN 704, and AP 706 may utilize cellular-WLAN aggregation (for example, LWA/LWIP). Cellular-WLAN aggregation may involve the UE 702 being configured by the RAN 704 to utilize both cellular radio resources and WLAN resources.

The RAN 704 may include one or more access nodes, for example, AN 708. AN 708 may terminate air-interface protocols for the UE 702 by providing access stratum protocols including RRC, PDCP, RLC, MAC, and L1 protocols. In this manner, the AN 708 may enable data/voice connectivity between CN 720 and the UE 702. In some embodiments, the AN 708 may be implemented in a discrete device or as one or more software entities running on server computers as part of, for example, a virtual network, which may be referred to as a CRAN or virtual baseband unit pool. The AN 708 be referred to as a BS, gNB, RAN node, eNB, ng-eNB, NodeB, RSU, TRxP, TRP, etc. The AN 708 may be a macrocell base station or a low power base station for providing femtocells, picocells or other like cells having smaller coverage areas, smaller user capacity, or higher bandwidth compared to macrocells.

In embodiments in which the RAN 704 includes a plurality of ANs, they may be coupled with one another via an X2 interface (if the RAN 704 is an LTE RAN) or an Xn interface (if the RAN 704 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 704 may each manage one or more cells, cell groups, component carriers, etc. to provide the UE 702 with an air interface for network access. The UE 702 may be simultaneously connected with a plurality of cells provided by the same or different ANs of the RAN 704. For example, the UE 702 and RAN 704 may use carrier aggregation to allow the UE 702 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 704 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 702 or AN 708 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 704 may be an LTE RAN 710 with eNBs, for example, eNB 712. The LTE RAN 710 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 704 may be an NG-RAN 714 with gNBs, for example, gNB 716, or ng-eNBs, for example, ng-eNB 718. The gNB 716 may connect with 5G-enabled UEs using a 5G NR interface. The gNB 716 may connect with a 5G core through an NG interface, which may include an N2 interface or an N3 interface. The ng-eNB 718 may also connect with the 5G core through an NG interface, but may connect with a UE via an LTE air interface. The gNB 716 and the ng-eNB 718 may connect with each other over an Xn interface.

In some embodiments, the NG interface may be split into two parts, an NG user plane (NG-U) interface, which carries traffic data between the nodes of the NG-RAN 714 and a UPF 748 (e.g., N3 interface), and an NG control plane (NG-C) interface, which is a signaling interface between the nodes of the NG-RAN 714 and an AMF 744 (e.g., N2 interface).

The NG-RAN 714 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 702 can be configured with multiple BWPs where each BWP configuration has a different SCS. When a BWP change is indicated to the UE 702, the SCS of the transmission is changed as well. Another use case example of BWP is related to power saving. In particular, multiple BWPs can be configured for the UE 702 with different amount of frequency resources (for example, PRBs) to support data transmission under different traffic loading scenarios. A BWP containing a smaller number of PRBs can be used for data transmission with small traffic load while allowing power saving at the UE 702 and in some cases at the gNB 716. A BWP containing a larger number of PRBs can be used for scenarios with higher traffic load.

The RAN 704 is communicatively coupled to CN 720 that includes network elements to provide various functions to support data and telecommunications services to customers/subscribers (for example, users of UE 702). The components of the CN 720 may be implemented in one physical node or separate physical nodes. In some embodiments, NFV may be utilized to virtualize any or all of the functions provided by the network elements of the CN 720 onto physical compute/storage resources in servers, switches, etc. A logical instantiation of the CN 720 may be referred to as a network slice, and a logical instantiation of a portion of the CN 720 may be referred to as a network sub-slice.

In some embodiments, the CN 720 may be an LTE CN 722, which may also be referred to as an EPC. The LTE CN 722 may include MME 724, SGW 726, SGSN 728, HSS 730, PGW 732, and PCRF 734 coupled with one another over interfaces (or “reference points”) as shown. Functions of the elements of the LTE CN 722 may be briefly introduced as follows.

The MME 724 may implement mobility management functions to track a current location of the UE 702 to facilitate paging, bearer activation/deactivation, handovers, gateway selection, authentication, etc.

The SGW 726 may terminate an Si interface toward the RAN and route data packets between the RAN and the LTE CN 722. The SGW 726 may be a local mobility anchor point for inter-RAN node handovers and also may provide an anchor for inter-3GPP mobility. Other responsibilities may include lawful intercept, charging, and some policy enforcement.

The SGSN 728 may track a location of the UE 702 and perform security functions and access control. In addition, the SGSN 728 may perform inter-EPC node signaling for mobility between different RAT networks; PDN and S-GW selection as specified by MME 724; MME selection for handovers; etc. The S3 reference point between the MME 724 and the SGSN 728 may enable user and bearer information exchange for inter-3GPP access network mobility in idle/active states.

The HSS 730 may include a database for network users, including subscription-related information to support the network entities' handling of communication sessions. The HSS 730 can provide support for routing/roaming, authentication, authorization, naming/addressing resolution, location dependencies, etc. An S6a reference point between the HSS 730 and the MME 724 may enable transfer of subscription and authentication data for authenticating/authorizing user access to the LTE CN 720.

The PGW 732 may terminate an SGi interface toward a data network (DN) 736 that may include an application/content server 738. The PGW 732 may route data packets between the LTE CN 722 and the data network 736. The PGW 732 may be coupled with the SGW 726 by an S5 reference point to facilitate user plane tunneling and tunnel management. The PGW 732 may further include a node for policy enforcement and charging data collection (for example, PCEF). Additionally, the SGi reference point between the PGW 732 and the data network 736 may be an operator external public, a private PDN, or an intra-operator packet data network, for example, for provision of IMS services. The PGW 732 may be coupled with a PCRF 734 via a Gx reference point.

The PCRF 734 is the policy and charging control element of the LTE CN 722. The PCRF 734 may be communicatively coupled to the app/content server 738 to determine appropriate QoS and charging parameters for service flows. The PCRF 732 may provision associated rules into a PCEF (via Gx reference point) with appropriate TFT and QCI.

In some embodiments, the CN 720 may be a 5GC 740. The 5GC 740 may include an AUSF 742, AMF 744, SMF 746, UPF 748, NSSF 750, NEF 752, NRF 754, PCF 756, UDM 758, and AF 760 coupled with one another over interfaces (or “reference points”) as shown. Functions of the elements of the 5GC 740 may be briefly introduced as follows.

The AUSF 742 may store data for authentication of UE 702 and handle authentication-related functionality. The AUSF 742 may facilitate a common authentication framework for various access types. In addition to communicating with other elements of the 5GC 740 over reference points as shown, the AUSF 742 may exhibit an Nausf service-based interface.

The AMF 744 may allow other functions of the 5GC 740 to communicate with the UE 702 and the RAN 704 and to subscribe to notifications about mobility events with respect to the UE 702. The AMF 744 may be responsible for registration management (for example, for registering UE 702), connection management, reachability management, mobility management, lawful interception of AMF-related events, and access authentication and authorization. The AMF 744 may provide transport for SM messages between the UE 702 and the SMF 746, and act as a transparent proxy for routing SM messages. AMF 744 may also provide transport for SMS messages between UE 702 and an SMSF. AMF 744 may interact with the AUSF 742 and the UE 702 to perform various security anchor and context management functions. Furthermore, AMF 744 may be a termination point of a RAN CP interface, which may include or be an N2 reference point between the RAN 704 and the AMF 744; and the AMF 744 may be a termination point of NAS (N1) signaling, and perform NAS ciphering and integrity protection. AMF 744 may also support NAS signaling with the UE 702 over an N3 IWF interface.

The SMF 746 may be responsible for SM (for example, session establishment, tunnel management between UPF 748 and AN 708); UE IP address allocation and management (including optional authorization); selection and control of UP function; configuring traffic steering at UPF 748 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 744 over N2 to AN 708; and determining SSC mode of a session. SM may refer to management of a PDU session, and a PDU session or “session” may refer to a PDU connectivity service that provides or enables the exchange of PDUs between the UE 702 and the data network 736.

The UPF 748 may act as an anchor point for intra-RAT and inter-RAT mobility, an external PDU session point of interconnect to data network 736, and a branching point to support multi-homed PDU session. The UPF 748 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 748 may include an uplink classifier to support routing traffic flows to a data network.

The NSSF 750 may select a set of network slice instances serving the UE 702. The NSSF 750 may also determine allowed NSSAI and the mapping to the subscribed S-NSSAIs, if needed. The NSSF 750 may also determine the AMF set to be used to serve the UE 702, or a list of candidate AMFs based on a suitable configuration and possibly by querying the NRF 754. The selection of a set of network slice instances for the UE 702 may be triggered by the AMF 744 with which the UE 702 is registered by interacting with the NSSF 750, which may lead to a change of AMF. The NSSF 750 may interact with the AMF 744 via an N22 reference point; and may communicate with another NSSF in a visited network via an N31 reference point (not shown). Additionally, the NSSF 750 may exhibit an Nnssf service-based interface.

The NEF 752 may securely expose services and capabilities provided by 3GPP network functions for third party, internal exposure/re-exposure, AFs (e.g., AF 760), edge computing or fog computing systems, etc. In such embodiments, the NEF 752 may authenticate, authorize, or throttle the AFs. NEF 752 may also translate information exchanged with the AF 760 and information exchanged with internal network functions. For example, the NEF 752 may translate between an AF-Service-Identifier and an internal 5GC information. NEF 752 may also receive information from other NFs based on exposed capabilities of other NFs. This information may be stored at the NEF 752 as structured data, or at a data storage NF using standardized interfaces. The stored information can then be re-exposed by the NEF 752 to other NFs and AFs, or used for other purposes such as analytics. Additionally, the NEF 752 may exhibit an Nnef service-based interface.

The NRF 754 may support service discovery functions, receive NF discovery requests from NF instances, and provide the information of the discovered NF instances to the NF instances. NRF 754 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 754 may exhibit the Nnrf service-based interface.

The PCF 756 may provide policy rules to control plane functions to enforce them, and may also support unified policy framework to govern network behavior. The PCF 756 may also implement a front end to access subscription information relevant for policy decisions in a UDR of the UDM 758. In addition to communicating with functions over reference points as shown, the PCF 756 exhibit an Npcf service-based interface.

The UDM 758 may handle subscription-related information to support the network entities' handling of communication sessions, and may store subscription data of UE 702. For example, subscription data may be communicated via an N8 reference point between the UDM 758 and the AMF 744. The UDM 758 may include two parts, an application front end and a UDR. The UDR may store subscription data and policy data for the UDM 758 and the PCF 756, and/or structured data for exposure and application data (including PFDs for application detection, application request information for multiple UEs 702) for the NEF 752. The Nudr service-based interface may be exhibited by the UDR 221 to allow the UDM 758, PCF 756, and NEF 752 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 758 may exhibit the Nudm service-based interface.

The AF 760 may provide application influence on traffic routing, provide access to NEF, and interact with the policy framework for policy control.

In some embodiments, the 5GC 740 may enable edge computing by selecting operator/3^{rd} party services to be geographically close to a point that the ULE 702 is attached to the network. This may reduce latency and load on the network. To provide edge-computing implementations, the 5GC 740 may select a UPF 748 close to the UE 702 and execute traffic steering from the UPF 748 to data network 736 via the N6 interface. This may be based on the UE subscription data, UE location, and information provided by the AF 760. In this way, the AF 760 may influence UPF (re)selection and traffic routing. Based on operator deployment, when AF 760 is considered to be a trusted entity, the network operator may permit AF 760 to interact directly with relevant NFs. Additionally, the AF 760 may exhibit an Naf service-based interface.

The data network 736 may represent various network operator services, Internet access, or third party services that may be provided by one or more servers including, for example, application/content server 738.

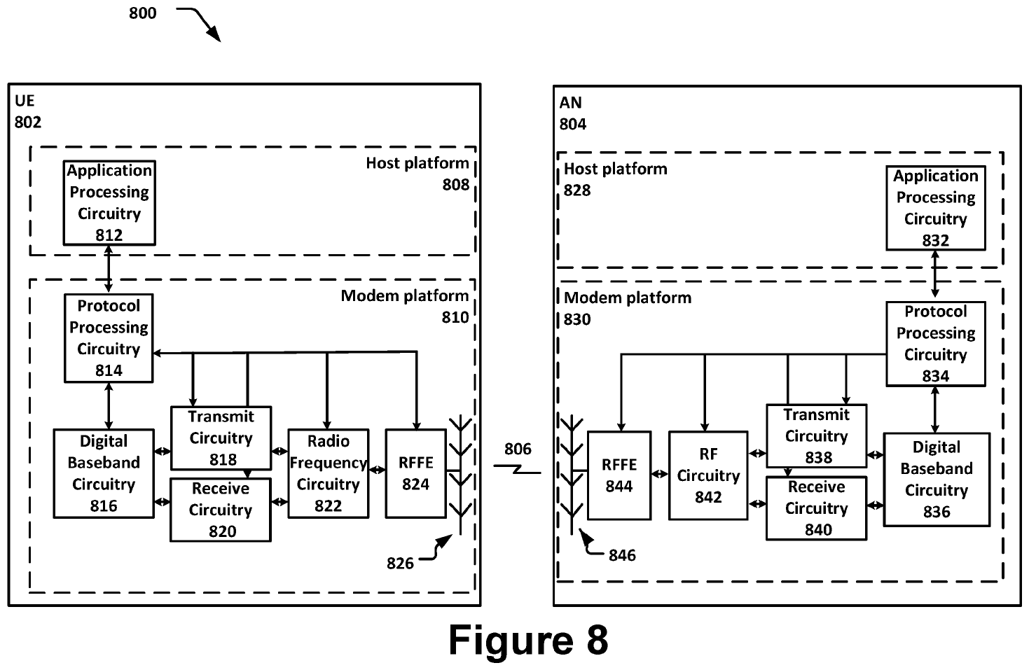

FIG. 8 schematically illustrates a wireless network 800 in accordance with various embodiments. The wireless network 800 may include a UE 802 in wireless communication with an AN 804. The UE 802 and AN 804 may be similar to, and substantially interchangeable with, like-named components described elsewhere herein.

The UE 802 may be communicatively coupled with the AN 804 via connection 806. The connection 806 is illustrated as an air interface to enable communicative coupling, and can be consistent with cellular communications protocols such as an LTE protocol or a 5G NR protocol operating at mmWave or sub-6 GHz frequencies.

The UE 802 may include a host platform 808 coupled with a modem platform 810. The host platform 808 may include application processing circuitry 812, which may be coupled with protocol processing circuitry 814 of the modem platform 810. The application processing circuitry 812 may run various applications for the UE 802 that source/sink application data. The application processing circuitry 812 may further implement one or more layer operations to transmit/receive application data to/from a data network. These layer operations may include transport (for example UDP) and Internet (for example, IP) operations

The protocol processing circuitry 814 may implement one or more of layer operations to facilitate transmission or reception of data over the connection 806. The layer operations implemented by the protocol processing circuitry 814 may include, for example, MAC, RLC, PDCP, RRC and NAS operations.

The modem platform 810 may further include digital baseband circuitry 816 that may implement one or more layer operations that are “below” layer operations performed by the protocol processing circuitry 814 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 810 may further include transmit circuitry 818, receive circuitry 820, RF circuitry 822, and RF front end (RFFE) 824, which may include or connect to one or more antenna panels 826. Briefly, the transmit circuitry 818 may include a digital-to-analog converter, mixer, intermediate frequency (IF) components, etc.; the receive circuitry 820 may include an analog-to-digital converter, mixer, IF components, etc.; the RF circuitry 822 may include a low-noise amplifier, a power amplifier, power tracking components, etc.; RFFE 824 may include filters (for example, surface/bulk acoustic wave filters), switches, antenna tuners, beamforming components (for example, phase-array antenna components), etc. The selection and arrangement of the components of the transmit circuitry 818, receive circuitry 820, RF circuitry 822, RFFE 824, and antenna panels 826 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 814 may include one or more instances of control circuitry (not shown) to provide control functions for the transmit/receive components.

A UE reception may be established by and via the antenna panels 826, RFFE 824, RF circuitry 822, receive circuitry 820, digital baseband circuitry 816, and protocol processing circuitry 814. In some embodiments, the antenna panels 826 may receive a transmission from the AN 804 by receive-beamforming signals received by a plurality of antennas/antenna elements of the one or more antenna panels 826.

A UE transmission may be established by and via the protocol processing circuitry 814, digital baseband circuitry 816, transmit circuitry 818, RF circuitry 822, RFFE 824, and antenna panels 826. In some embodiments, the transmit components of the UE 804 may apply a spatial filter to the data to be transmitted to form a transmit beam emitted by the antenna elements of the antenna panels 826.

Similar to the UE 802, the AN 804 may include a host platform 828 coupled with a modem platform 830. The host platform 828 may include application processing circuitry 832 coupled with protocol processing circuitry 834 of the modem platform 830. The modem platform may further include digital baseband circuitry 836, transmit circuitry 838, receive circuitry 840, RF circuitry 842, RFFE circuitry 844, and antenna panels 846. The components of the AN 804 may be similar to and substantially interchangeable with like-named components of the UE 802. In addition to performing data transmission/reception as described above, the components of the AN 808 may perform various logical functions that include, for example, RNC functions such as radio bearer management, uplink and downlink dynamic radio resource management, and data packet scheduling.

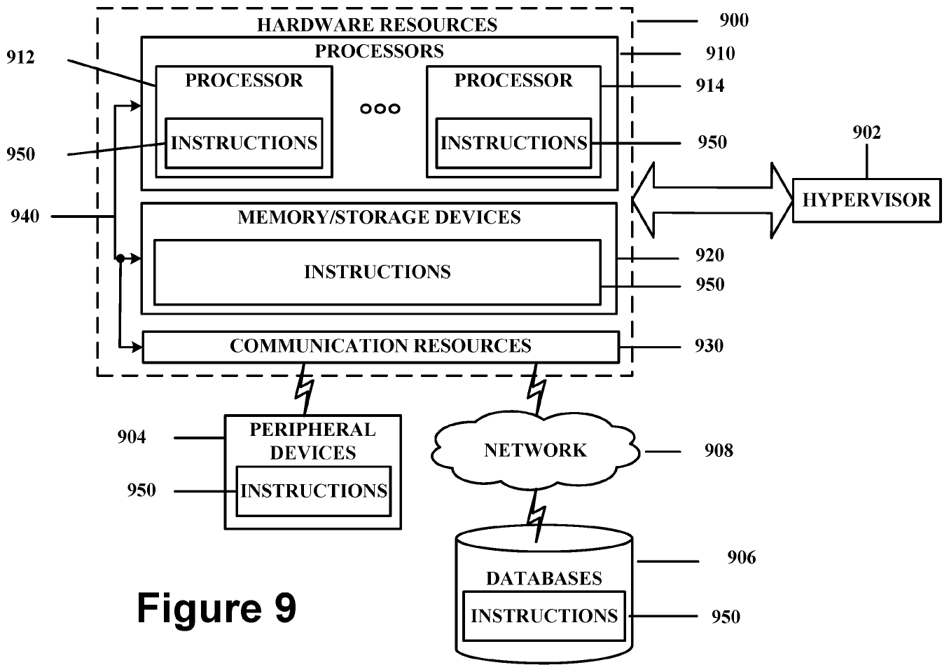

FIG. 9 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors (or processor cores) 910, one or more memory/storage devices 920, and one or more communication resources 930, each of which may be communicatively coupled via a bus 940 or other interface circuitry. For embodiments where node virtualization (e.g., NFV) is utilized, a hypervisor 902 may be executed to provide an execution environment for one or more network slices/sub-slices to utilize the hardware resources 900.

The processors 910 may include, for example, a processor 912 and a processor 914. The processors 910 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 920 may include main memory, disk storage, or any suitable combination thereof. The memory/storage devices 920 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 930 may include interconnection or network interface controllers, components, or other suitable devices to communicate with one or more peripheral devices 904 or one or more databases 906 or other network elements via a network 908. For example, the communication resources 930 may include wired communication components (e.g., for coupling via USB, Ethernet, etc.), cellular communication components, NFC components, Bluetooth® (or Bluetooth® Low Energy) components, Wi-Fi® components, and other communication components.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 910, the memory/storage devices 920, the peripheral devices 904, and the databases 906 are examples of computer-readable and machine-readable media.

### Example Procedures

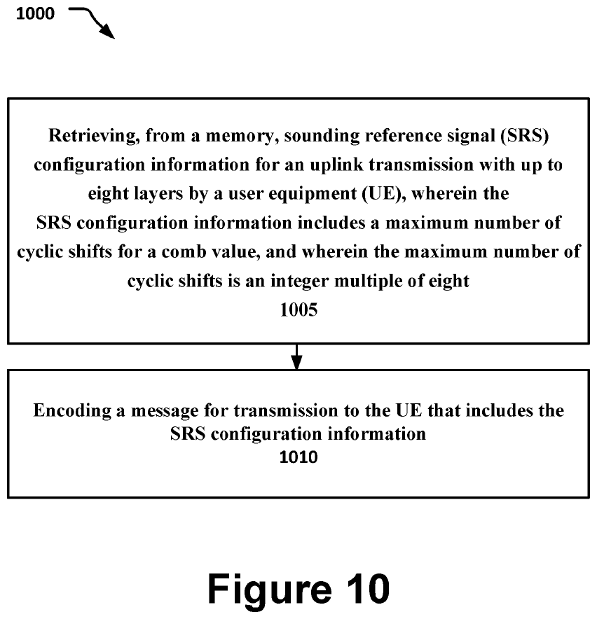

In some embodiments, the electronic device(s), network(s), system(s), chip(s) or component(s), or portions or implementations thereof, of FIGS. 7-9, or some other figure herein, may be configured to perform one or more processes, techniques, or methods as described herein, or portions thereof. One such process is depicted in FIG. 10, which may be performed by a next-generation NodeB (gNB) in some embodiments. In this example, process 1000 includes, at 1005, retrieving, from a memory, sounding reference signal (SRS) configuration information for an uplink transmission with up to eight layers by a user equipment (UE), wherein the SRS configuration information includes a maximum number of cyclic shifts for a comb value, and wherein the maximum number of cyclic shifts is an integer multiple of eight. The process further includes, at 1010, encoding a message for transmission to the UE that includes the SRS configuration information.

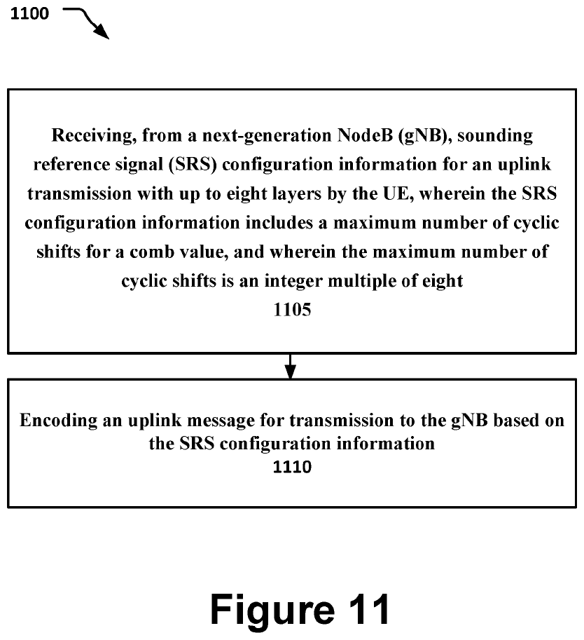

Another such process is illustrated in FIG. 11, which may be performed by a UE in some embodiments. In this example, process 1100 includes, at 1105, receiving, from a next-generation NodeB (gNB), sounding reference signal (SRS) configuration information for an uplink transmission with up to eight layers by the UE, wherein the SRS configuration information includes a maximum number of cyclic shifts for a comb value, and wherein the maximum number of cyclic shifts is an integer multiple of eight. The process further includes, at 1110, encoding an uplink message for transmission to the gNB based on the SRS configuration information.

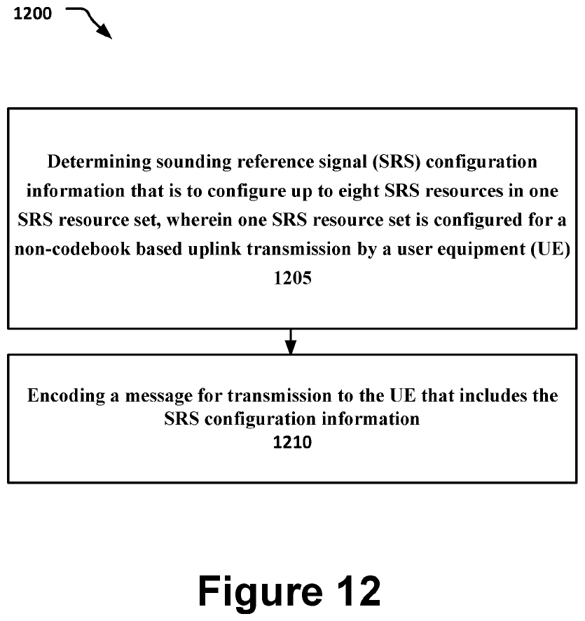

Another such process is illustrated in FIG. 12, which may be performed by a gNB in some embodiments. In this example, process 1200 includes, at 1205, determining sounding reference signal (SRS) configuration information that is to configure up to eight SRS resources in one SRS resource set, wherein one SRS resource set is configured for a non-codebook based uplink transmission by a user equipment (UE). The process further includes, at 1210, encoding a message for transmission to the UE that includes the SRS configuration information.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 may include a method of operating a wireless network comprising a next-generation NodeB (gNB) that is adapted to configure a user equipment (UE) with SRS transmission.

Example 2 may include the method of example 1 or some other example herein, wherein in order to support uplink transmission with up to 8 layers, the number of SRS antenna port should be extended to 8, e.g., Nₐₚ^{SRS}∈{1, 2, 4, 8}.

Example 3 may include the method of example 2 or some other example herein, wherein in order to support 8-port SRS operation, the maximum number of cyclic shifts (N_{SRS}^{CS,max}) for different comb value (K_{TC}) should be multiple integer times of 8.

Example 4 may include the method of example 2 or some other example herein, wherein in order to support 8-port SRS, the existing values for maximum number of cyclic shifts (N_{SRS}^{CS,max}) as shown in Table 1 is used.

Example 5 may include the method of example 4 or some other example herein, wherein when generating 8-port SRS for Comb-4 and Comb-8, multiple Comb offsets, e.g., 4 comb offsets, should be used. For example, for Comb-4, 4 comb offsets (0,1,2,3) will be used, and each comb offset is mapped with 2-port. For Comb-8, 4 comb offsets (0,2,4,6) or (1,3,5,7) could be used, and each comb offset is mapped with 2-port.

Example 6 may include the method of example 4 or some other example herein, wherein when generating 8-port SRS for Comb-2 and Comb-4, multiple Comb offsets, e.g., 2 comb offsets, should be used. For Comb-2, 2 comb offsets (0,1) could be used, and each comb offset is mapped with 4-port. For Comb-4, 2 comb offsets (0, 2) or (1, 3) could be used, and each comb offset is mapped with 4-port.

Example 7 may include the method of example 1 or some other example herein, wherein in order to support uplink transmission with up to 8 layers, 6-port SRS could be supported besides 8-port SRS, e.g., Nₐₚ^{SRS}∈{1, 2, 4, 6, 8}.

Example 8 may include the method of example 7 or some other example herein, wherein in order to support 8-port and 6-port SRS operation, the maximum number of cyclic shifts (N_{SRS}^{CS,max}) for different comb value (K_{TC}) should be multiple integer times of 8 and 6.

Example 9 may include the method of example 1 or some other example herein, wherein in order to support 6-port SRS, the existing values for maximum number of cyclic shifts (N_{SRS}^{CS,max}) as shown in Table 1 is used.

Example 10 may include the method of example 9 or some other example herein, wherein when generating 6-port SRS for Comb-2, multiple Comb offsets, e.g., 2 comb offsets, should be used. For example, 2 comb offsets (0,1) will be used. One comb offset (0) is mapped with 4-port and the other comb offset (1) is mapped with 2-port.

Example 11 may include the method of example 9 or some other example herein, wherein when generating 6-port SRS for Comb-4, one comb offsets could be used, and the comb offset is mapped with 6-port. Or multiple comb offsets, e.g., 3 comb offsets (0,1,2), could be used, and each comb offset is mapped with 2-port.

Example 12 may include the method of example 9 or some other example herein, wherein when generating 6-port SRS for Comb-8, multiple Comb offsets, e.g., 3 comb offsets, should be used. For example, comb offset (0, 2, 4) is used, and each comb offset is mapped with 2-port.

Example 13 may include the method of example 1 or some other example herein, wherein for SRS antenna switching, the following xTyR configuration should be supported: 6T8R, 8T8R.

Example 14 may include the method of example 13 or some other example herein, wherein for 6T8R, one or several of the following SRS resource configuration could be supported:
2 SRS resources, one is 6-port and the other one is 2-port (if 6-port SRS is supported)
2 SRS resources, both are 4-port
2 SRS resources, both are 6-port (if 6-port SRS is supported)
4 SRS resources, all the resources are 2-port

Example 15 may include the method of example 13 or some other example herein, wherein for 6T8R, up to 2 or 4 aperiodic SRS resource sets could be supported.

Example 16 may include the method of example 13 or some other example herein, wherein for 8T8R, one SRS resource with 8-port could be supported and one aperiodic SRS resource set could be supported.

Example 17 includes a method of a next-generation NodeB (gNB) comprising: determining sounding reference signal (SRS) configuration information for an uplink transmission by a user equipment (UE) with up to eight layers; and encoding a message for transmission to the UE that includes the SRS configuration information.

Example 18 includes the method of example 17 or some other example herein, wherein the SRS configuration information is to indicate a maximum number of cyclic shifts based on a number of ports for SRS and an SRS sequence length.

Example 19 includes the method of example 17 or some other example herein, wherein the SRS configuration information is to indicate a plurality of different comb offsets.

Example 20 includes the method of example 17 or some other example herein, wherein the SRS configuration information is to indicate a respective comb offset and cyclic shift for each respective port of a plurality of ports for SRS.

Example A1 may include the gNB, wherein the gNB could configure the UE for non-codebook based uplink transmission.

Example A2 may include the method of example A1 or some other example herein, wherein in order to support 8 layers transmission in uplink, for non-codebook based transmission, up to 8 SRS resources could be configured in one SRS resource set and only one SRS resource set is configured for non-codebook based transmission.

Example 3 may include the method of example A2 or some other example herein, wherein the SRI field for non-codebook based transmission in DCI should be extended as shown in Table X1 to Table X8.

Example A4 may include the method of example A1 or some other example herein, wherein for non-codebook based transmission, the value of parameter maxMIMO-Layers (Lₘₐₓ) should be extended up to 8. In order to save overhead and for power saving, more than 4 and up to 8 SRS resources are configured in the SRS resource set for non-codebook only when Lₘₐₓ is larger than certain threshold, e.g., 4. For example, if Lₘₐₓ is smaller than or equal to 4, then only up to 4 SRS resources can be configured, which means in Table X1 to Table X4, column 5 to column 8 are not used.

Example A5 may include the method of example A1 or some other example herein, wherein for non-codebook based transmission, in order to support up to 8 layers transmission, multiple codewords, e.g., 2, could be used and two SRS resource sets could be configured. In each SRS resource set, up to 4 SRS resource could be configured. For each codeword, up to 4 layers are supported. The number of SRS resources within the two SRS resource sets should be the same. In another example, the number of SRS resources within the two SRS resource sets could be different.

Example A6 may include the method of example A5 or some other example herein, wherein in DCI, two SRI fields should be included. For each SRI field, the mapping between bit field index and SRIs for given Lₘₐₓ (maximum number of layers as indicated by maxMIMO-Layers) and number of SRS resources within one SRS resource set (N_{SRS}) could use the legacy mapping as shown in FIG. 3 to FIG. 6. In one example, the Lₘₐₓ value is applied for both SRI fields. In another example, two Lₘₐₓ values could be configured, one for each SRI field. The two Lₘₐₓ values could be the same or different.

Example A7 may include the method of example A5 or some other example herein, wherein the mapping between SRI field in DCI and the codeword could be implicit or explicit. With implicit mapping, the order of the SRI field can indicate which codeword it is applied to. For example, the 1st SRI field is applied to the 1st codeword and the 2nd SRI field is applied to the 2nd codeword. With explicit mapping, the mapping between SRI field and codeword could be indicated by DCI or configured by RRC. For example, a new field could be added to DCI or the existing field could be reused/repurposed.

Example A8 may include the method of example A5 or some other example herein, wherein whether one codeword is used for transmission could implicitly indicated by the SRI field. If one codeword is not used for transmission, in the corresponding SRI field, one specific value (for example, one reserved value) of the SRI field could be used to indicate that the corresponding codeword is not used for transmission. For example, for N_{SRS}=4, Lₘₐₓ=4, value of ‘15’ (which is reserved) could be used to indicate the corresponding codeword is not used for transmission. In such case, for Lₘₐₓ=1, N_{SRS}=2, the SRI field should be extended to 2 bits. In another example, whether the codeword is used for transmission or not could be explicitly indicated by DCI. For example, a new field could be added to DCI or the existing field could be reused/repurposed. In one example, the new field could be a bitmap of two bits.

Example A9 may include the method of example A1 or some other example herein, wherein for non-codebook based transmission, in order to support up to 8 layers transmission, two SRS resource sets could be configured if only one codeword is used (or two SRS resource sets could be configured irrespective the number of codewords). In each SRS resource set, up to 4 SRS resource could be configured. The number of SRS resources within the two SRS resource sets should be the same. In another example, the number of SRS resources within the two SRS resource sets could be different.

Example A10 may include the method of example A9 or some other example herein, wherein a new RRC parameter could be introduced to indicating the maximum number of total layers, for example, L_{Total,Max}, and L_{Total,Max}<=8. The legacy parameter Lₘₐₓ is to indicate the maximum number of layers corresponding to one SRS resource set, Lₘₐₓ<=4 and Lₘₐₓ<=L_{Total,Max}. In another example, the new RRC parameter L_{Total,Max} is not needed and only the legacy parameter Lₘₐₓ is used.

Example A11 may include the method of example A9 or some other example herein, wherein in DCI, two SRI fields should be included. For each SRI field, the mapping between bit field index and SRIs for given Lₘₐₓ (maximum number of layers as indicated by maxMIMO-Layers) and number of SRS resources within one SRS resource set (N_{SRS}) could use the legacy mapping as shown in FIG. 3 to FIG. 6. In one example, the Lₘₐₓ value is applied for both SRI fields. In another example, two Lₘₐₓ values could be configured, one for each SRI field. The two Lₘₐₓ values could be the same or different.

Example A12 may include the method of example A9 or some other example herein, wherein the rank indicated by the two SRI fields should be the same. In another example, the rank indicated by the two SRI fields could be different.

Example A13 may include the method of example A9 or some other example herein, wherein the mapping between SRI field in DCI and the SRS resource set could be implicit or explicit. With implicit mapping, the order of the SRI field can indicate which SRS resource set it is applied to. For example, the 1st SRI field is applied to the 1st SRS resource set and the 2nd SRI field is applied to the 2nd SRS resource set. With explicit mapping, the mapping between SRI field and the SRS resource set could be indicated by DCI or configured by RRC. For example, a new field could be added to DCI or the existing field could be reused/repurposed.

Example A14 may include the method of example A9 or some other example herein, wherein whether the SRI field is used to indicate SRIs for transmission could implicitly indicated. With implicit indication, if one SRI field is not used for transmission, one specific value (for example, one reserved value) of the SRI field could be used to indicate that the corresponding SRI field is not used for transmission. For example, for N_{SRS}=4, Lₘₐₓ=4, value of ‘15’ (which is reserved) could be used to indicate the corresponding SRI field is not used for transmission. In such case, for Lₘₐₓ=1, N_{SRS}=2, the SRI field should be extended to 2 bits. In another example, whether the SRI field is used for transmission or not could be explicitly indicated by DCI. For example, a new field could be added to DCI or the existing field could be reused/repurposed. In one example, the new field could be a bitmap of two bits.

Example A15 includes a method of a next-generation NodeB (gNB), comprising: determining sounding reference signal (SRS) configuration information that is to configure up to eight SRS resources in one SRS resource set, wherein one SRS resource set is configured for non-codebook based transmission; and encoding a message for transmission to a user equipment (UE) that includes the SRS configuration information.

Example A16 includes the method of example A15 or some other example herein, wherein the SRS configuration information includes an indication of a port group associated with a non-codebook based PUSCH transmission with eight or fewer layers.

Example A17 includes the method of example A16 or some other example herein, wherein

An SRS resource set and an SRI field in downlink control information (DCI) is mapped to the port group.

Example A18 includes the method of example A17 or some other example herein, wherein the SRI field is to indicate SRIs for transmission.

Example A19 includes the method of example A15 or some other example herein, wherein the SRS configuration information is encoded for transmission to the UE via radio resource control (RRC) signaling.

Example A20 includes the method of example A19 or some other example herein, wherein the SRS configuration information includes an RRC parameter for indicating a maximum number of total layers.

Example X1 includes an apparatus comprising:
memory to store sounding reference signal (SRS) configuration information for an uplink transmission with up to eight layers by a user equipment (UE); and
processing circuitry, coupled with the memory, to:
   retrieve SRS configuration information from the memory, wherein the SRS configuration information includes a maximum number of cyclic shifts for a comb value, and wherein the maximum number of cyclic shifts is an integer multiple of eight; and
   encode a message for transmission to the UE that includes the SRS configuration information.

Example X2 includes the apparatus of example X1 or some other example herein, wherein the SRS configuration information includes a respective maximum number of cyclic shifts for each respective comb value in a plurality of comb values, and wherein each respective maximum number of cyclic shifts is an integer multiple of eight.

Example X3 includes the apparatus of example X1 or some other example herein, wherein the comb value is two, four or eight, and the maximum number of cyclic shifts is eight, sixteen, or twenty-four.

Example X4 includes the apparatus of example X1 or some other example herein, wherein the SRS configuration information includes an indication of multiple comb offsets.

Example X5 includes the apparatus of example X4 or some other example herein, wherein the SRS configuration information includes an indication of four comb offsets.

Example X6 includes the apparatus of example X5 or some other example herein, wherein the four comb offsets are (0, 1, 2, 3), (0, 2, 4, 6), or (1, 3, 5, 7).

Example X7 includes the apparatus of example X4 or some other example herein, wherein each comb offset is mapped with two ports.

Example X8 includes the apparatus of any of examples X1-X7 or some other example herein, wherein the SRS configuration information is to support eight transmit and eight receive (8T8R) antenna ports on the UE.

Example X9 includes the apparatus of any of examples X1-X8 or some other example herein, wherein the apparatus includes a next-generation NodeB (gNB) or portion thereof.

Example X10 includes one or more computer-readable media storing instructions that, when executed by one or more processors, configure a user equipment (UE) to:
receive, from a next-generation NodeB (gNB), sounding reference signal (SRS) configuration information for an uplink transmission with up to eight layers by the UE, wherein the SRS configuration information includes a maximum number of cyclic shifts for a comb value, and wherein the maximum number of cyclic shifts is an integer multiple of eight; and
encode an uplink message for transmission to the gNB based on the SRS configuration information.

Example X11 includes the one or more computer-readable media of example X10 or some other example herein, wherein the SRS configuration information includes a respective maximum number of cyclic shifts for each respective comb value in a plurality of comb values, and wherein each respective maximum number of cyclic shifts is an integer multiple of eight.

Example X12 includes the one or more computer-readable media of example X10 or some other example herein, wherein the comb value is two, four or eight, and the maximum number of cyclic shifts is eight, sixteen, or twenty-four.

Example X13 includes the one or more computer-readable media of example X10 or some other example herein, wherein the SRS configuration information includes an indication of multiple comb offsets.

Example X14 includes the one or more computer-readable media of example X13 or some other example herein, wherein the SRS configuration information includes an indication of four comb offsets.

Example X15 includes the one or more computer-readable media of example X14 or some other example herein, wherein the four comb offsets are (0, 1, 2, 3), (0, 2, 4, 6), or (1, 3, 5, 7).

Example X16 includes the one or more computer-readable media of example X13 or some other example herein, wherein each comb offset is mapped with two ports.

Example X17 includes the one or more computer-readable media of any of examples X10-X16 or some other example herein, wherein the SRS configuration information is to support eight transmit and eight receive (8T8R) antenna ports on the UE.

Example X18 includes one or more computer-readable media storing instructions that, when executed by one or more processors, configure a next-generation NodeB (gNB) to:
determine sounding reference signal (SRS) configuration information that is to configure up to eight SRS resources in one SRS resource set, wherein one SRS resource set is configured for a non-codebook based uplink transmission by a user equipment (UE); and
encode a message for transmission to the UE that includes the SRS configuration information.

Example X19 includes the one or more computer-readable media of example X18 or some other example herein, wherein the SRS configuration information includes an indication of a port group associated with a non-codebook based PUSCH transmission with eight or fewer layers.

Example X20 includes the one or more computer-readable media of example X19 or some other example herein, wherein the message includes downlink control information (DCI) comprising an SRS resource set and an SRS resource index (SRI) field mapped to the port group.

Example X21 includes the one or more computer-readable media of example X20 or some other example herein, wherein the SRI field is to indicate SRIs for transmission.

Example X22 includes the one or more computer-readable media of example X18 or some other example herein, wherein the SRS configuration information includes an indication of multiple codewords and two resource sets, wherein up to four SRS resources are configured in each of the two resource sets.

Example X23 includes the one or more computer-readable media of example X22 or some other example herein, wherein the SRS configuration information includes a mapping between an SRI filed and a codeword.

Example Z01 may include an apparatus comprising means to perform one or more elements of a method described in or related to any of examples 1-X23, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-X23, or any other method or process described herein.

Example Z03 may include an apparatus comprising logic, modules, or circuitry to perform one or more elements of a method described in or related to any of examples 1-X23, or any other method or process described herein.

Example Z04 may include a method, technique, or process as described in or related to any of examples 1-X23, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-X23, or portions thereof.

Example Z06 may include a signal as described in or related to any of examples 1-X23, or portions or parts thereof.

Example Z07 may include a datagram, packet, frame, segment, protocol data unit (PDU), or message as described in or related to any of examples 1-X23, or portions or parts thereof, or otherwise described in the present disclosure.

Example Z08 may include a signal encoded with data as described in or related to any of examples 1-X23, or portions or parts thereof, or otherwise described in the present disclosure.

Example Z09 may include a signal encoded with a datagram, packet, frame, segment, protocol data unit (PDU), or message as described in or related to any of examples 1-X23, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-X23, or portions thereof.

Example Z11 may include a computer program comprising instructions, wherein execution of the program by a processing element is to cause the processing element to carry out the method, techniques, or process as described in or related to any of examples 1-X23, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| AC | Application Client |
| ACR | Appplication Context Relocation |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AOA | Angle of Arrival |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital EXpenditure |
| CBRA | Contention Based Random Access |
| CC | Component Carrier, Country Code, Cryptographic |
| | Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CDR | Charging Data Request |
| CDR | Charging Data Response |
| CFRA | Contention Free Random Access |
| CG | Cell Group |
| CGF | Charging Gateway Function |
| CHF | Charging Function |
| CI | Cell Identity |
| CID | Cell-ID (e g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, CSI-RS |
| | Resource Indicator |
| C-RNTI | Cell RNTI |
| CS | Circuit Switched |
| CSCF | call session control function |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, DMRS | Demodulation Reference Signal |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| EAS | Edge Application Server |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM |
| | Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink |
| | Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated |
| | Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, further |
| | enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE Radio Access |
| | Network |
| GGSN | Gateway GPRS Support Node |
| GLONASS | GLObal'naya NAvigatsionnaya Sputnikovaya Sistema |
| | (Engl.: Global Navigation Satellite System) |
| gNB | Next Generation NodeB |
| gNB-CU | gNB-centralized unit, Next Generation NodeB |
| | centralized unit |
| gNB-DU | gNB-distributed unit, Next Generation NodeB |
| | distributed unit |
| GNSS | Global Navigation Satellite System |
| GPRS | General Packet Radio Service |
| GPSI | Generic Public Subscription Identifier |
| GSM | Global System for Mobile Communications, |
| | Groupe Sp\acute{é}cial Mobile |
| GTP | GPRS Tunneling Protocol |
| GTP-UGPRS | Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is |
| | http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IIOT | Industrial Internet of Things |
| IM | Interference Measurement, Intermodulation, IP |
| | Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the |
| | convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LMF | Location Management Function |
| LOS | Line of Site |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec |
| | Tunnel |
| LTE | Long Term Evolution |
| M2M | Machine-to-Machine |
| MAC | Medium Access Control (protocol layering |
| | context) |
| MAC | Message authentication code (security/ |
| | encryption context) |
| MAC-A | MAC used for authentication and key agreement |
| | (TSG T WG3 context) |
| MAC-IMAC | used for data integrity of signalling messages |
| | (TSG T WG3 context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management Information |
| | Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling |
| | Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTC | massive MTC, massive Machine-Type |
| | Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non- Access |
| | Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| P-CSCF | Proxy CSCF |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet |
| | Data Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular PP, PTP Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System |
| | Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, Receiving, Receiver |
| S1AP | S1 Application Protocol |
| S1-MME | S1 for the control plane |
| S1-U | S1 for the user plane |
| S-CSCF | serving CSCF |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple |
| | Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data |
| | Adaptation Protocol layer |
| SDL | Supplementary Downlink |
| SDNF | Structured Data Storage Network Function |
| SDP | Session Description Protocol |
| SDSF | Structured Data Storage Function |
| SDT | Small Data Transmission |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and |
| | frame timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH Block | SSBRI SS/PBCH Block Resource Indicator, |
| | Synchronization Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise |
| | and Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, VLAN Virtual LAN, Virtual Local |
| | Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over- Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-23. (canceled)

24. An apparatus of a next generation Node B (gNB), the apparatus comprising:
memory to store sounding reference signal (SRS) configuration information for an uplink transmission with up to eight layers by a user equipment (UE); and
processing circuitry, coupled with the memory, to:
retrieve SRS configuration information from the memory, wherein the SRS configuration information includes a maximum number of cyclic shifts for a comb value, and wherein the maximum number of cyclic shifts is an integer multiple of eight; and
encode a message for transmission to the UE that includes the SRS configuration information.

25. The apparatus of claim 24, wherein the SRS configuration information includes a respective maximum number of cyclic shifts for each respective comb value in a plurality of comb values, and wherein each respective maximum number of cyclic shifts is an integer multiple of eight.

26. The apparatus of claim 24, wherein the comb value is two, four or eight, and the maximum number of cyclic shifts is eight, sixteen, or twenty-four.

27. The apparatus of claim 24, wherein the SRS configuration information includes an indication of multiple comb offsets.

28. The apparatus of claim 27, wherein the SRS configuration information includes an indication of four comb offsets, and wherein the four comb offsets are (0, 1, 2, 3), (0, 2, 4, 6), or (1, 3, 5, 7).

29. The apparatus of claim 27, wherein each comb offset is mapped with two ports.

30. The apparatus of claim 24, wherein the SRS configuration information is to support eight transmit and eight receive (8T8R) antenna ports on the UE.

31. One or more computer-readable media storing instructions that, when executed by one or more processors, configure a user equipment (UE) to:
receive, from a next-generation NodeB (gNB), sounding reference signal (SRS) configuration information for an uplink transmission with up to eight layers by the UE, wherein the SRS configuration information includes a maximum number of cyclic shifts for a comb value, and wherein the maximum number of cyclic shifts is an integer multiple of eight; and
encode an uplink message for transmission to the gNB based on the SRS configuration information.

32. The one or more computer-readable media of claim 31, wherein the SRS configuration information includes a respective maximum number of cyclic shifts for each respective comb value in a plurality of comb values, and wherein each respective maximum number of cyclic shifts is an integer multiple of eight.

33. The one or more computer-readable media of claim 31, wherein the comb value is two, four or eight, and the maximum number of cyclic shifts is eight, sixteen, or twenty-four.

34. The one or more computer-readable media of claim 31, wherein the SRS configuration information includes an indication of multiple comb offsets.

35. The one or more computer-readable media of claim 34, wherein the SRS configuration information includes an indication of four comb offsets, and wherein the four comb offsets are (0, 1, 2, 3), (0, 2, 4, 6), or (1, 3, 5, 7).

36. The one or more computer-readable media of claim 34, wherein each comb offset is mapped with two ports.

37. The one or more computer-readable media of claim 31, wherein the SRS configuration information is to support eight transmit and eight receive (8T8R) antenna ports on the UE.

38. One or more computer-readable media storing instructions that, when executed by one or more processors, configure a next-generation NodeB (gNB) to:
determine sounding reference signal (SRS) configuration information that is to configure up to eight SRS resources in one SRS resource set, wherein one SRS resource set is configured for a non-codebook based uplink transmission by a user equipment (UE); and
encode a message for transmission to the UE that includes the SRS configuration information.

39. The one or more computer-readable media of claim 38, wherein the SRS configuration information includes an indication of a port group associated with a non-codebook based PUSCH transmission with eight or fewer layers.

40. The one or more computer-readable media of claim 39, wherein the message includes downlink control information (DCI) comprising an SRS resource set and an SRS resource index (SRI) field mapped to the port group.

41. The one or more computer-readable media of claim 40, wherein the SRI field is to indicate SRIs for transmission.

42. The one or more computer-readable media of claim 38, wherein the SRS configuration information includes an indication of multiple codewords and two resource sets, wherein up to four SRS resources are configured in each of the two resource sets.

43. The one or more computer-readable media of claim 42, wherein the SRS configuration information includes a mapping between an SRI field and a codeword.
